(19) United States
(12) Patent Application Publication
(10) Pub. No.: US 2018/0020329 A1
(43) Pub. Date: Jan. 18, 2018

(54) Method and System for Internet of Things (iOT) Enhanced Location Based Services Trilateration

(71) Applicant: Rivada Research, LLC, Colorado Springs, CO (US)

(72) Inventor: Clint Smith, Warwick, NY (US)

(21) Appl. No.: 15/651,763

(22) Filed: Jul. 17, 2017

Related U.S. Application Data
(63) Continuation-in-part of application No. 15/431,274, filed on Feb. 13, 2017.
(60) Provisional application No. 62/363,798, filed on Jul. 18, 2016.

(51) Int. Cl. H04W 4/02; H04L 29/08; G01S 19/46; H04W 84/18

(52) U.S. Cl. CPC H04W 4/027; H04L 67/12; G01S 19/46; H04W 84/18

(57) ABSTRACT

Methods and systems for determining a location of a wireless device include the wireless device determining its approximate location, and forming a communication group with other devices in proximity to the wireless device, the other devices including at least one internet of things (iOT) device. The wireless device may receive location information from the devices in the communication group, such as information identifying a location of the iOT device relative to a location of the iOT hub. The wireless device may use the determined approximate location in conjunction with information received from the devices in the communication group to generate a more precise location value.

### RELATED APPLICATIONS

This application claims the benefit of priority to U.S. Provisional Application No. 62/363,798, entitled “Method and System for Internet of Things (iOT) Enhanced Location Based Services Trilateration” filed Jul. 18, 2016, and is a continuation in part of continuation in part of U.S. patent application Ser. No. 15/431,274 entitled “Method and System for Providing Enhanced Location Based Information for Wireless Handsets” filed on Feb. 13 2017, the entire contents of all of which are hereby incorporated by reference.

This application is also related to U.S. Non-Provisional application Ser. No. 15/345,441, entitled “Method and System for Enhanced Location Based Information for Fixed Platforms” filed on Nov. 7, 2016, U.S. Non-Provisional application Ser. No. 15/434,024, entitled “Method and System for Performing Trilateration for Fixed Infrastructure Nodes (FIN) Based On Enhanced Location Based Information” filed on Feb. 15, 2017, and U.S. Non-Provisional application Ser. No. 15/630,589, entitled “Method and System for Providing Enhanced Location Based Trilateration” filed on Jun. 22, 2017, the entire contents of all of which are hereby incorporated by reference.

### BACKGROUND

Wireless communication technologies and mobile electronic devices (e.g., cellular phones, tablets, laptops, etc.) have grown in popularity and use over the past several years. To keep pace with increased consumer demands, mobile electronic devices have become more powerful and feature rich, and now commonly include global positioning system (GPS) receivers, sensors, and many other components for connecting users to friends, work, leisure activities and entertainment. However, despite these advancements, mobile devices remain lacking in their ability to provide effective location based services, information, or communications. As mobile devices and technologies continue to grow in popularity and use, generating enhanced location information for mobile devices is expected to become an important and challenging design criterion for mobile device manufactures and network engineers.

### BRIEF DESCRIPTION OF THE DRAWINGS

The accompanying drawings, which are incorporated herein and constitute part of this specification, illustrate exemplary embodiments of the invention, and, together with the general description given above and the detailed description given below, serve to explain features of the invention.

FIG. 1 is a communication system block diagram illustrating network components of an example telecommunication system suitable for use in a mobile-device centric approach for determining the location of a mobile device in accordance with various embodiments.

FIG. 2 is a communication system block diagram illustrating network components of an example telecommunication system suitable for use in a network centric approach for determining the location of a mobile device in accordance with various embodiments.

FIG. 3 is an illustration of an example mobile device suitable for use in grouping with other mobile devices and computing precise location information in accordance with the various embodiments.

FIG. 4A is a communication system block diagram illustrating network components of an example LTE communication system suitable for use with various embodiments

FIG. 4B is a block diagram illustrating logical components, communication links and information flows in an embodiment communication system.

FIGS. 5A through 5C are component block diagrams illustrating functional components, communication links, and information flows in an embodiment method of grouping mobile devices and sharing location information between grouped mobile devices.

FIG. 5D is a process flow diagram illustrating an embodiment mobile device method for grouping mobile devices and sharing location information between grouped mobile devices and the network to compute enhanced location information.

FIGS. 6A through 6D are component block diagrams illustrating functional components, communication links, and information flows in an embodiment method for computing location information in which the grouped/paired mobile devices are updated with their respective location information.

FIG. 6E is a process flow diagram illustrating an embodiment system method of determining the location of two or more grouped mobile devices.

FIG. 6F is a process flow diagram illustrating an embodiment mobile device method of adjusting the update intervals in response to detecting a low battery condition.

FIG. 7 is a component block diagram illustrating functional components, communication links, and information flows in embodiment method of periodically scan for cells.

FIG. 8 is a process flow diagram illustrating an embodiment mobile device method for determining the location of a mobile device in a wireless network.

FIGS. 9A through 9E are component block diagrams illustrating various logical and functional components, information flows and data suitable for use in various embodiments.

FIG. 10 is a sequence diagram illustrating an embodiment hybrid lateration method by which mobile devices may gain access to the network.

FIG. 11 is a sequence diagram illustrating another embodiment hybrid lateration method in which a mobile device is unable to locate a network due coverage problems.

FIGS. 12A through 12C are component block diagrams illustrating functional components, communication links, and information flows in an embodiment method of transferring a connection from a local radio system to the small cell system.

FIGS. 13A through 13C are component block diagrams illustrating functional components, communication links, and information flows in an embodiment method of identifying and responding to a distressed mobile device.

FIG. 14 is a component block diagram illustrating functional components, communication links, and information flows in an embodiment method of performing dead reckoning grouping mobile devices in an ad-hoc scheme.

FIG. 15 is an illustration of an enhanced antenna that may be used with various embodiments to further improve positional accuracy.

FIGS. 16A and B are illustrations of various enhanced antenna configurations that may be used with the various embodiments to further improve positional accuracy.

FIGS. 17A and B are sectional diagrams illustrating strips of antenna patches that may be used in various embodiments.

FIG. 18 is a circuit diagram of antenna system suitable for use with various embodiments.

FIG. 19 is an illustration of an embodiment antenna array retrofitted into an existing cellular wireless network in accordance with an embodiment.

FIG. 20 is a component block diagram of a mobile device suitable for use with an embodiment.

FIG. 21 is a component block diagram of a server suitable for use with an embodiment.

FIG. 22A is a block diagram illustrating various components, information flows, and operations in an example computing device/system configured to perform enhanced location based service (eLBS) trilateration operations in accordance with various embodiments.

FIG. 22B is a block diagram illustrating various components, information flows, and operations in an example computing device/system configured to perform single device eLBS trilateration operations in accordance with various embodiments

FIG. 22C is a block diagram illustrating various components, information flows, and operations in a computing device/system configured to perform eLBS trilateration operations in accordance with some embodiments.

FIGS. 23A and 23B are process flow diagrams illustrating operations in a system configured to select or generate location information for trilateration input for a fixed wireless device in accordance with an embodiment.

FIGS. 24A and 24B are process flow diagrams illustrating operations in a system configured to use trilateration inputs to generate a fusion trilateration value for a fixed wireless device in accordance with an embodiment.

FIG. 25 is a process flow diagram illustrating a method of using trilateration inputs to generate fusion trilateration values for a fixed wireless device in accordance with another embodiment.

FIGS. 26 through 40 are component block diagrams illustrating functional components, communication links, and information flows in an Internet of Things (iOT) ecosystem that includes devices configured to perform enhanced location based services trilateration operations in accordance with the various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

The terms “mobile device,” “cellular telephone,” and “cell phone” are used interchangeably herein to refer to any one or all of cellular telephones, smartphones, personal data assistants (PDA's), laptop computers, tablet computers, ultrabooks, palm-top computers, wireless electronic mail receivers, multimedia Internet enabled cellular telephones, wireless gaming controllers, and similar personal electronic devices which include a programmable processor, a memory and circuitry for sending and/or receiving wireless communication signals. While the various embodiments are particularly useful in mobile devices, such as cellular telephones, which have limited battery life, the embodiments are generally useful in any computing device that may be used to wirelessly communicate information.

The terms “wireless network”, “network”, “cellular System”, “cell tower” and “radio access point” may used generically and interchangeably to refer to any one of various wireless mobile systems. In an embodiment, wireless network may be a radio access point (e.g., a cell tower), which provides the radio link to the mobile device so that the mobile device can communicate with the core network.

A number of different cellular and mobile communication services and standards are available or contemplated in the future, all of which may implement and benefit from the various embodiments. Such services and standards include, e.g., third generation partnership project (3GPP), long term evolution (LTE) systems, third generation wireless mobile communication technology (3G), fourth generation wireless mobile communication technology (4G), global system for mobile communications (GSM), universal mobile telecommunications system (UMTS), 3GSM, general packet radio service (GPRS), code division multiple access (CDMA) systems (e.g., cdmaOne, CDMA2000™), enhanced data rates for GSM evolution (EDGE), advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), public switched telephone network (PSTN), Wi-Fi Protected Access I & II (WPA, WPA2), Bluetooth®, integrated digital enhanced network (iden), and land mobile radio (LMR). Each of these technologies involves, for example, the transmission and reception of voice, data, signaling and/or content messages. It should be understood that any references to terminology and/or technical details related to an individual telecommunication standard or technology are for illustrative purposes only, and are not intended to limit the scope of the claims to a particular communication system or technology unless specifically recited in the claim language.

A number of different methods, technologies, solutions, and/or techniques (herein collectively “solutions”) are currently available for determining the location of mobile device, any or all of which may be implemented by, included in, and/or used by the various embodiments. Such solutions include, e.g., global positioning system (GPS) based solutions, assisted GPS (A-GPS) solutions, and cell-based positioning solutions such as cell of origin (COO), time of arrival (TOA), observed time difference of arrival (OTDOA), advanced forward link trilateration (AFLT), and angle of arrival (AOA). In various embodiments, such solutions may implemented in conjunction with one or more wireless communication technologies and/or networks, including wireless wide area networks (WWANs), wireless local area networks (WLANs), wireless personal area networks (WPANs), and other similar networks or technologies. By way of example, a WWAN may be a Code Division Multiple Access (CDMA) network, a Frequency Division Multiple Access (FDMA) network, an OFDMA network, a 3GPP LTE network, a WiMAX (IEEE 802.16) network, and so on. The WPAN may be a Bluetooth network, an IEEE 802.15x network, and so on. A WLAN may be an IEEE 802.11x network, and so on. A CDMA network may implement one or more radio access technologies (RATs) such as CDMA2000, Wideband-CDMA (W-CDMA), and so on.

Various embodiments discussed herein may generate, compute, and/or make use of location information pertaining to one or more mobile devices. Such location information may be useful for providing and/or implementing a variety of location-based services, including emergency location services, commercial location services, internal location services, and lawful intercept location services. By way of example: emergency location services may include services relating to the provision of location and/or identification information to emergency service personal and/or emergency systems (e.g., to 911 system); commercial location services may include any general or value-added service (e.g., asset tracking services, navigation services, location-based advertising services, etc); internal location services may include services pertaining to the management of the wireless service provider network (e.g., radio resource management services, message delivery services, paging services, call delivery services, services for providing position/location network enhancements, etc.); and lawful intercept location services may include any service that provides public safety and/or law enforcement agencies with identification and/or location information pertaining to a mobile device or a mobile device user. While the various embodiments are particularly useful in applications that fall within one or more of the categories/types of location based services discussed above, the embodiments are generally useful in any application or service that benefits from location information.

Modern mobile electronic devices (e.g., mobile phones) typically include one or more geospatial positioning systems/components for determining the geographic location of the mobile device. Location information obtained by these geospatial systems may be used by location-aware mobile software applications (e.g., Google® Maps, Yelp®, Twitter® Places, “Find my Friends” on Apple®, etc.) to provide users with information regarding the mobile device's physical location at a given point in time. In recent years, such location-based services and software applications have increased in popularity, and now enable mobile device users to navigate cities, read reviews of nearby restaurants and services, track assets or friends, obtain location-based safety advice, and/or take advantage of many other location-based services on their mobile devices.

Consumers of modern mobile devices now demand more advanced, robust, and feature-rich location-based services than that which is currently available on their mobile devices. However, despite many recent advances in mobile and wireless technologies, mobile devices remain lacking in their ability to provide their users/consumers with location based services that are accurate or powerful enough to meet the demands of these consumers. For example, while existing location-aware mobile software applications (e.g., “Find my Friends” on Apple®, Google® Latitude, etc.) enable a mobile device user to view the approximate geographical position of other mobile devices on a two-dimensional map, they lack the capability to accurately, efficiently and consistently pin point the precise location and/or position of the other mobile devices in all three dimensions and/or within a wireless communication network. The various embodiments overcome these and other limitations of existing solutions by collecting information from multiple mobile devices, generated more precise location information on or about one or more mobile devices, generating advanced three-dimensional location and position information on or about one or more mobile devices, and using the generated location/position information to provide mobile device users with more accurate, more powerful, and more reliable location based services.

One of the challenges associated with using geo-spatial positioning technology on a mobile device is that the mobile device's ability to acquire satellite signals and navigation data to calculate its geospatial location (called “performing a fix”) may be hindered when the mobile device is indoors, below grade, and/or when the satellites are obstructed (e.g., by tall buildings, etc.). The presence of physical obstacles, such as metal beams or walls, may cause multipath interference and signal degradation of the wireless communication signals when the mobile device is indoors or in urban environments that include tall buildings or skyscrapers. In rural environments, the mobile device may not have sufficient access to satellite communications (e.g., to a global positioning system satellite) to effectively ascertain the mobile device's current location. These and other factors often cause existing geo-spatial technologies to function inaccurately and/or inconsistently on mobile devices, and hinder the mobile device user's ability to fully utilize location-aware mobile software applications and/or other location based services and applications on his/her mobile device.

Another problem with using existing geo-spatial positioning technologies is that position accuracy afforded by existing technologies is not sufficient for use in emergency services due to the relatively high level of position accuracy required by these services.

The various embodiments include improved location determination solutions that determine the location of a mobile device at the level of position accuracy which is suitable for use in emergency location services, commercial location services, internal location services, and lawful intercept location services.

Generally, there are three basic approaches for determining the location of mobile devices in a communication network: a mobile-device centric approach, a network centric approach and a hybrid approach that may include aspects of both the mobile device centric approach and the network centric approach.

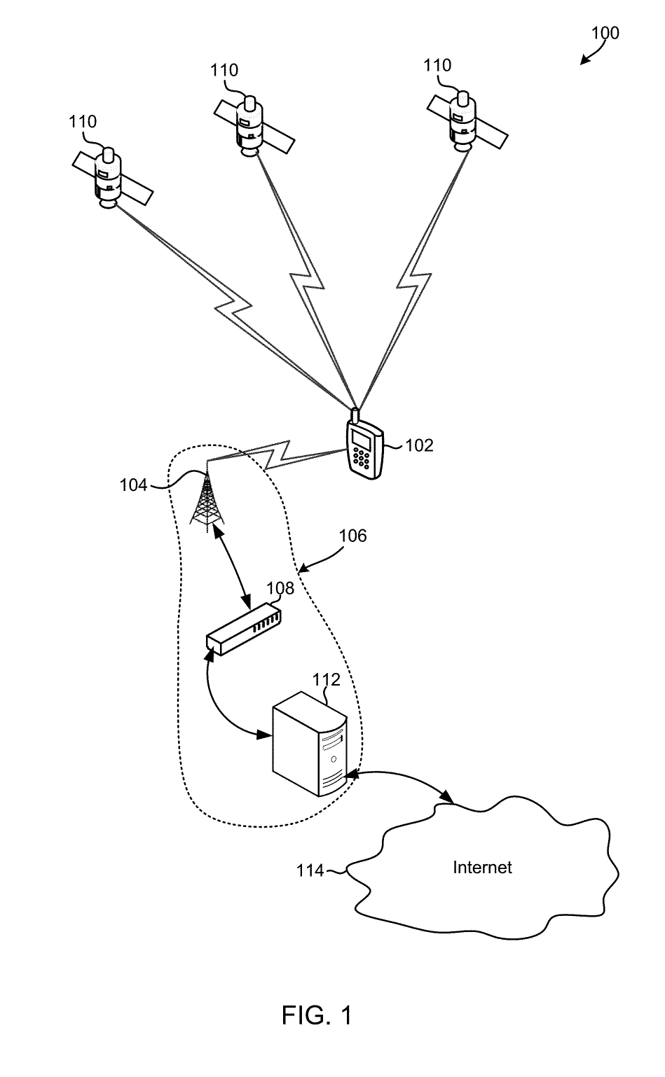

FIG. 1 illustrates an example communication system 100 suitable for implementing a mobile-device centric approach for determining the location of a mobile device 102 in accordance with various embodiments. The mobile device 102 may include a global positioning system (GPS) receiver in communication with multiple geo-spatial positioning and navigation satellites 110 and a base tower 104 of a communication network 106. The mobile device 102 may receive (e.g., via the GPS receiver) radio signals emitted by the satellites 110, measure the time required for the signals to reach the mobile device 102, and use trilateration techniques to determine the geographical coordinates (e.g., latitude and longitude coordinates) of the mobile device 102. The mobile device 102 may send the geographical coordinates to the communication network 106 at various times and/or in response to various conditions or events, such as upon initial acquisition with the communication network 106, in response to network-based requests, in response to third party requests, etc.

In an embodiment, the communication network may be a cellular telephone network. A typical cellular telephone network includes a plurality of cellular base stations 104 coupled to a network operations center 108, which operates to connect voice and data calls between mobile devices 102 (e.g., mobile phones) and other network destinations, such as via telephone land lines (e.g., a POTS network, not shown) and the Internet 114. Communications between the mobile devices 102 and the cellular telephone network 11 may be accomplished via two-way wireless communication links, such as 4G, 3G, CDMA, TDMA, and other cellular telephone communication technologies. The network 106 may also include one or more servers 112 coupled to or within the network operations center 108 that provide connections to the Internet 114.

In various embodiments, the mobile device 102 may be configured to communicate with a radio access node, which can include any wireless base station or radio access point such as LTE, CDMA2000/EVDO, WCDMA/HSPA, IS-136, GSM, WiMax, WiFi, AMPS, DECT, TD-SCDMA, or TD-CDMA and switch, Land Mobile Radio (LMR) interoperability equipment, a satellite Fixed Service Satellite (FSS) for remote interconnection to the Internet and PSTN.

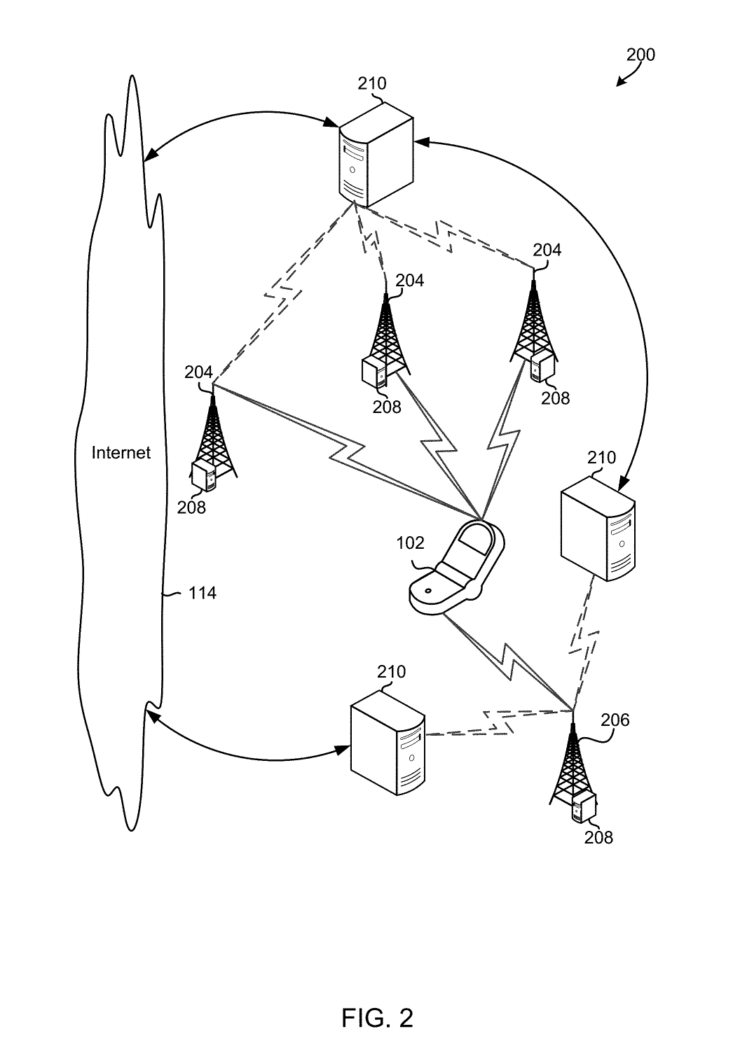

FIG. 2 illustrates an example communication system 200 suitable for implementing a network centric approach for determining the location of a mobile device 102 in accordance with various embodiments. The mobile device 102 may include a circuitry for wirelessly sending and receiving radio signals. The communication system 200 may include a plurality of radio access points 204, 206 having installed thereon additional radio equipment 208 for measuring the location of the mobile devices in the communication system. For example, the mobile device 102 may transmit radio signals for reception by one or more (e.g., typically three) radio access points 204, and the radio access points may receive the transmitted signals and measure the signal strength and/or radio energy of the received signals to identify the location of the mobile device 102.

In an embodiment, the radio access points 204 may be configured to determine the location of the mobile device relative to a known location of a network component, such as the illustrated radio access point 206. In this manner, the additional radio equipment 208 installed on the radio access points 204, 206 provides the communication system 200 with similar functionality as is provided by a GPS receiver for signals received from the mobile device. For example, the radio equipment on one or more of the radio access points 204 may measure how long it takes for the radio signal to travel from the mobile device 102 to another radio access point 206, and using trilateration techniques (e.g., time of arrival, angle of arrival, or a combination thereof), the mobile device 102 or a network server 210 may estimate the location of the mobile device 102 to within an accuracy of 100 to 300 meters. Once the network has estimated the latitude and longitude coordinates of the mobile device 102, this information can be used to determine the geo-spatial location of the mobile device 102, which may be communicated to other systems, servers or components via the Internet 114.

Various embodiments may implement and/or make use of a hybrid approach for determining the location of mobile devices in a communication network, which may include aspects of both the device-centric and the network-centric approaches discussed above with reference to FIGS. 1 and 2. For example, an embodiment may implement a hybrid approach in which the GPS capabilities of mobile devices, the measured signal strengths and/or radio energy of radio signals transmitted from the mobile devices, and known locations of network components are used in combination to estimate the locations of one or more mobile devices in a network. In a further embodiment, the mobile devices and/or network components (e.g., severs, radio access points, etc.) may be configured to dynamically determine which factors (e.g., radio signal strength, GPS, etc.) to measure and/or use in determining the location of the mobile devices.

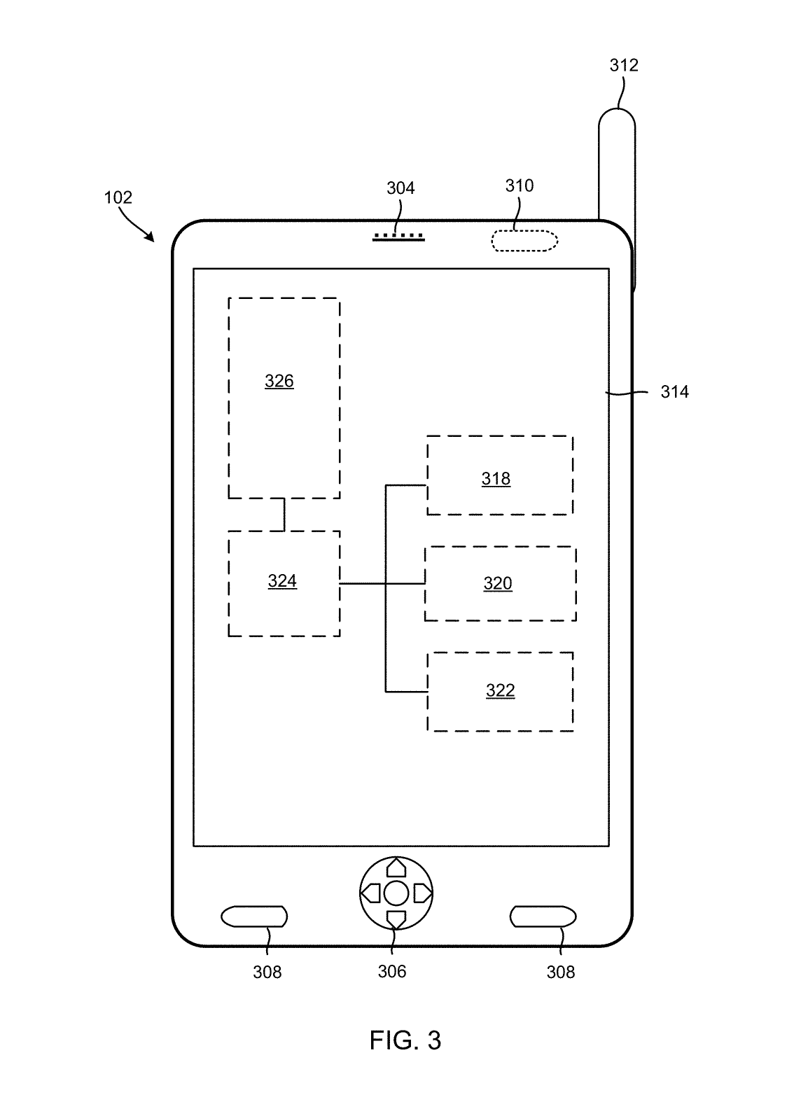

FIG. 3 illustrates sample components of a mobile device in the form of a phone 102 that may be used with the various embodiments. The phone 102 may include a speaker 304, user input elements 306, microphones 308, an antenna 312 for sending and receiving electromagnetic radiation, an electronic display 314, a processor 324, a memory 326 and other well known components of modern electronic devices.

The phone 102 may also include one or more sensors 310 for monitoring physical conditions (e.g., location, motion, acceleration, orientation, altitude, etc.). The sensors may include any or all of a gyroscope, an accelerometer, a magnetometer, a magnetic compass, an altimeter, an odometer, and a pressure sensor. The sensors may also include various bio-sensors (e.g., heart rate monitor, body temperature sensor, carbon sensor, oxygen sensor, etc.) for collecting information pertaining to environment and/or user conditions. The sensors may also be external to the mobile device and paired or grouped to the mobile device via a wired or wireless connection (e.g., Bluetooth®, etc.). In embodiment, the mobile device 102 may include two or more of the same type of sensor (e.g., two accelerometers, etc.).

The phone 102 may also include a GPS receiver 318 configured to receive GPS signals from GPS satellites to determine the geographic location of the phone 102. The phone 102 may also include circuitry 320 for transmitting wireless signals to radio access points and/or other network components. The phone 102 may further include other components/sensors 322 for determining the geographic position/location of the phone 102, such as components for determining the radio signal delays (e.g., with respect to cell-phone towers and/or cell sites), performing trilateration and/or multilateration operations, identifying proximity to known networks (e.g., Bluetooth® networks, WLAN networks, WiFi, etc.), and/or for implementing other known geographic location technologies.

The phone 102 may also include a system acquisition function configured to access and use information contained in a subscriber identity module (SIM), universal subscriber identity module (USIM), and/or preferred roaming list (PRL) to, for example, determine the order in which listed frequencies or channels will be attempted when the phone 102 is to acquire/connect to a wireless network or system. In various embodiments, the phone 102 may be configured to attempt to acquire network access (i.e., attempt to locate a channel or frequency with which it can access the wireless/communication network) at initial power-on and/or when a current channel or frequency is lost (which may occur for a variety of reasons).

The mobile device 102 may include pre-built in USIM, SIM, PRL or access point information. In an embodiment, the mobile device may be configured for first responders and/or public safety network by, for example, setting the incident radio system as the default and/or preferred communication system.

As mentioned above, despite recent advances in mobile and wireless communication technologies, determining the specific location of a mobile device in a wireless network remains a challenging task for a variety of reasons, including the variability of environmental conditions in which mobile devices are often used by consumers, deficiencies in existing technologies for computing and/or measuring location information on mobile devices, and the lack of uniform standards. For example, there is currently no universally accepted standard for implementing or providing location-based services. As a result, mobile device designers and wireless network operators, in conjunction with local public safety and third party providers, are using a variety of inefficient, incoherent, and sometimes incompatible methods, technologies, solutions, and/or techniques to determine the location of a mobile device and/or to provide location based services.

While there are no universally accepted standards for implementing or providing location-based services, there are certain requirements or standards associated with determining the location of a mobile device that may be of use in various embodiments. The U.S. Congress has mandated that cellular service providers configure their networks, communication systems and/or mobile devices so that the locations of mobile devices can be determined when a 911 call is placed. To implement Congress's mandate, the Federal Communications Commission (FCC) requested cellular service providers upgrade their systems in two phases (herein “Phase I” and “Phase II” respectively). While the level of precision/accuracy provided by these Phase I and II upgrades are generally inadequate for providing effective location based services that meet the demands of modern users of mobile devices, these upgrades provide a foundation from which more effective location based solutions may be built.

As mentioned above, the FCC requested cellular service providers upgrade their systems in two phases. In the first phase (Phase I), cellular service providers were to upgrade their systems so that emergency calls (e.g., 911 calls) are routed to the public service answering point (PSAP) closest to the cell-tower antenna with which the mobile device is connected, and so that PSAP call-takers can view the phone number of the mobile device and the location of the connecting cell-tower. The location of the connecting cell-tower may be used to identify the general location of the mobile device within a 3-6 mile radius.

In the second phase (Phase II), cellular service providers were to upgrade their systems so that PSAP call-takers could identify the location of the mobile device to within 300 meters. To meet these Phase II requirements, wireless service providers have implemented a variety of technologies, and depending on the technology used, can generally identify the location of the mobile device to within 50-300 meters. For example, on systems that have implemented a network-based solution (e.g., triangulation of nearby cell towers, etc.), the location of a mobile device can be determined within an accuracy of 100 meters 67% of the time, and to within an accuracy of 300 meters 95% of the time. On systems that have adopted a mobile device-based solution (e.g., embedded global positioning system receivers, etc.), the location of the mobile device may be determined to within 50 meters 67% of the time, and to within 150 meters 95% of the time.

Existing phase I and II solutions, alone, are not adequate for generating location information having sufficient accuracy or detail for use in providing accurate, powerful, and reliable location based services. Various embodiments may use some or all of the capabilities built into existing systems (e.g., as part of phase I and II upgrades, device-centric systems, network-centric systems, etc.), in conjunction with more advanced location determination techniques, to compute location information suitable for the advanced location based services demanded by today's consumers.

In addition to the three basic approaches discussed above, a number of different solutions are currently available for determining the location of mobile device, any or all of which may be implemented by and/or included in the various embodiments.

Most conventional location determination solutions use distance estimation techniques that are based on single-carrier signals, and one of the fundamental operations in ground-based (or network-centric) location determination solutions is timing estimation of a first-arrival path of a signal. That is, a single-carrier signal transmitted between a transceiver and a mobile device can be received via multiple paths (i.e., multipath), and the multiple paths of the signal can have different received powers and arrival times. The received signal may be cross-correlated to distinguish the multiple paths of the received signal. In this method it is generally assumed that the first-arrival path (e.g., first detected signal, strongest signal, etc.) is associated with the path traveling the shortest distance, and hence is the right value to use in estimating distance between the mobile device and the transceiver. Often, this first-arrival path is the strongest path due to zero or fewer reflections, relative to the other paths, between the transceiver and the mobile device.

In various embodiments, the first-arrival time of the identified first-arrival path may be used in addition to other parameters (e.g., an estimated signal transmission time and/or a time offset between clocks of the transceiver and the mobile device, etc.) to estimate distance between a mobile device and a network component (e.g., another mobile device, a transceiver, an access point, a base station, etc.). The first-arrival time may be estimated by the mobile device (e.g., based on the downlink received signal) or by the network component (e.g., based on an uplink received signal).

The location of the mobile device may also be determined by estimating the distance between the mobile device and a network component or other signal sources (e.g., a transceiver, ground or satellite-based signal sources, etc.). For example, the location of the mobile device may be determined by performing trilateration using estimated distances between multiple (e.g., three or more) transceivers and the mobile device.

Another location determination solution may include computing an observed time difference of arrival (OTDOA) value by measuring the timing of signals received from three network components (e.g., mobile devices, transceivers, access points, etc.). For example, a mobile device may be configured to compute two hyperbolas based on a time difference of arrival between a reference transceiver signal and signals of two neighbor transceivers. The intersection of the computed hyperbolas may define a position on the surface of the earth that may be used by various embodiments to determine the location of the mobile device.

The accuracy of such OTDOA solutions may be a function of the resolution of the time difference measurements and the geometry of the neighboring transceivers. As such, implementing an OTDOA solution may require determining the precise timing relationship between the neighboring transceivers. However, in existing asynchronous networks, this precise timing relationship may be difficult to ascertain.

In various embodiments, location measurement units (LMUs) may be added throughout a deployment region of an asynchronous network to measure/compute timing information for one or more network components (e.g., transceivers) relative to a high quality timing reference signal. For example, a mobile device or an LMU may determine the observed time difference between frame timing of transceiver signals, and the observed time difference may be sent to the transceiver or a radio network controller of the communication network to determine the location of the mobile device. The location of the mobile device may also be determined based on the observed time difference and assistance data (e.g., position of the reference and neighbor transceivers) received from the communication network.

Another location determination solution may include computing an uplink-time difference of arrival (U-TDOA) based on network measurements of the time of arrival of a known signal sent from the mobile device and received at multiple (e.g., four or more) LMUs. For example, LMUs may be positioned in the geographic vicinity of the mobile device to accurately measure the time of arrival of known signal bursts, and the location of the mobile device may be determined using hyperbolic trilateration based on the known geographical coordinates of the LMUs and the measured time-of-arrival values.

As discussed above, conventional location determination solutions are typically based on single-carrier signals. The various embodiments include a ground-based location determination solution based on multi-carrier signals. A location determination solution based on multi-carrier signals may improve the accuracy of the computed location information by, for example, improving the accuracy of the timing estimation (e.g., by expanding the bandwidth of cellular signals). Location determination solutions based on multiple carriers may be used in both the device-centric (e.g., mobile device-based) and network-centric (e.g., base station-based) approaches, and may be applied to both 3GPP and 3GPP2 wireless communication technologies.

In various embodiments, a mobile device may be configured to determine its geospatial location based on information collected from mobile device sensors (e.g. gyroscope, accelerometer, magnetometer, pressure sensor, etc.), information received from other mobile devices, and information received from network components in a communication system.

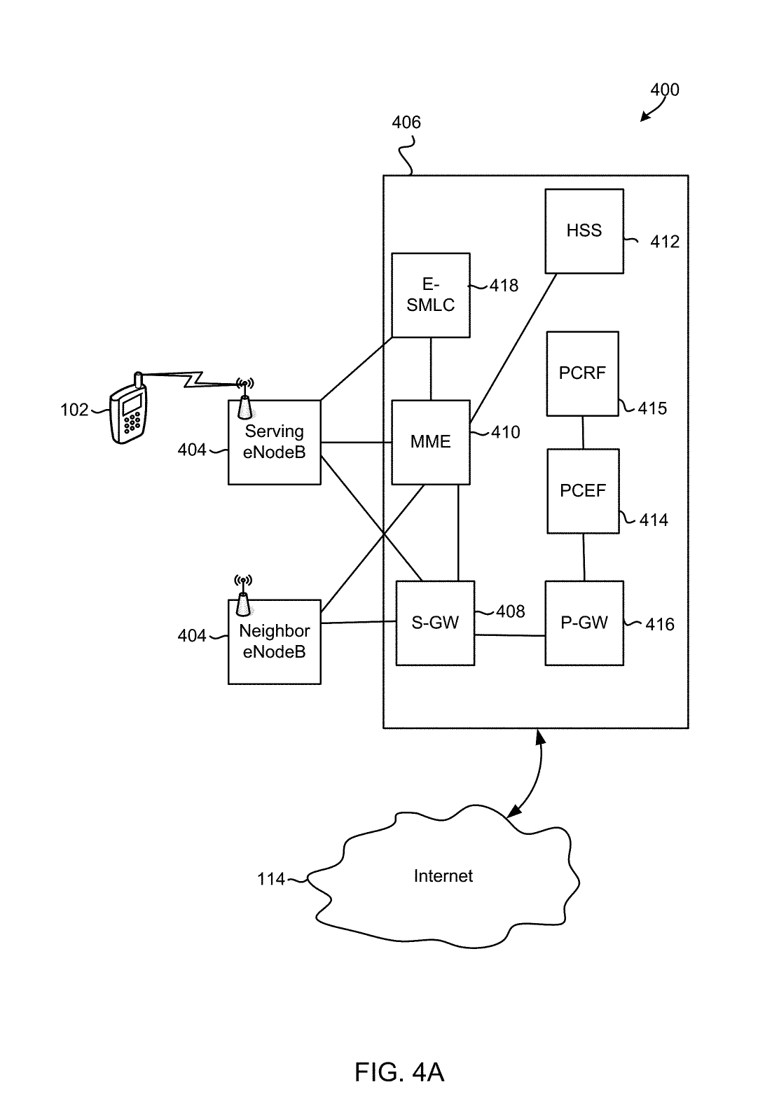

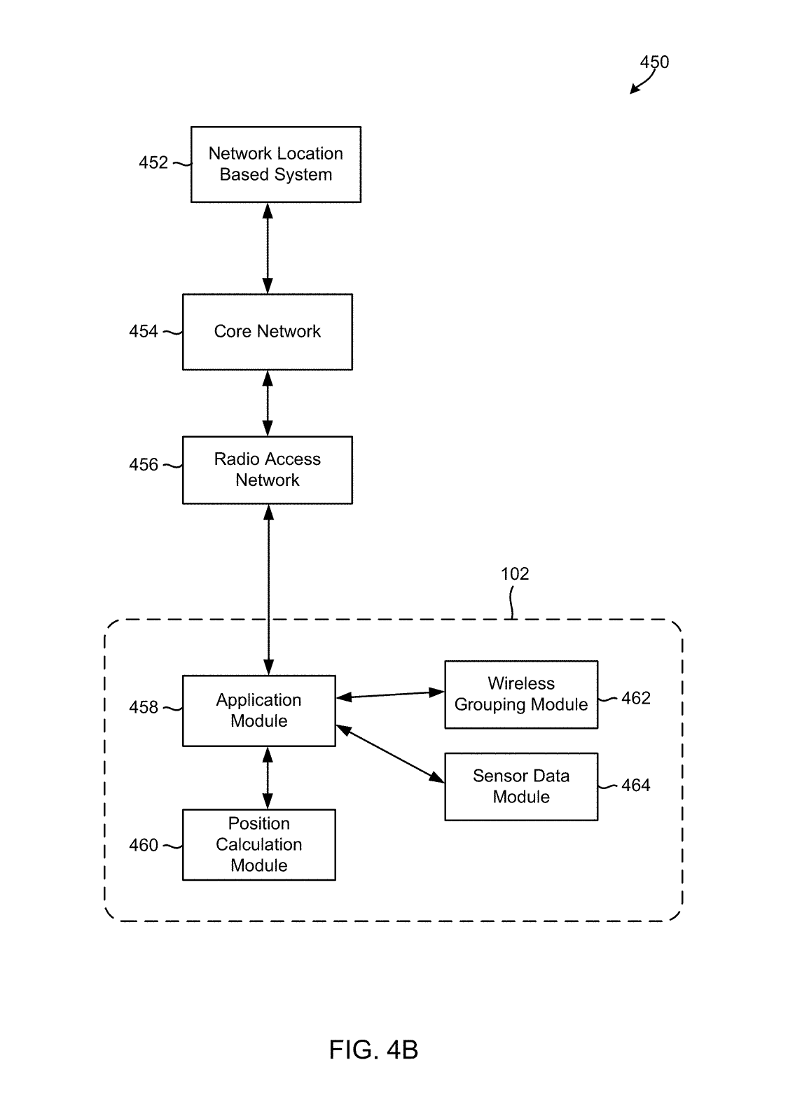

FIG. 4A illustrates an example communication system within which the various embodiments may be implemented. Generally, the mobile device 102 may be configured to send and receive communication signals to and from a network 406, and ultimately the Internet 114, using a variety of communication systems/technologies (e.g., GPRS, UMTS, LTE, cdmaOne, CDMA2000™). In the example illustrated in FIG. 4A, long term evolution (LTE) data transmitted from the wireless device 102 is received by a eNodeB (eNB) 404 and sent to a serving gateway (S-GW) 408 located within the core network 406. The mobile device 102 or serving gateway 408 may also send signaling (control plane) information (e.g., information pertaining to security, authentication, etc.) to a mobility management entity (MME) 410.

The MME 410 may request user and subscription information from a home subscriber server (HSS) 412, perform various administrative tasks (e.g., user authentication, enforcement of roaming restrictions, etc.), and send various user and control information to the S-GW 408. The S-GW 408 may receive and store the information sent by the MME 410 (e.g., parameters of the IP bearer service, network internal routing information, etc.), generate data packets, and forward the data packets to a packet data network gateway (P-GW) 416. The P-GW 416 may process and forward the packets to a policy and control enforcement function (PCEF) 414 which receives the packets and requests charging/control policies for the connection from a policy and charging rules function (PCRF) 415. The PCRF 415 provides the PCEF 414 with policy rules that it enforces to control the bandwidth, the quality of service (QoS), and the characteristics of the data and services being communicated between the network (e.g., Internet, service network, etc.) and the mobile device 102. In an embodiment, the PCEF 414 may be a part of, or perform operations typically associated with, the P-GW 416. Detailed information about policy and charging enforcement function operations may be found in “3rd Generation Partnership Project Technical Specification Group Services and System Aspects, Policy and Charging Control Architecture,” TS 23.203, the entire contents of which are incorporated herein by reference.

In an embodiment, the network 406 may also include an Evolved Serving Mobile Location Center (E-SMLC) 418. Generally, the E-SMLC 418 collects and maintains tracking information about the mobile device 102. The E-SMLC 418 may be configured to provide location services via a lightweight presentation protocol (LLP), which supports the provision of application services on top of TCP/IP networks. The E-SMLC 418 may send or receive (e.g., via LPP) almanac and/or assistance data to and from the MME 410 and/or eNB 404. The E-SMLC 418 may also forward external or network initiated location service requests to the MME 410.

In addition, the mobile device 102 may receive information from the serving eNodeB 404 via System Information Blocks that includes the neighbor cells to scan that are on the same system using the same frequencies or different frequencies, Home eNB (HeNB), in addition to CDMA, GERAN and UTRA cells.

FIG. 4B illustrates logical components, communication links, and information flows in an embodiment communication system 450 suitable for use in determining the location of the mobile device. The communication system 450 may include a network location based system 452, a core network 454, and a radio access network 456. The communication system 450 may also include an application module 458, a position calculation module 460, a wireless grouping module 462, and a sensor data module 464, any or all of which may be included in a mobile device 102. The application module 458 (e.g., client software) may request and receive location information from the network location based system 452 (e.g., through the core network 454 and the radio access network 456). Likewise, the network location based system 452 (or another client attached to, or within, the core network 454) may request and receive location information from the application module 458.

In various embodiments, the mobile device 102 may be configured to determine its geospatial location based on information collected from mobile device sensors (e.g. gyroscope, accelerometer, magnetometer, pressure sensor, etc.), information received from other mobile devices, and information received from network components in a communication system. In an embodiment, the collection and reporting of sensor information may be controlled/performed by the sensor data module 464. For example, the application module 458 may retrieve/receive sensor information from the sensor data module 464 and send the sensor information to the position calculation module 460 to compute the location of the mobile device locally for position updates and/or position augmentation. The application module 458 may also send the computed location information to the network location based system 452 and or other mobile devices.

As mentioned above, in various embodiments, the mobile device 102 may be configured to determine its geospatial location based on information collected from other mobile devices. In these embodiments, two or more mobile devices may be organized into groups. Each mobile device may also share its location information with the other mobile devices with which the mobile device is grouped. For example, mobile devices may be configured to share their current location and/or position information (e.g., latitude, longitude, altitude, velocity, etc.) and an estimate of a distance between themselves and a target mobile device with other mobile devices in their group.

In an embodiment, the grouping of mobile devices may be controlled by the wireless grouping module 462. For example, the application module 458 may retrieve wireless group information (e.g., information pertaining to the locations of other mobile devices) from the wireless grouping module 462, and send the group information to the position calculation module 460 to perform local calculations for position updates and/or position augmentation. In an embodiment, the position calculation module 460 may perform the local calculations based on both sensor information received from the sensor data module 464 and group information received from the wireless grouping module 462.

In an embodiment, the mobile device 102 may be configured to automatically share its location information with other mobile devices upon discovery of the other mobile devices. Mobile devices may augment their location information (e.g., position coordinates) with information received from other mobile devices within same geographic location, and in a controlled pseudo ad-hoc environment. Since the shared location information (e.g., latitude, longitude, altitude, velocity, etc.) involves a relatively small amount of data, in an embodiment the mobile devices may receive such information from a network server by in-band and or out-of-band signaling.

When implemented in a 3GPP-LTE network, the various embodiments may include an E-SMLC 418 component configured to send and receive location information (e.g., latitude, longitude, altitude, velocity, etc.) to and from the mobile devices, which may be achieved both on-net and off-net. The location information may be delivered in standard formats, such as those for cell-based or geographical co-ordinates, together with the estimated errors (uncertainty) of the location, position, altitude, and velocity of a mobile device and, if available, the positioning method (or the list of the methods) used to obtain the position estimate

To aid in the determination of the locations of mobile devices, 3GPP-LTE networks have standardized several reference signals. Various embodiments may use these reference signals for timing based location and positioning solutions. Such reference signals may include the primary and secondary synchronization signals and the cell specific reference signals.

As mentioned above, two or more mobile devices may be organized into groups. Mobile devices within the same group may be part of the same network, or may be associated with different networks and/or network technologies. The mobile devices within the same group may also operate on different network operating systems (NOSs) and/or radio access networks (RANs).

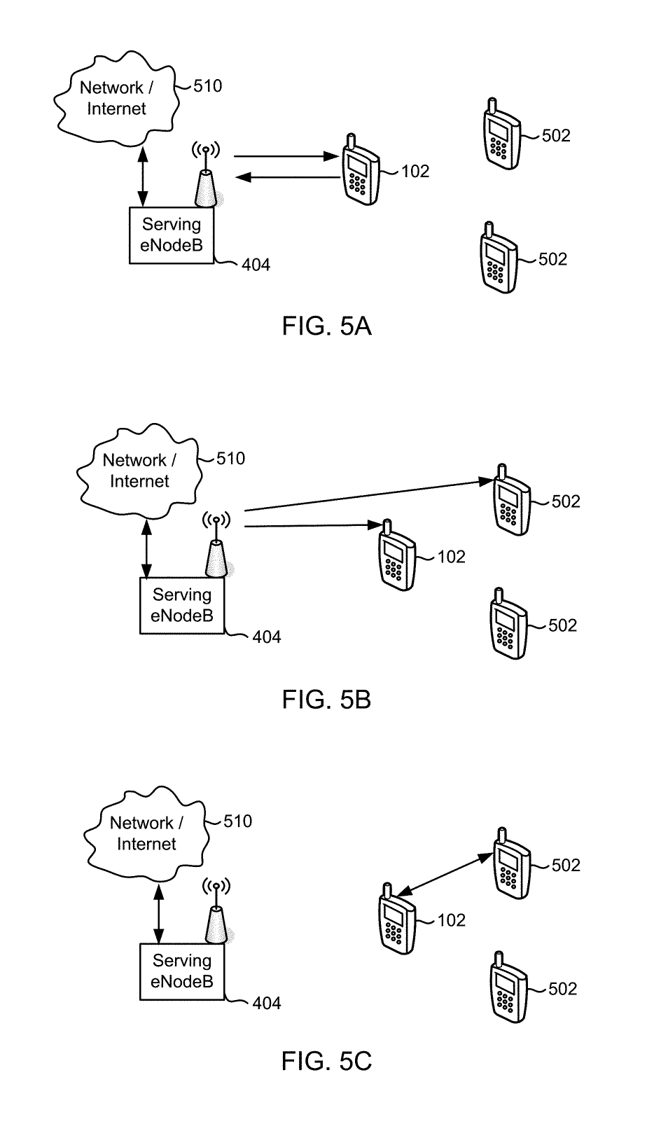

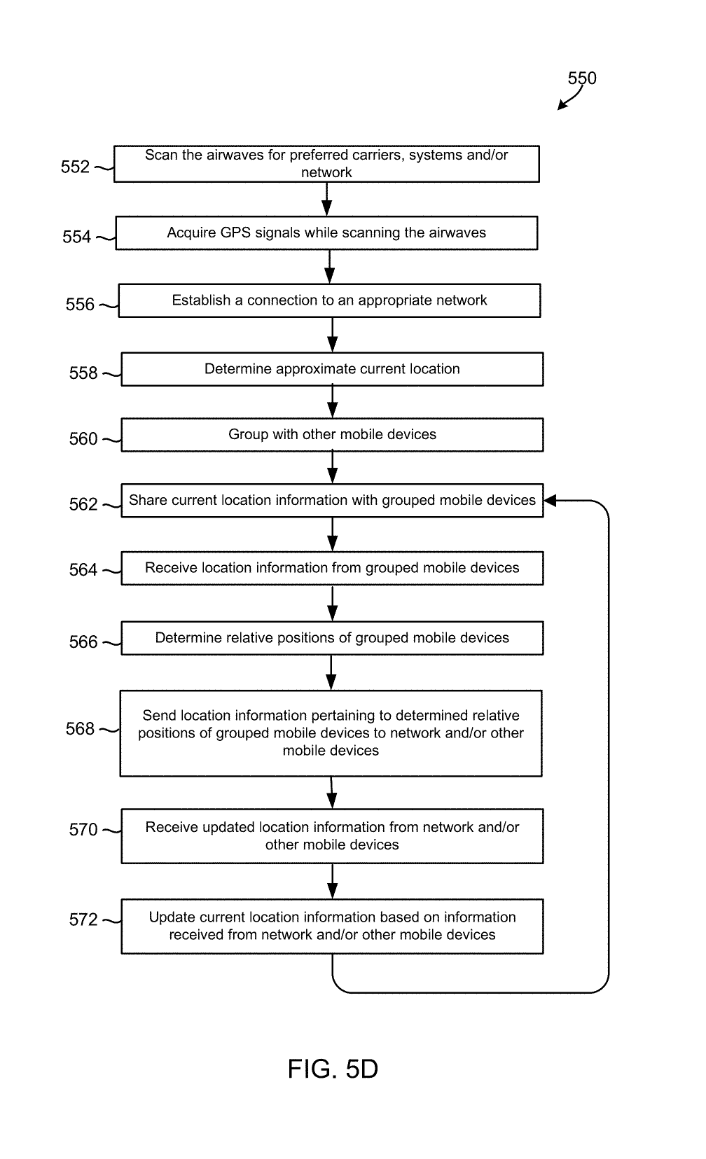

FIGS. 5A-5C illustrate functional components, communication links, and information flows in an embodiment method of grouping mobile devices and sharing location information between grouped mobile devices. With reference to FIG. 5A, after a mobile device 102 is powered on, the mobile device 102 may scan the airwaves for predefined and/or preferred radio frequency carriers and/or systems with which the mobile device 102 may connect to the network. If the mobile device 102 does not find an appropriate network with which it may connect (or loses its connection) the mobile device 102 may scan the airwaves for other radio access systems (e.g., mobile network, radio access point associated with a mobile device, etc.) to acquire (i.e., connect to) until a connection to a network/Internet 510 is established. These operations may also be performed in the event of a dropped call or power interruption.

The mobile device 102 may also begin acquiring GPS signals while scanning the airwaves for radio frequency carriers and/or systems. If the mobile device 102 cannot acquire GPS signals, a network component (not illustrated) may help determine the relative position of the mobile device 102 based on one or more of the location determination solutions discussed herein (e.g., based on the antenna used for the radio access point, the time delay, angle of arrival, etc.).

The mobile device 102 may acquire (i.e., connect to) an appropriate radio access system, radio frequency carrier and/or system via the mobile device's system acquisition system. In the examples illustrated in FIGS. 5A-5C, the mobile device 102 establishes a connection to a network 510 via an eNodeB 404. However, it should be understood that any or all of the communication technologies discussed above are contemplated and within the scope of the various embodiments.

After the mobile device 102 acquires the radio access system, the network 510 (i.e., a component in the network such as a server) will know the approximate location of the mobile device 102 (e.g., via one or more of the location determination solutions discussed above, such as proximity to base towers). In addition, the mobile device 102 may compute its current location (e.g., via GPS and/or the location determination solutions discussed above), store the computations in a memory of the mobile device, and report its current location to the network 510.

In addition to knowing the approximate location of the mobile device 102, the network 510 may also be informed of the locations of other mobile devices 502 and the proximity of the other mobile devices 502 to the recently acquired mobile device 102.

FIG. 5B illustrates that the network 510 may send instructions/commands to the mobile devices 102, 502 to cause the mobile devices 102, 502 to group with mobile devices 102, 502 and possibly others. In an embodiment, the network 510 may be configured to automatically group the mobile devices 102, 502 based on the proximity of the devices 102, 502 with respect to one another. In an embodiment, the network 510 may be configured to allow an incident command system (ICS) commander to group the devices. In an embodiment, the network 510 may be configured to allow the mobile devices to form groups based on their proximity to one another.

FIG. 5C illustrates that the mobile device 102 may pair/group with another mobile device 502 and/or establish communication links so that the mobile devices 102, 502 may share real-time relative location information with each other. Two or more grouped/paired mobile devices 102 and 502 may identify their relative positions to each other by sending relative location information over the established communication links. The relative location information may include time-to-arrival, angle-of-arrival, and existing or self-aware location information.

The mobile devices 102, 502 may be configured report sensor information to each other and/or the network 510. The sensor information may include x, y, z coordinate information and velocity information. The sensor information may be polled on a continuous basis, may be requested periodically, and/or made available on demand in response to network/system requests.

In an embodiment, a mobile device 102, 502 may be configured to report sensor information in response to determining that there is a high likelihood that there has been change in a location of the mobile device 102, 502 (e.g., in response to detecting motion). The mobile devices 102, 502 may also be configured collect and report sensor information to the network 510 in response to receiving an instruction/command from the network 510 (i.e., a component in the network such as a server or E-SLMC 418 illustrated in FIG. 4). The network 510 (i.e., a component in the network) may be configured receive the sensor and location information from the mobile devices 102, 502, and compute and store information about the distances (e.g., in time delay and angle of arrival with respect to the mobile devices 102, 502).

In an embodiment, the reporting of sensor information may be based on local parameter settings. For example, the mobile devices 102, 502 may be configured to transmit sensor information when any of the measured parameters (e.g., x, y, z and velocity information) meet or exceed a threshold value (e.g., exceed a rate-of-change, meet a timeout limit), which may be identified by local parameter settings stored in a memory of the mobile devices 102, 502. In an embodiment, the mobile devices 102, 502 may be configured to re-compute and/or update their location information in response to determining that the measured parameters (e.g., x, y, and z coordinates and velocity information) meet or exceed a threshold value.

In an embodiment, a mobile device 102 and/or the network 510 (i.e., a component in the network) may be configured to compare collected sensor information to computed latitude and longitude coordinates, relative altitude information, and other available information to determine if there is a discrepancy between the collected/measured values and the expected values. When it is determined that there exists a discrepancy between the expected and measured values, the mobile device 102 and/or network 510 may perform additional measurements to improve the location accuracy of the measurements/location information.

FIG. 5D illustrates an embodiment mobile device method 550 for grouping mobile devices and sharing location information between grouped mobile devices and the network to compute enhanced location information. After a mobile device is powered on, in block 552, the mobile device may scan the airwaves for predefined and/or preferred radio frequency carriers and/or systems with which the mobile device may connect. In block 554, the mobile device may begin acquiring GPS signals while scanning the airwaves for radio frequency carriers and/or systems. If the mobile device cannot acquire GPS signals, the mobile device or a network component may, as part of block 554, determine the relative position of the mobile device based on one or more of the location determination solutions discussed herein. In block 556, the mobile device may acquire (i.e., connect to) an appropriate radio access system, radio frequency carrier, system and/or network.

In block 558, the mobile device may compute its current location (e.g., via GPS and/or the location determination solutions discussed above), store the computations in a memory, and report its current location to the network. In block 560, the mobile device may group with other mobile devices in response to receiving instructions/commands from a network component and/or in response to detecting that the other mobile devices are within a predefined proximity to the mobile device (i.e., within a threshold distance). In block 562, the mobile device may share its current location information, as well as information collected from sensors, with the grouped mobile devices. In block 564, the mobile device may receive location and/or sensor information from the grouped mobile devices. The sensor information may include x, y, z coordinate information and velocity information.

In block 566, the mobile device may identify the relative positions of the other mobile devices, which may be achieve by evaluating the location and sensor information received from the other mobile devices and/or via any or all of the location determination solutions discussed herein. In block 568, the mobile device may send the relative location information, its current location information, and/or sensor information to a network component and/or the other mobile devices, which may receive the sensor and location information and compute updated location information (e.g., based on distance in time delay and angle of arrival, relative altitude information, etc.). In block 570, the mobile device may receive updated location information from the network component and/or the other grouped mobile devices. In block 572, the mobile device may update its current location calculation and/or information based on the information received from the network component and/or the other grouped mobile devices. The operations of blocks 562-572 may be repeated until the desired level of precision is achieved for the location information.

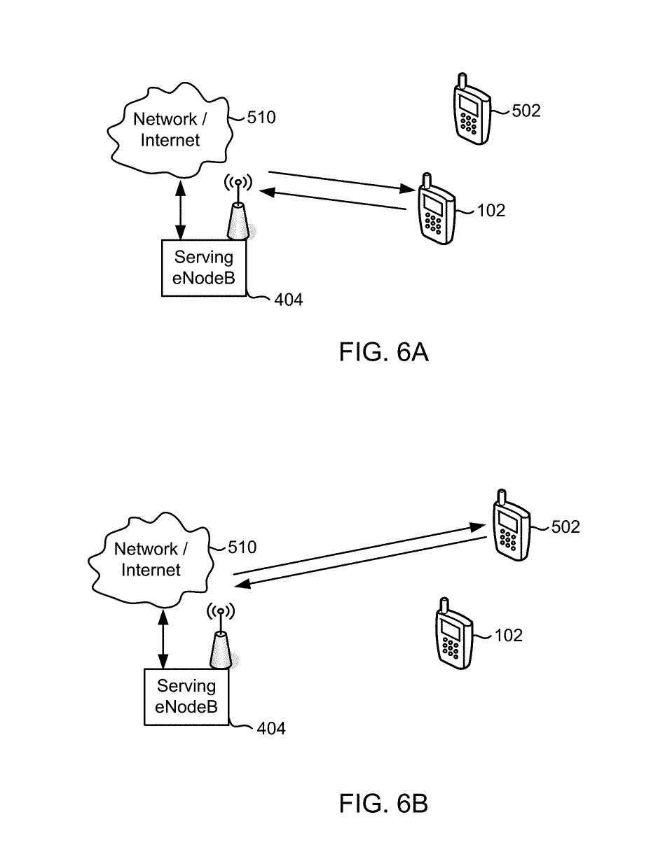

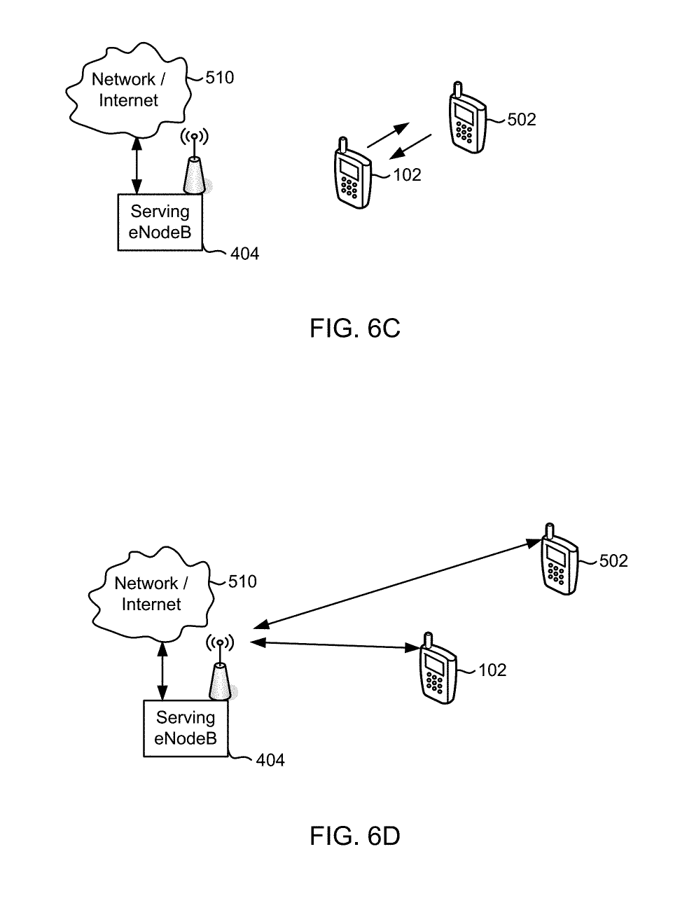

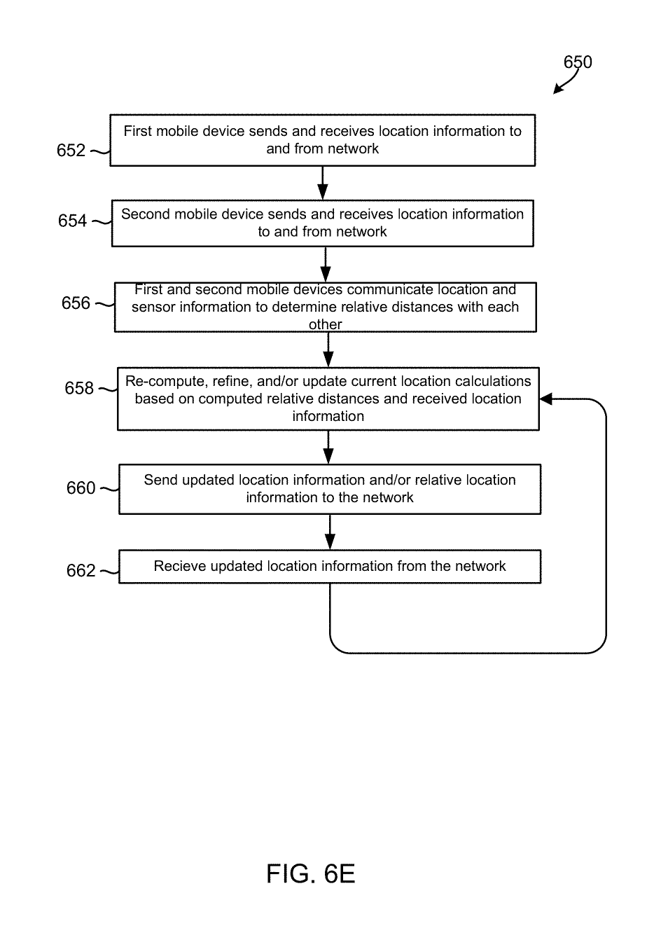

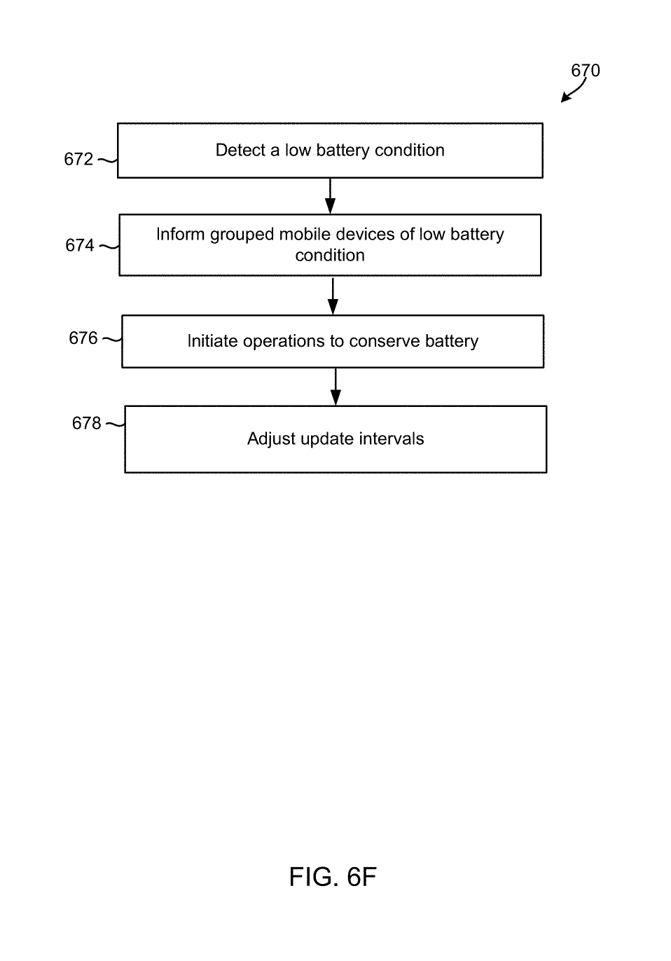

FIGS. 6A-6D illustrate functional components, communication links, and information flows in an embodiment method for computing location information in which the grouped/paired mobile devices 102, 502 are updated with their respective location information.

FIG. 6A illustrates that the mobile device 102 may communicate with a serving eNodeB 404 to relay its location information to the network 510 and/or to receive location information from the network 510.

FIG. 6B illustrates that another mobile device 502 may also communicate with the serving eNodeB 404 to relay its location information to the network 510 and/or to receive location information from the network 510.

FIG. 6C illustrates that the grouped/paired mobile devices 102, 502 may communicate with each other to determine the distance between each other, which may be achieved by the mobile devices 102, 502 communicating various types of information, such as time-of-arrival, relative position with angle-of-arrival measurements, and other similar values, measurements, or computations. The mobile devices 102, 502 may then re-compute, refine, and/or update their current location calculations and/or location information based on information received from the other mobile devices 102, 502.

FIG. 6D illustrates that the grouped/paired mobile devices 102 and 502 may send their self-aware location information and/or relative location information to the network 510 (via the serving eNodeB 404), and receive updated location information from the network 510. For example, the mobile devices 102 and 502 may send their present location coordinates, distances between mobile device (e.g., distance to each other), altitude, and bearings (e.g., where mobile device 102 is with respect to mobile device 502) to the network 220. The network may compute updated location information based on the received information (e.g., coordinates, sensor information, proximity information, etc.), and send the updated location information to the mobile devices 102, 502. The mobile devices 102, 502 may then re-compute, refine, and/or update their current location calculations and/or location information based on information received from the network.

The operations discussed above with respect to FIGS. 6A-6D may be repeated so that the mobile devices 102, 502 recursively, continuously, and/or periodically re-compute, refine, and/or update their current location calculations and/or location information based on updated information received from the other mobile devices and/or the network 510 until the desired level of precision is achieved for the location information.

FIG. 6E illustrates an embodiment system method 650 of determining the location of two or more grouped mobile devices. In block 652, a first mobile device may send and/or receive current location information to and from a network component. In block 654, a second mobile device may send and/or receive current location information to and from a network component. In block 656, the first and second mobile devices may communicate with each other to determine the relative distances between each other, which may be achieved by communicating various types of information, including time-of-arrival, relative position with angle-of-arrival measurements, velocity, altitude, etc.

In block 658, the first and/or second mobile devices may re-compute, refine, and/or update their current location calculations and/or location information based on information received from the other mobile devices and/or the network. In block 660, the first and/or second mobile devices may send their updated current location calculations and/or location information to the network component, which may receive the calculations/information and compute updated location information (e.g., based on distance in time delay and angle of arrival, relative altitude information, etc.). In block 662, the first and/or second mobile devices may receive updated location information from the network. The operations in blocks 658-662 may be repeated until the desired level of precision is achieved for the location information.

It should be understood that the methods and operations discussed above with reference to FIGS. 5A-5D and 6A-6F may also be performed such that they include more than two devices. For example, in an embodiment, the mobile devices may be grouped into units of four (4) such that each mobile device may triangulate its position relative to the other mobile devices in the same group.

In an embodiment, a mobile device 102 and/or a network component may store relative location information for all the mobile devices within each group, based on the type of grouping. For example, a network component may store relative location information for all the mobile devices grouped/paired by an incident command system (ICS) commander. Likewise, the network component may store relative location information for all the mobile devices grouped/paired based on their proximity to each another.

In an embodiment, the mobile device 102 may be configured to detect a low battery condition, and initiate operations to conserve battery. For example, a mobile device 102 may be configured to turn off its radio and/or terminate or reduce its participation in the group/pairing information exchange. As another example, a mobile device 102 may be flagged or identified as having a low battery condition, and the other grouped/paired mobiles devices may be informed of the low battery situation so that update intervals may be adjusted to reduce battery consumption.

FIG. 6F illustrates an embodiment method 670 of adjusting the update intervals in a mobile device in response to detecting a low battery condition. In block 672, the mobile device may detect/determine that the amount of power remaining in the mobile device battery is below a predetermined threshold. In block 674, the mobile device may transmit a signal or otherwise inform grouped mobile devices of the detected low battery condition. In block 676, may initiate operations to converse power, such as by turn off its radio and/or reducing its participation in exchanging information with grouped mobile devices. In block 678, the mobile device and/or the informed grouped mobile devices may adjust the update intervals with respect to the mobile device to reduce the load on the mobile device.

As discussed above, grouped mobile devices may share various types of information to improve the accuracy of the location determination calculations. For the information shared between grouped/paired mobile devices, a comparison may be made for the path, range, between the mobile devices using any or all of the information available to the mobile devices (e.g., location coordinates, sensor information, proximity information, etc.). If the two mobile devices report relative positional information that is within a user or network defined range tolerance as being acceptable this is information may be forwarded to the network. If the relative positional information is not within the user or network defined range tolerance, additional polling operations may be performed to improve the accuracy of the measurements or location information. The above-mentioned operations may be repeated until the desired level of accuracy is achieved. In an embodiment, the number of times the above-mentioned operations are repeated may determined based on a user-definable values which can be set by the network, user or algorithm used.

As mentioned above, a mobile device 102 may include two or more of the same type of sensor. In the embodiments in which the mobile device 102 includes more than one of the same type of sensor (e.g., includes two accelerometers), one of the sensors (e.g., one the two accelerometers) may be identified as a master sensor. The values measures by each sensor may be compared, and if the difference between the values falls within a tolerance range, the values measured by the master sensor may be used to compute the sensor parameters (e.g., x,y,z and velocity parameters). If the difference between the values falls outside a tolerance range, the mobile device may use information collected from other sensors (of the same or different types) to determine if the values measured by the master sensor are consistent with expected values. For example, the mobile device may use information collected from various other types of sensors to compute sensor parameters (e.g., x,y,z and velocity parameters), and compare the computed sensor parameters to similar sensor parameters computed based on the values measured on the master sensor to determine if the master sensor is functioning correctly. Values measured on the master sensor may also be compared to information stored in the network or other mobile devices to determine if the master sensor is functioning correctly. If it is determined that the master sensor is not functioning correctly, a secondary sensor may be designated as the master sensor. The previous master sensor may be demoted to standby status (i.e., for use if the primary sensor has a failure) and not used for immediate positional calculations.

As mobile devices move into an area, the mobile devices may be asked to group/pair with more devices. The number devices that a mobile device can group/pair with may be restricted by user configuration, through the system, and/or user intervention so as to conserve battery and computational efforts (e.g., when the mobile device detects a low battery condition).

In an embodiment, proximity grouping may be used in the x, y and z coordinates/fields and/or for velocity information.

In the event that a mobile device is unable to group with another mobile device with which it is instructed to group/pair with (e.g., due to a RF path problems), the mobile device may group with yet another mobile device in an ad-hoc fashion. If no mobile device is pairable with the mobile device, it may rely on its own geographic and/or and sensor information to report to the network.

When a mobile device 102 is undetected as being within a given proximity of a grouping radius, other mobile devices in the same group as the mobile device 102 may be informed of the decision to degroup/depair them from the mobile device 102. In an embodiment, the system may be configured so that an approval from the incident commander or user is required before the mobile is degrouped/depaired. In an embodiment, this may be achieved may transmitting a signal to a mobile device of the incident commander or user requesting approval, to which the incident commander or user may send a reply approving or disapproving of the request to degroup/depair. In an embodiment, the degrouping/depairing process may be transparent to the mobile device users.

In the event that a mobile device is unable to communicate with the network, the mobile device may send telemetry information pertaining to location services (and other telemetry information) to a grouped mobile device for relaying to the network.

In an embodiment, polling for information may be performed once the network has lost communication with the mobile device. Mobile devices that and known to be grouped to the mobile device may be instructed to communicate with the disconnected mobile even when it is trying to reacquire the network. A logical sequence based on proximity, signal quality to the network, and/or battery strength may be used to determine which mobile device will be used as a relay for communicating with the network.

The relayed telemetry information may include more than just positional information. For example, the telemetry information may also include bio sensor and user bio information reporting on the environment and user conditions, including heart rate and temperature, CO, O2 and other sensor information.

In an embodiment, the network may continuously measure/monitor the connected mobile devices. Knowing their location and relative location to each of the other mobile devices enables the network to continuously measure the uplink and downlink communication paths. If a communication path degradation occurs and begins to fall within a defined system quality range (which may be user defined), a mobile device may be instructed to either handover to another radio access node for the same network and/or network technology, or be instructed to initiate to perform relay operations to relay communications though a defined mobile device as a secondary signal path.

In the event that a communication link is lost with the network the mobile device may attempt to acquire itself on another network. While the acquisition process is underway, a mobile device may act as a mesh device. Other mobile devices in the proximity group may also connect as a mesh network.

In an embodiment, the mobile devices may utilize dead reckoning (also called deducted reckoning) techniques to compute updated location information. Mobile devices may store the updated information for eventual relay to another mobile device which has network access or until one of the mobile devices or both devices have access to the initial network or another network and granted access to whether it is public or a private network.

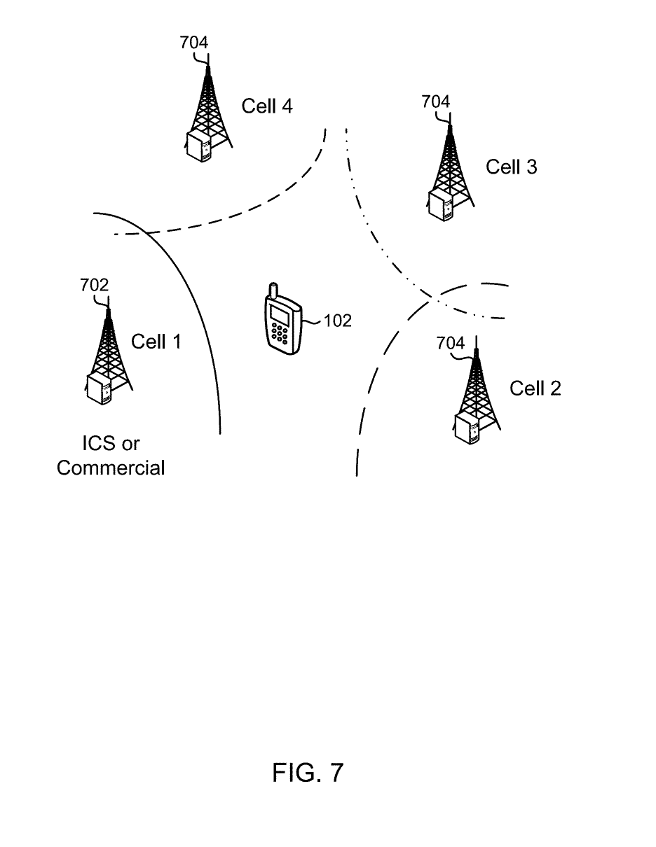

FIG. 7 illustrates normal operating conditions in which a mobile device 102 will periodically scan for other cells 704, including its serving cell 903. If the radio access points are part of the network then the mobile device will report the identity and signaling information required by the existing network to determine (e.g., via triangulating and/or trilateration) the mobile device's location based on a network approach. If the mobile device detects a radio access point is not part of its preferred cell selection process, it may attempt to read the coordinates and positional information from the access point that is broadcast.

Once synched with the access point the mobile device may determine the timing difference and other requisite information to help determine its relative location and distance from the access point. This information may be related to the location system used by the mobile device to help refine its current location calculations.

Additionally the mobile device may be configured to compare each cell read to its own coordinate and using bearing and time difference for all the cells it reads. The mobile device may then triangulate on its own position.

During a 911 call a software application on the distressed mobile device may be executed. The software application may access an active neighbor list, read the overhead of each cell, and use that information to triangulate on the mobile device's own positions. The mobile device may also read the time offset for each of the cells.

In this case the system begins to try and locate the distressed mobiles position with more precision an accuracy to assist First Responders with triangulating on the distressed mobiles position and sending the information to the incident commander and/or public service answering point (PSAP) with a relative distance to target indication that is updated on pre-defined intervals. If the mobile device has lost contact with the 911 center, PSAP then the last location is continuously display and any velocity information is also relayed to assist the first responders.

In an emergency, the mobile device 102 may be configured to send its location information to the network. The mobile device 102 may be configured to automatically send its location information in response to detecting the emergency, or may provide the user with an option to send the location information. In an embodiment, the mobile device 102 may be configured to send its location information in response to a network initiated command.

Each mobile device may become an access point (AP). The decision to be the access point may be periodically updated while still in communication with the network, or when no network is found. Upon powering up, each mobile device may act as a client, and on a pseudo random time interval, the mobile devices may become an access point and then a client.

The location based methodology may be the same for a frequency-division duplexing (FDD) and a time-division duplexing (TDD) system. However in the event that the communication link between the mobile device and the network is lost, the mobile device may be configured to relay its telemetry information through another mobile device having network access.

In an embodiment, all information sent via wireless communication links may be digital. In an embodiment, the information may be encrypted to a requisite advanced encryption standard (AES) standards level or the appropriate encryption level needed for the requisite communication system and access method used.

Generally, the location based systems (LBS) may utilize reactive or proactive based methods. In a reactive location based system, the mobile devices may synchronously interact with each other on a time basis or some other predetermined update method. In a proactive location based system, the mobile devices may update their location information based on a set of predetermined event conditions using an algorithm. The various embodiments may include both reactive and proactive aspects, taking the best of both approaches to enhance location accuracy and precision.

Various embodiments may include location determination solutions that utilize horizontal data (i.e., a set of reference points on the Earth's surface against which position measurements are made) and/or vertical data. Horizontal data define the origin and orientation of the coordinate system and are prerequisites for referring a position relative to the Earth's surface. Vertical data are based on geoids, which primarily serves as a basis to determine the height of a position relative to means sea level for which the geoids act as a benchmark for origin and orientation. Various embodiments may utilize horizontal and vertical data to provide/generate enhanced three-dimensional location information. The horizontal and vertical data can be global, national, local or custom depending on the locality and positioning reference system utilized.

Traditionally global data are used for position location as compared to a local datum. Global data are used for initial position fixing if possible and are based on GPS coordinates. Local data are based on a particular position on the surface of the earth, which allows for a non GPS based location based services to take place. The various embodiments may use global data, local data, or both. In an embodiment, GPS may be used to help identify the initial positional fix, and may be augmented by dead reckoning and a hybrid trilateration solution that utilizes both network and terminal based positioning. In this embodiment, both local and global data may be used.

Generally, a hybrid lateration and trilateration solution includes a mobile device performing a measurement and sending it to the network, and a network component performing the location determination calculations. The various embodiments include a hybrid lateration and trilateration solution in which the mobile device performs the location determination calculations, with and without the support of the network components.

Various embodiments may include sensor fusion operations in which a collaborative approach is used so that the sensors do not act as individual sensors, but as a collective team. As discussed above, the mobile device may include various sensors (e.g., accelerometer, gyros, magnetic compass, altimeters, odometers, etc.) capable of generating heading, orientation, distance traveled, and velocity as part of the sensor information collected on the mobile device. In various embodiments, information collected from any or all the internal sensors may be used for improving location or positioning accuracy and/or confidence improvements. Various embodiments may compute location information based on information from multiple sensors, with or without the aid of radio frequency propagation information.

The sensor fusion operations may include the sharing of telemetry including sensor data indicating relative movement of the individual mobile device, which enables temporal readings to assist in the location estimate, either with external assistance or dead reckoning.

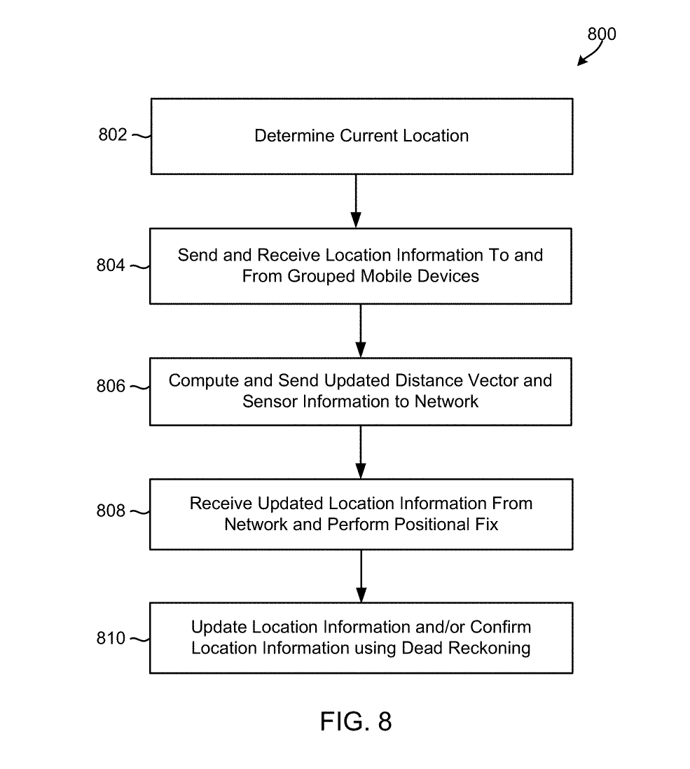

FIG. 8 illustrates an embodiment mobile device method 800 for determining the location of a mobile device in a wireless network. In block 802, a mobile device may determine its current location using any of the above mentioned location determination solutions. In block 804, the mobile device may share its location information with other grouped mobile devices and/or receive location information from other grouped mobile devices. In block 806, the mobile device may compute and send updated distance vector and sensor information to a network component for improved positional fix. In block 808, the mobile device may receive updated location information from the network component, and perform its own positional fix based on mobile data information received from the network. In block 810, the mobile device may update its location information and/or confirm its location information using dead reckoning to enhance positional accuracy.

Dead reckoning may provide the needed positional corrections as a local datum method for positioning when GPS or other network related positioning solutions are not available. Additionally dead reckoning may enhance the location position accuracy and precision calculations by providing and additional horizontal and vertical datum comparisons.

With dead reckoning, the current position may be deduced (or extrapolated) from the last known position. The dead reckoning accuracy requires a known starting point which either can be provided by the network, GPS, near field communication link, RF beacon, or via another mobile device.

A dead reckoning system may be dependent upon the accuracy of measured distance and heading, and the accuracy of the known origin. However the problem with relying on dead reckoning alone to assist in positional improvement is error accumulation caused by sensor drift (i.e., differences or errors in values computed/collected from one or more sensors). In particular, magnetic, accelerometers and gyroscopes are susceptible to sensor drift. The error accumulation for any of the sensors may increase over undulating terrain, as compared to flat terrain. Bias error and step size error are leading contributors to dead reckoning errors.

Various embodiments may tightly couple the mobile device sensors and continuously recalibrate the sensors to reduce any drift problems caused by unaided dead reckoning. Additionally, as part of the tightly coupling the sensors, any bias drift associated with the sensors (e.g., a gyroscope) may be address by utilizing a Kalman filter to reduce the errors from the primary and/or secondary sensors (e.g., gyroscopes). The Kalman filter may be a single axis Kalman filter, a two dimensional Kalman filter, a three dimensional Kalman filter, or any other Kalman filter that is known is the art.

In various embodiments, the mobile device may be configured to include velocity computations as part of the location determination computations to account for position changes that occur. When a GPS signal is available, the step size (via velocity computation) and compass bias errors may be estimated by an Enhanced Kalman Filter (EKF). Additionally if GPS is available, the compass may also be able to identify slow motion changes due to changes in magnetic inclination. The compass may be relied upon for motion computations in addition to that of accelerometers and gyroscopes, with and without the availability of GPS.

Dead reckoning accuracy degrades with time, requiring regular position updates or positional corrections. Therefore, the mobile device may be configured to not only use its own internal sensors to compute the location/positional information, but may also communicate with other mobile devices to leverage their location/positional information to enhance its own location/positional information. In essence, the mobile devices may act as RF base stations, proving the lateration capability to improve the positional accuracy of other mobile devices.

In an embodiment, a mobile device may be configured to poll one or more other mobile devices to gain a better positional fix on its location.

Mobile devices may be grouped together, either through assignment by the network or through the mobile device acquiring/detecting/connecting to other mobile devices (which may or may not be in the same network) as part of a discovery method for sharing location information.

Location information may be shared via the use of a near field communications system (e.g., Bluetooth®, ultrawideband, peanut radios, etc.), infrared, ultrasonic, and other similar technologies, such as via the use of WiFi. The wireless communications may also be ad hoc or infrastructure based, or based on a TDD system, such as LTE, SD-CDMA, TD-CDMA, or any other TDD methods.

In an embodiment, the mobile device may be configured to initiate the sharing of location/position information in response to receiving a network-driven grouping request from a network component.

In an embodiment, when the mobile device has lost contact with the network, it may attempt to find a suitable mobile device to help in its location determination computations, and for possible connection to the network (e.g., via a relay).

In an embodiment, the mobile device may be configured to send a request for location information to another mobile device. The request may be sent after the authentication process between mobile devices, and may include a time stamp which may be sub-seconds in size (milliseconds). Another mobile device may respond with a message that also has its time stamp and when it received the time stamp from the initiating mobile device.

Several messages (e.g., three messages) may be exchanged quickly between the mobile devices to establish time synchronization and share location/positional information that includes x, y, and z coordinates and a velocity component in each message. The time differences along with the x, y, and z coordinates may be compared with possible pulses or pings to establish an estimated distance vector between the devices.

When the distance vector and the x, y, z coordinates of two mobile devices are known, a point-to-point fix may be established. This process may be repeated for all the mobile devices in a group that has been assigned or created by the mobile device itself. Having multiple distance vectors from other points to the mobile will enhance the positioning accuracy.

A mobile device may be configured to report back to the network location server the distance vectors it has found between different mobiles. The other mobile devices also involved with the positioning enhancement may also report their distance vectors to the network to have their overall position accuracy improved as well.

The positional accuracy is meant to be done in incremental steps and the process will continue until no more positional improvements will be achievable. The positional accuracy improvement threshold may be operator defined, and may be stored in a mobile device memory.

When collecting the distance vectors and other positional information, if the error in position is greater than x % for a lower positional confidence level then no update may be required. As the mobile device receives other sensor data and more than a pre-described distance in any direction or a combined distance vector than the positional update process begins again. However if the x % of positional confidence level is less than desired additional positional, updates may be made with the mobile devices grouped together in an interactive process to improve the confidence level of the positional information.

It is important to note that typical positional location methods that are used currently by the network are not necessarily replaced with above-described positional lateration. Instead, the hybrid lateration method may be used in various embodiments to augment the positioning accuracy and confidence for network based position request due to boundary changes or paging requests or other position location triggered events.

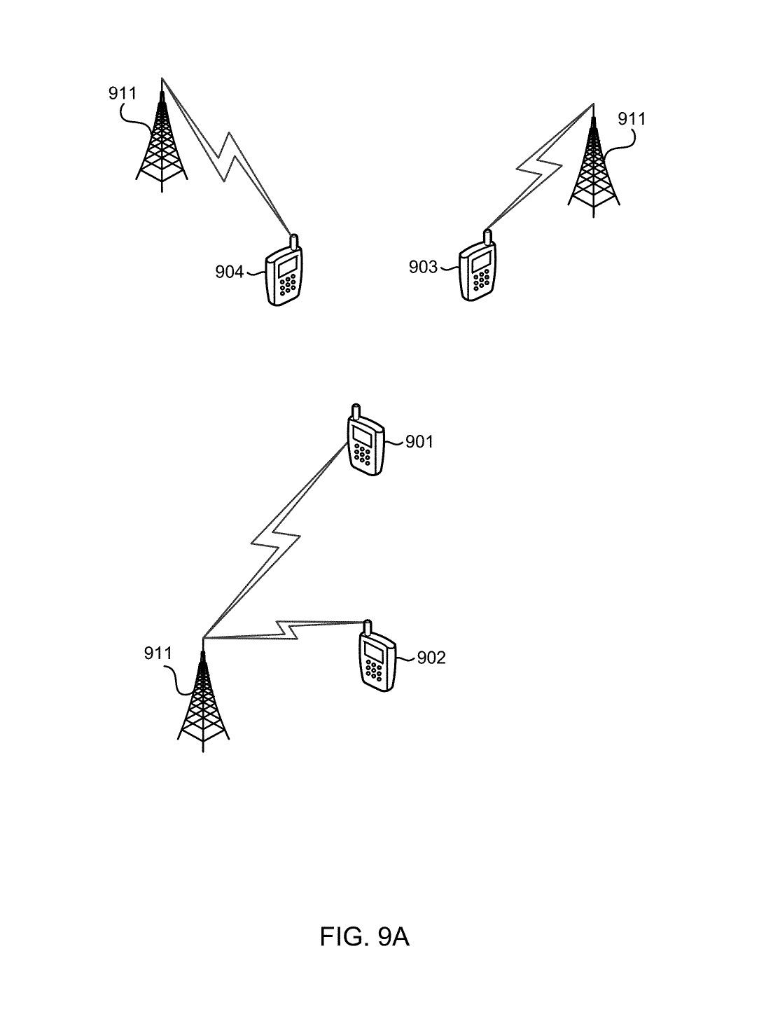

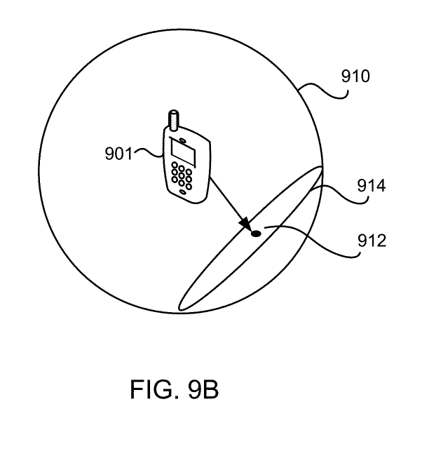

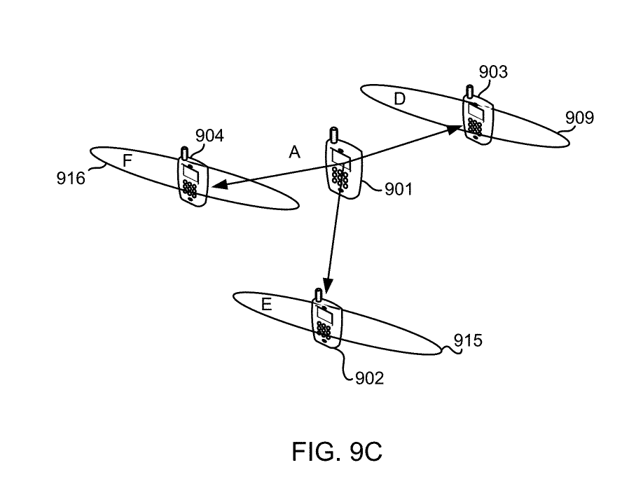

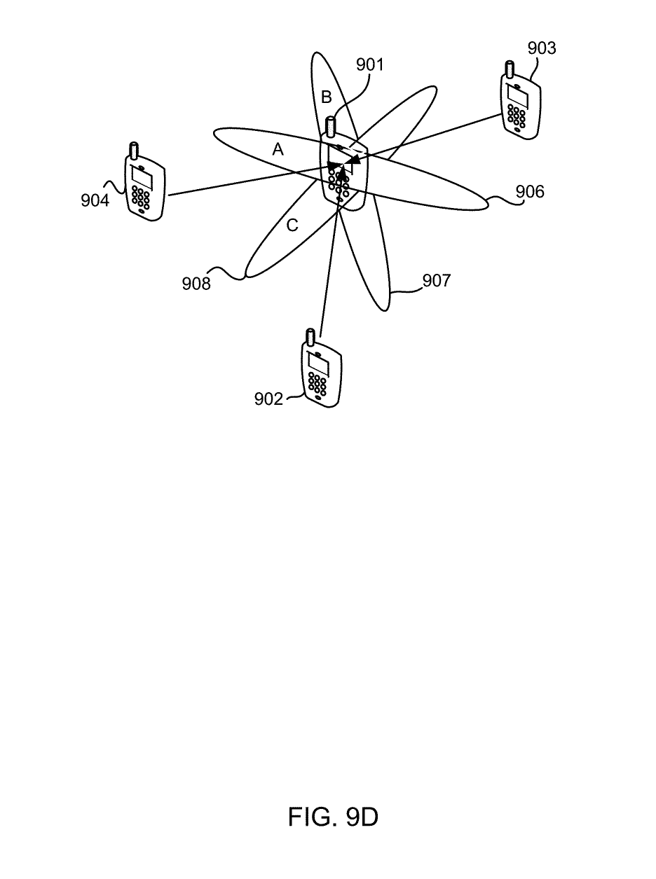

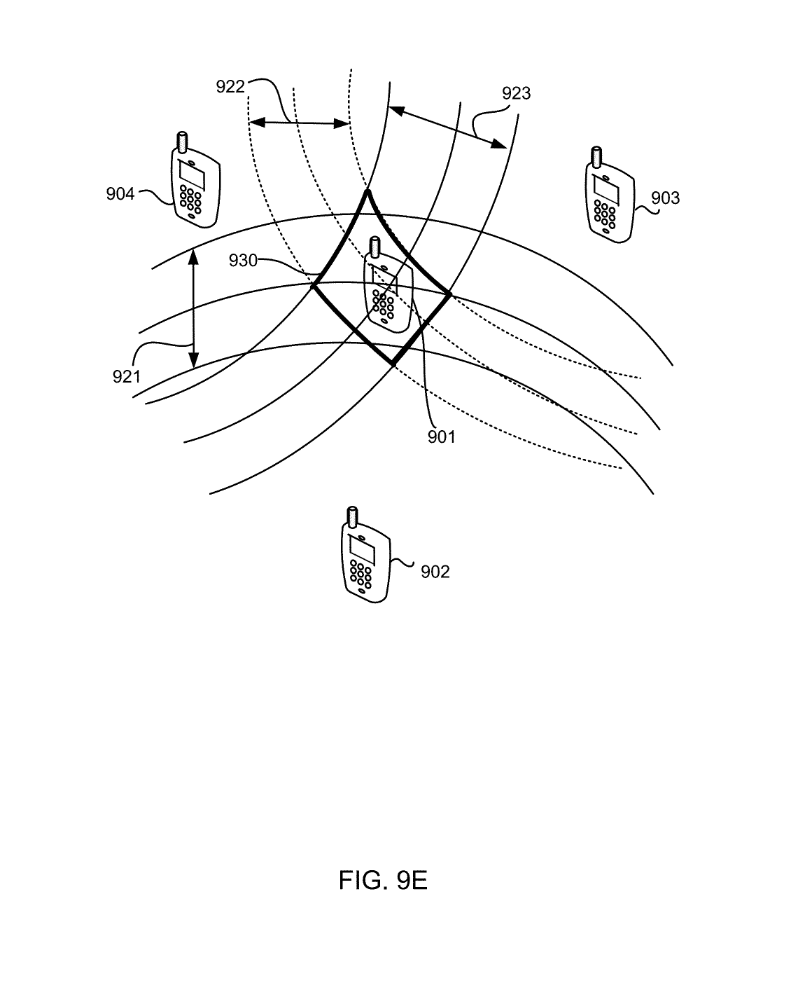

FIGS. 9A-9E illustrate various logical components, information flows and data suitable for use in various embodiments. FIG. 9A illustrates that mobile devices 901, 902, 903, and 904 are communicating with the wireless network via multiple cell sites/radio access points/eNodeBs 911. The mobile devices 901, 902, 903, and 904 may compute a relative fix on their initial location using any of the location determination solutions discussed above. A first mobile device 901 may be instructed to find and communicate with the other mobile devices 902, 903 and 904, and/or any or all of mobile devices 902, 903 and 904 may be instructed to communicate with the first mobile device 901. The mobile devices 901, 902, 903, and 904 may be grouped together (e.g., via one of the grouping methods discussed above). The network may also designate one of the mobile devices 901 (e.g., a mobile device having a high position confidence) to be used as the reference or beacon for the other mobile devices 902, 903, and 904 within the group of mobile devices 901, 902, 903, and 904.

FIG. 9B illustrates that a combination of circular and hyperbolic trilateration operations may be performed as part of an embodiment location determination solution. For example, if any of the coordinate data provided by the sensors and/or mobile devices is in latitude and longitudinal coordinates, it may be converted to Cartesian coordinates to facilitate a hybrid lateration calculation. In the example illustrated in FIG. 9B, the mobile devices 901 has been designated as reference mobile device, reference number 912 identifies the position to be determined/computed (i.e., with a high level of accuracy) with respect to mobile device 901, reference number 910 identifies a three-dimensional sphere that encompass the mobile device 901, and reference number 914 identifies an area of the three-dimensional sphere (with x, y and z coordinates) within which the device exists.

FIG. 9C-9D illustrate that distance vectors may be computed between the mobile devices 901, 902, 903, and 904 as part of an embodiment location determination solution. In FIG. 9C mobile 901 using the hybrid trilateration method determines is relative position with respect to mobile devices 902, 903 and 904 respectively, Additionally, reference numbers 915, 909, and 916 identify the relative areas of mobile devices 902, 903, and 904, respectively. As part of the hybrid trilateration operations of the embodiment location determination solution, mobile devices 902, 903, and 904 may locate mobile device 901, and the mobile device 901 may compute a distance vector between itself and mobile devices 902, 903 and or 904. The mobile device 901 may initiate communications with mobile device 902 (although mobile device 902 could initiate the communication) and exchange time stamps, positional information, sensor data. The same process may occur with respect to mobile devices 904 and 903, in which positional and sensor information is exchanged.

As illustrated in FIG. 9D, the mobile devices 902, 903, and 904 may establish a distance vector between themselves and mobile device 901. The same process may occur with respect to mobile devices 902, 903 and/or 904, in which positional and sensor information is exchanged. Where mobile device 902 undergoes the same process as that done with mobile device 901 as part of the hybrid trilateration process, mobile device 901 may use mobiles 902,903, 904 to enhance it positional information and mobile device 902 may use mobiles 901,903 and 904 to enhance its positional information, and so forth for all the mobile devices that are grouped together.

The three circles or ellipses 909, 915 and 916 illustrated in FIG. 9C and the three circles or ellipses 906, 907 and 908 illustrated in FIG. 9D do not intersect at a given point, but span an area of a particular size depending on the range involved.

FIG. 9E illustrates an embodiment hybrid trilateration method in which the position of mobile device 901 is validated or improved upon. As part of the hybrid lateration method, a separate calculation operation may be required for each x, y and z coordinates, in addition to accounting for velocity. However, the ability to have three mobile devices 902, 903, and 904 locate mobile device 901 may present an error window (or an error area) for each coordinate plane represented by reference number 930. The error window/area may be a combination of range errors from the mobile devices 902, 903, and 904. Contributing to the error window/area is the hybrid range errors illustrated by reference numbers 921, 922 and 923, where: reference number 921 is the hybrid range error associated with mobile device 902; reference number 922 is the hybrid range error associated with mobile device 903; and reference number 923 is the hybrid range error associated with mobile device 904. Additionally this process can be done with less or more mobile devices than used in the above example.

For each axis(x, y, or z), a similar process occurs where the error area 930 is a combination of determining the range between the other mobile devices and mobile device 901. The hyperbolic lateration is a typical calculation method used in location based systems and is based on the principal that the range between two locations is the same. However the range determined for the points may not be constant since both can be moving toward, away or together at a similar velocity and trajectory.

With the hybrid lateration method proposed a corrective distance vector Δx,Δy,Δz is used that can be used to apply to the estimated position.

The three circles or ellipses 909, 915 and 916 illustrated in FIG. 9C and the three circles or ellipses 906, 907 and 908 illustrated in FIG. 9D do not intersect at a given point, but span an area of a particular size depending on the range involved. Therefore range is “r” and is denoted by the subscript representing the distance vector involved. Thus:

r=pᵢ+error

The pseudo range pᵢ deviated from the actual range in any axis due to the inaccuracy in synchronization or propagation in a multipath environment or due to sensor induced errors. Where the distance vector accounting for change in direction is:

rᵢ=√(Xᵢ−x)²+(Yᵢ−y)²+(Zᵢ−z)²

Three range calculations are then averaged to determine the distance vector that is used. If the previous range calculation rⱼ as compared to that of the current calculation has an error in excess of a user defined % or variant then the new measurement is disregarded. Included with the distance vector validation may be the fusion sensor information where expected position verse calculated may be included for the confidence interval.

Range difference=dᵢⱼ=rᵢ−rⱼ

An iterative process may be used for position improvement, which may include the use of a least squares calculation fit to approximate the position solution in a step wise basis. The process may continue until the range difference measured does not produce any noticeable accuracy improvement, which may be user-defined, either at the mobile device or network or both.

The multi-lateration calculations may include estimating a location of a mobile device based upon estimated distances to three or more measurement locations (i.e., locations of three other mobile devices or wireless transceivers). In these calculations, the estimated distance from a measurement location (location of another mobile device) to the mobile device may be derived from the measured signal strength. Since signal strength roughly decreases as the inverse square of the separation distance, and the transmission power of the mobile device can be presumed, the distance dᵢ can be simply calculated as:

dᵢ=√(S₀/Siᵢ)
where:
dᵢ is the estimated separation distance between a measurement location and the mobile device;
Sᵢ is the measured signal strength; and
S₀ is the strength of the signal transmitted by the other mobile device.

Alternatively, the signal strength readings may be translated into distances using a path loss model, such as the following:

RSSIᵢ=a−cb log₁₀(dᵢ)
where:
a is the signal strength at dᵢ=1 meter;
b is the path loss exponent; and
c is the pathloss slope with 20 being used for free space.

The lateration operations may include performing a least squares computation, which may accomplished by a processor calculating the following formula:

min_{(x,y)}Σ(dᵢ−∥MSᵢ−(x,y)∥)²
where:
dᵢ is the distance calculated based on a measured signal strength value;
MSᵢ corresponds to the known location/position of the mobile device; and
the minimization value of (x, y) is the estimated position of other mobile devices.

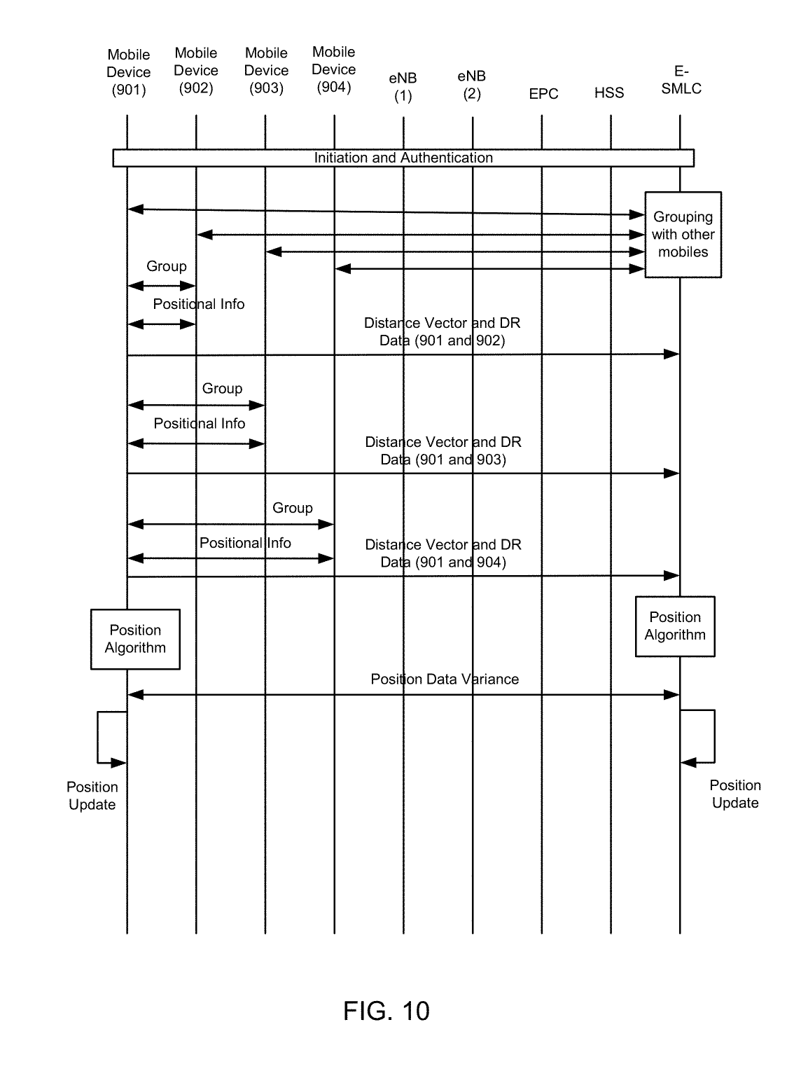

FIG. 10 illustrates an embodiment hybrid lateration method 100 in which mobile devices may gain access to the network. The mobile devices may be instructed to be grouped by the network. Mobile devices 901 and 902 may initiate sharing of information for position location, either due to the network driven grouping request or when the mobile device has lost contact with the network and attempts to find a suitable mobile device to help in its position location and possible connection to the network via a relay or to another network.

Mobile device 901 may send a request for position information to mobile device 902. The information may be sent after the authentication process between mobile devices, and may include a time stamp. The time stamp may be sub seconds in size (e.g., milliseconds). The mobile device 902 may respond with a message that also has a time stamp, and timing information pertaining to when the mobile device 902 received the time stamp from mobile device 901. Three messages may be transferred quickly to establish time synchronization. The time differences may then be compared, along with possible pulses or pings, to establish an estimated distance vector between the mobile devices. Knowing the distance vector and the x, y, and z coordinates of both 901 and 902, a point-to-point fix may be established.

The mobile device 901 may then initiate communication with mobile devices 903, 904 and repeat the operations discussed above with respect to mobile device 902 for each of mobile device 903, 904. After obtaining two or more distance vectors along with positional information, the mobile device 901 may compare the new coordinates to its previously computed current location, and adjust the location computations accordingly.

The positional information distance vectors may be sent to the network for positional processing with other network positional information. Based on the position calculated for the mobile device, the network (i.e., a component in the network, such as a network server or E-SMLC) may instruct the mobile device to adjust its positional information.

Additionally the mobile device 901 may also make a positional correction if the network either does not respond in time, which may result in a message update time out. Alternatively, when the network cannot make the necessary correction, and the positional information may used by another component and/or other mobile devices to perform the necessary corrections.

If the error is greater than x % for a lower positional confidence level then no update is required. As the mobile receives other sensor data and more than a pre-described distance in any direction or a combined distance vector than the positional update process begins again. If the x % of positional confidence level is less than desired, additional positional updates may be made with the grouped mobile devices (e.g., iteratively) to improve the confidence level of the positional information. Additionally if the positional information from one of the mobile devices that is being attempted to obtain a distance vector appears to be in error, then that mobile devices data may be selected to not be used for this iterative step of performing positional updates with other grouped mobile devices. However it will continue to be queried as part of the process since its position location could be corrected in one of the steps it is taking to improve its position location as well.

Additionally in the event that one or more mobile devices lose communication with the core network it will still be possible to maintain position accuracy through one of the other grouped mobile devices. It will also be possible to continue to maintain a communication link by establishing a network relay connection with another of the mobile devices in the same group which still has communication with the network itself

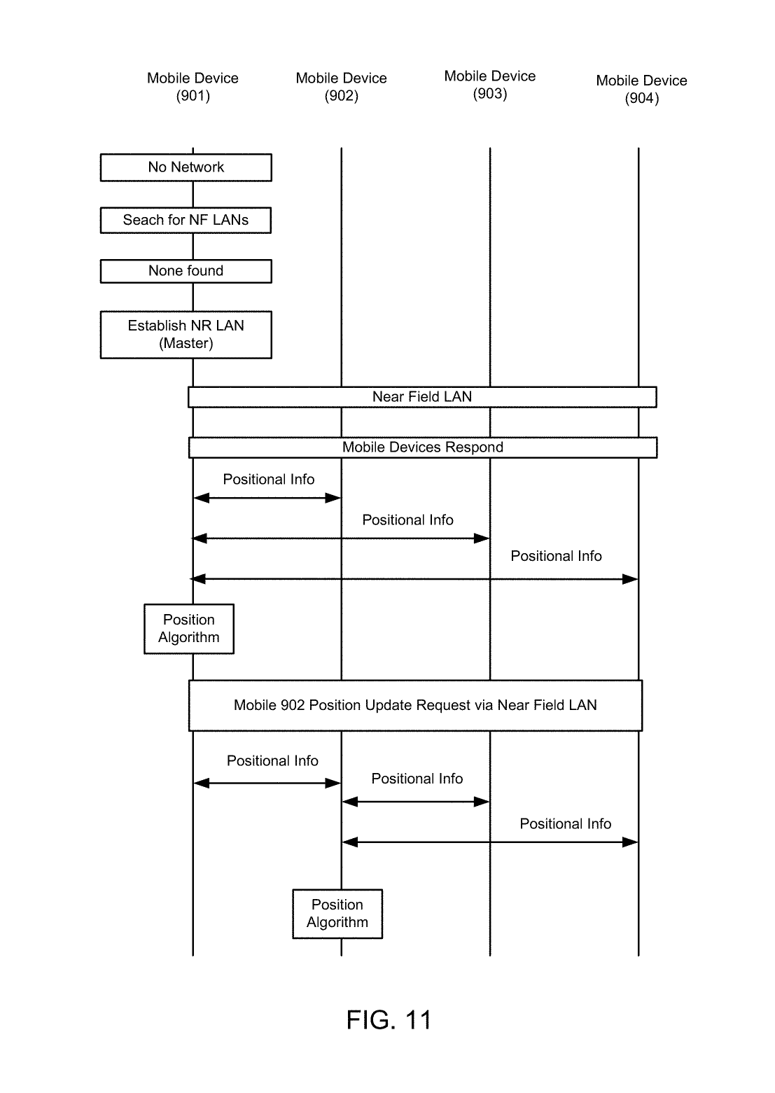

FIG. 11 illustrates another embodiment hybrid lateration method 100 in which a mobile device cannot locate a network due coverage problems. The mobile device 901 may operate in an autonomous mode and attempt to locate another mobile device. The other mobile device could be used to relay information to the network and possibly set up a near field communication bridge in addition to providing location enhancement capability.

In the example illustrated in FIG. 11, mobile device 901 establishes a near field LAN inviting other mobile devices in proximity to communicate with it. Positional information can then be shared and the mobile device 901 can have its location improved and the positional information can be relayed back to the core network via another mobile device.

The mobile device 901 may also communicate its positional information and establish near field communication link with a mobile device that is not part of the home network associated with mobile device 901.

The mobile devices may have the USIM, SIM, PRL or access point information pre-built in. The mobile device for first responders may have the incident radio system set as their preferred system, or in the case that the radio access system being used as a public safety network.

For first responders to utilize a wireless mobile network (e.g., LTE) the position location information accuracy needs to improve for in-building environments in addition to providing more accurate location information about where the mobile devices are actually located. Whether the mobile device is used by a first responder, commercial cellular user or a combination of both.

The positional location improvement for first responders may be helpful to improve situation awareness, improved telemetry and overall communication with the incident commander. Since all incidents for first responders tend to be fluid the ability to account for a dynamic environment of mobile devices will come into and out of the incident area. In addition, the mobile devices proximity location to other mobile devices can and will change as the incident situation changes where resources are added and or reassigned as the need arises for operational requirements.

The use of network and terminal driven position enhancement techniques previously discussed may be exploited. The grouping of mobile devices may be done either as part of pre-plan, with intervention by the incident commander or driven from the commercial wireless network, public safety wireless network or local incident communication system (ICS) 1204 based on reported proximity of the mobile devices.

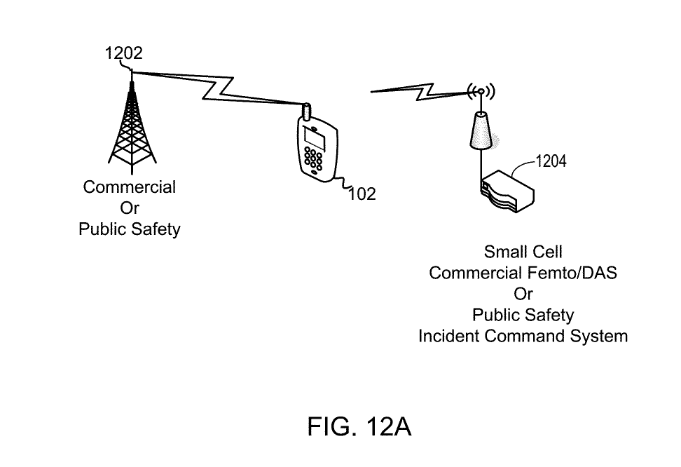

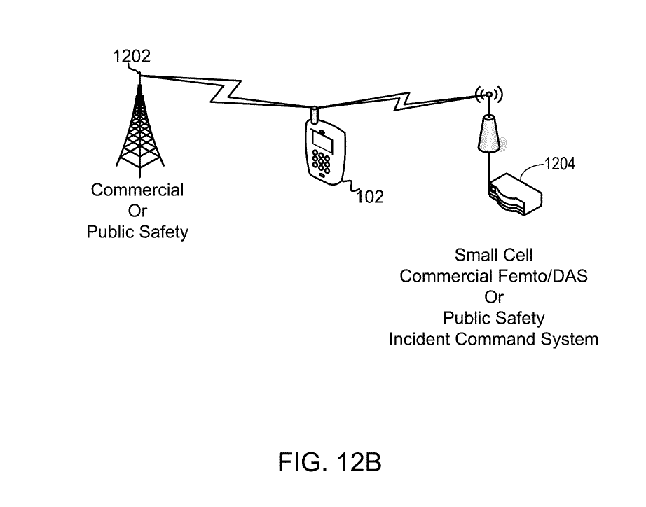

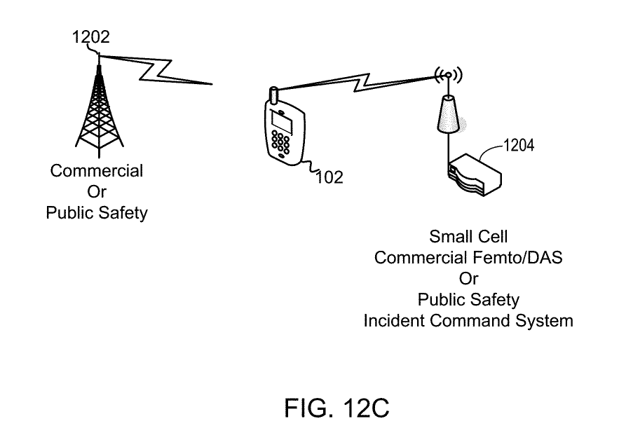

FIG. 12A illustrates that upon arriving at the incident scene, a mobile device 102 may recognize the existence of a local radio network 1202. If there is no ICS radio network 1204 with which the mobile device may connect, the mobile device 102 will continue to communicate via a commercial or other wireless network, 1202.

FIG. 12B illustrates that the mobile device 102 may determine that there is a valid local radio system 1202 with which it may communicate, and may have a priority access to small cell system 1204 a based on a preferred network and cell selection process the mobile device 102 has been instructed to use.

FIG. 12C illustrates that the mobile device 102 may transfer the connection from the local radio system 1202 to the small cell system 1204.

For first responders when a situation arises that requires finding a man down or responding to an emergency call (911) the location based process can be used to help in the search and rescue of the person.

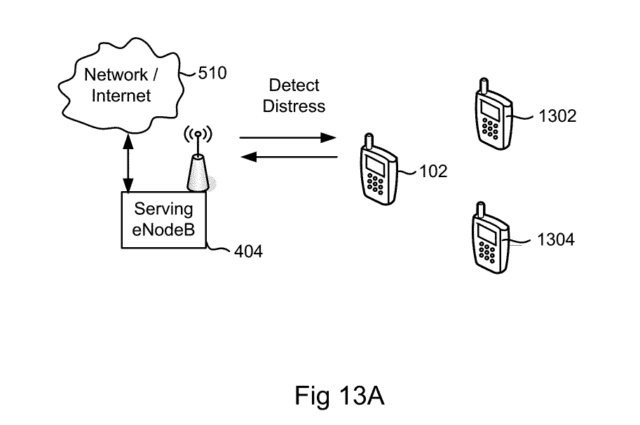

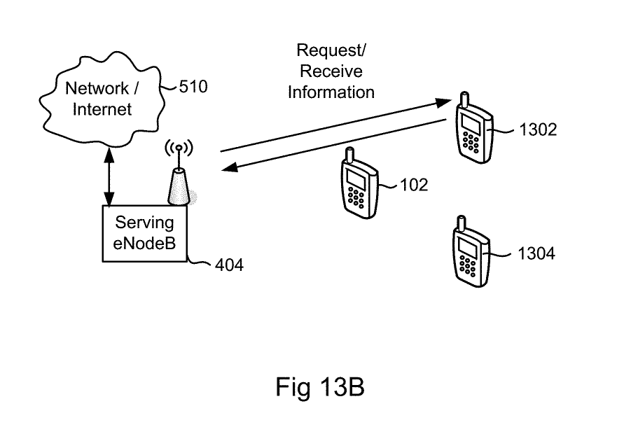

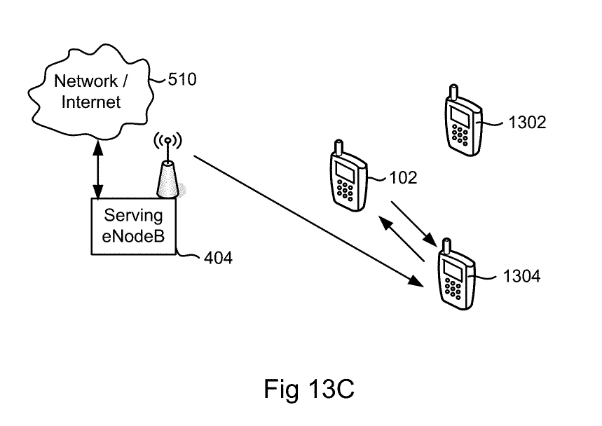

FIG. 13A illustrates that the mobile device 102 may be identified by the network as being in distress via network monitoring of the mobile device 102 or via the mobile device transmitting a distress signal. The distressed mobile device 102 may determine that it has lost communication with the network, and may instruct the wearer/user to either disable or initiate a distress signal. The mobile device 102, upon initiation of a distress signal, may begin a grouping process previously defined.

FIG. 13B illustrates that the network 510 to which the serving eNodeB 404 is connected to may instruct a mobile device 1302 in the same group as the distressed mobile device 102 to report the last known location of the mobile device 102 and time stamp.

FIG. 13C illustrates that the network 510 may instruct additional mobiles devices 1304 to attempt to group with the distressed mobile device 102.

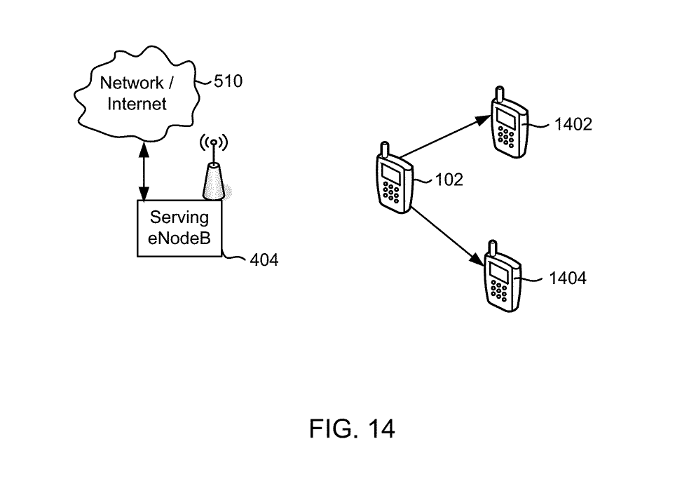

FIG. 14 illustrates that when the mobile device 102 is unable to communicate with the network 510, it may begin operating under a dead reckoning process and continue to attempt to locate other mobile devices 1402, 1404 and group with them under an ad-hoc scheme.

Once the mobile device has been grouped, or is still connected to the network, the relative location of the mobile device will be sent to all the mobile devices that are in active search for that mobile device. The selection of which mobile devices will be searched may be determined by operator intervention and selection.

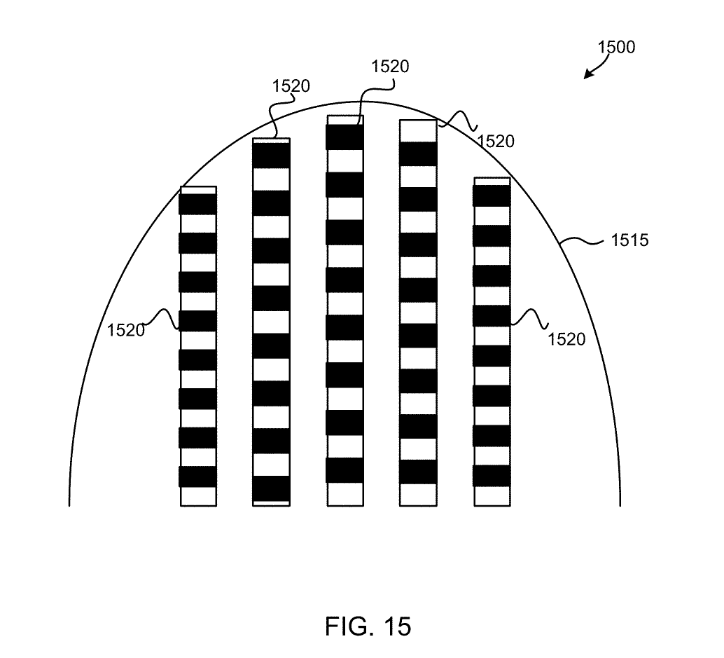

FIG. 15 illustrates an embodiment enhanced antenna scheme 1500 that may be used by wireless network operators or first responders to improve the positional accuracy for the mobile device. The enhanced antenna scheme 1500 may include a radome 1515 that is curved over a series of patch antennas 1520. Several antennas 1520 may be used achieve better angle of arrival measurement. In an embodiment, the enhanced antenna scheme 1500 may include an array of antennas 1520 on flexible circuit boards so they can conform to the radome 1515.

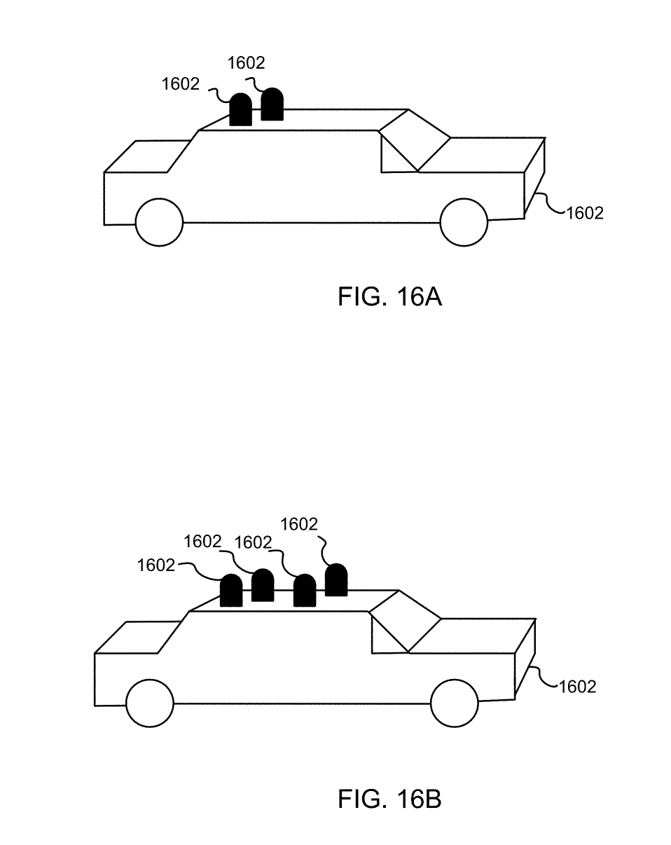

FIG. 16A-B illustrate that the above mentioned enhanced antenna scheme 1500 may be implemented on a vehicle 1602. Specifically, FIG. 16A illustrates an enhanced antenna scheme 1500 that includes two antennas 1602 for this purpose. FIG. 16B illustrates an enhanced antenna scheme 1500 that includes four antennas 1602 for this purpose. Each antenna 1602 may include an array of antennas 1520 on flexible circuit boards so they can conform to the radome 1515.

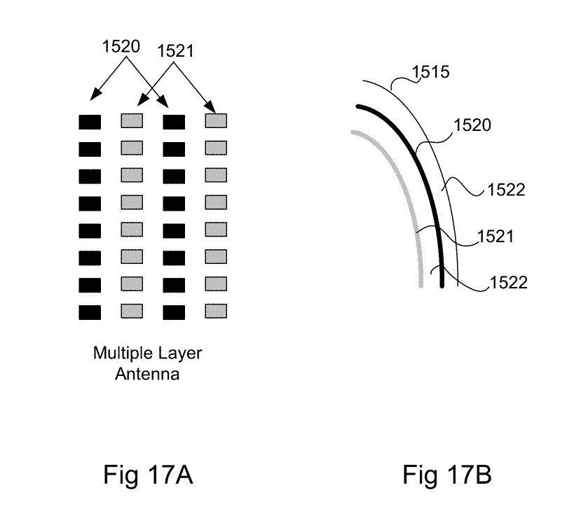

FIG. 17A-B illustrate strips of antenna patches that may be used in various embodiments. FIG. 17A illustrates two strips of antenna patches 1520 and 1521 next to each other in an antenna array (which may be on a flexible circuit board so they conform to a radome). FIG. 17B is an illustration of a cross sectional view of the radome 1515 in which the antenna patches 1520 and 1521 of the antenna array are shown layered. The antenna patch 1520 is closer to the outer radome cover 1515 than is antenna array 1521. A fiber glass or a transparent RF medium 1522 may provide rigidity and enable the antennas to be closely spaced. The antenna array may be cone shared using a flexible circuit design (for receive only configurations). Envelope detectors may be used to determine which of the antenna patches are receiving the highest quality signal from the mobile device using an amplitude method for detection.

In an embodiment, the detection and tracking of a mobile device may be controlled so that the measurements are in-synch with an eNodeB pulse request to the mobile device for positional information.

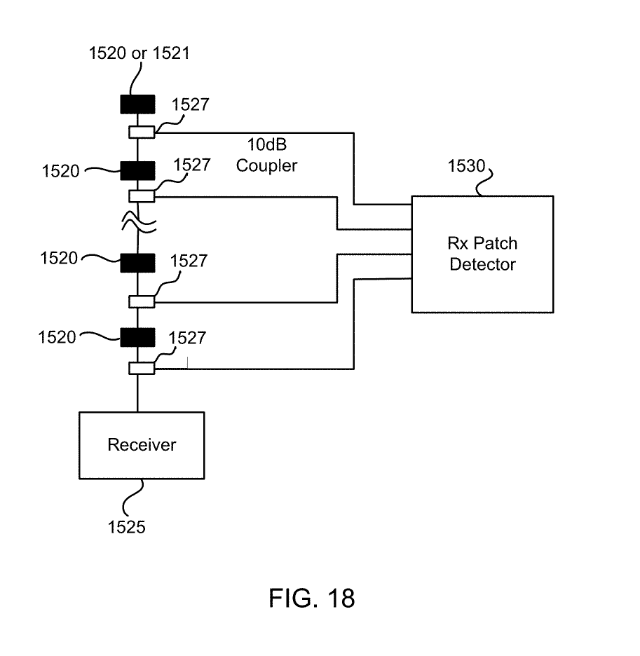

FIG. 18 illustrates an antenna array (1520 or 1521) in which the antenna system is connected to the normal antenna port on a receiver (e.g., eNodeB) 1525. Each of the patch antennas may be matched to a 10 db coupler 1527 and configured to provide a port coupling to a receive patch detector 1530. The receive patch detector 1530 may be configured to determine which patch antenna has the strongest signal, and based on the number of patch antennas and the distance calculation, another altitude measurement may be made by the mobile device.

In an embodiment, the antenna array system may not be connected to the eNodeB receiver 1525 and control coordination may be provided by the E-SMLC for synchronization of the received signal from the mobile device.

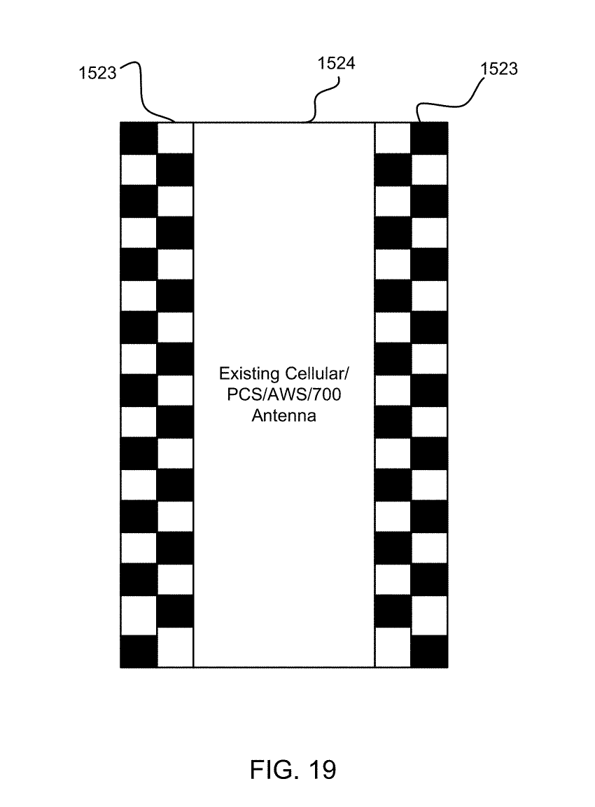

FIG. 19 illustrates an embodiment antenna array 1523 retrofitted into an existing cellular wireless network. The array 1523 may be installed in parallel to an existing antenna 1524. A control mechanism that is the same as or similar to the control mechanism illustrated in FIG. 18 may used for the commercial applications.

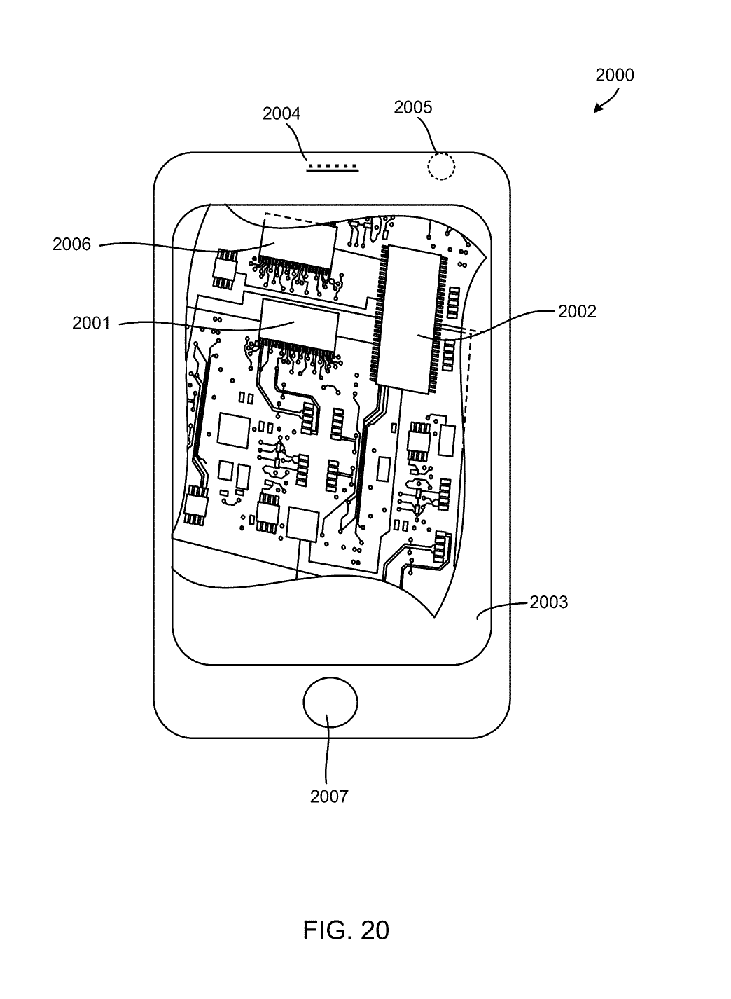

The various embodiments may be implemented on a variety of mobile computing devices, an example of which is illustrated in FIG. 20. Specifically, FIG. 20 is a system block diagram of a mobile transceiver device in the form of a smartphone/cell phone 2000 suitable for use with any of the embodiments. The cell phone 2000 may include a processor 2001 coupled to internal memory 2002, a display 2003, and to a speaker 2054. Additionally, the cell phone 2000 may include an antenna 2004 for sending and receiving electromagnetic radiation that may be connected to a wireless data link and/or cellular telephone transceiver 2005 coupled to the processor 2001. Cell phones 2000 typically also include menu selection buttons or rocker switches 2008 for receiving user inputs.

A typical cell phone 2000 also includes a sound encoding/decoding (CODEC) circuit 2024 which digitizes sound received from a microphone into data packets suitable for wireless transmission and decodes received sound data packets to generate analog signals that are provided to the speaker 2054 to generate sound. Also, one or more of the processor 2001, wireless transceiver 2005 and CODEC 2024 may include a digital signal processor (DSP) circuit (not shown separately). The cell phone 2000 may further include a peanut or a ZigBee transceiver (i.e., an IEEE 802.15.4 transceiver) 2013 for low-power short-range communications between wireless devices, or other similar communication circuitry (e.g., circuitry implementing the Bluetooth® or WiFi protocols, etc.).

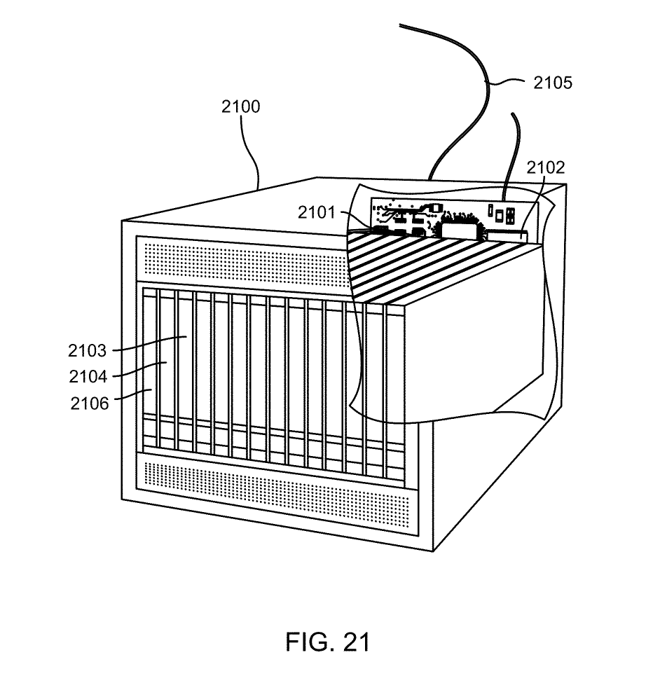

Various embodiments may be implemented on any of a variety of commercially available server devices, such as the server 2100 illustrated in FIG. 21. Such a server 2100 typically includes one or more processors 2101, 2102 coupled to volatile memory 2103 and a large capacity nonvolatile memory, such as a disk drive 2104. The server 2100 may also include a floppy disc drive, compact disc (CD) or DVD disc drive 2106 coupled to the processor 2101. The server 2100 may also include network access ports 2106 coupled to the processor 2101 for establishing data connections with a network 2105, such as a local area network coupled to other communication system computers and servers.

The processors 2001, 2101, and 2102 may be any programmable microprocessor, microcomputer or multiple processor chip or chips that can be configured by software instructions (applications) to perform a variety of functions, including the functions of the various embodiments described below. In some mobile devices, multicore processors 2102 may be provided, such as one processor core dedicated to wireless communication functions and one processor core dedicated to running other applications. Typically, software applications may be stored in the internal memory 2002, 2103, and 2104 before they are accessed and loaded into the processor 2001, 2101, and 2102. The processor 2001, 2101, and 2102 may include internal memory sufficient to store the application software instructions.

The wireless device location determination techniques described herein may be implemented in conjunction with various wireless communication networks such as a wireless wide area network (WWAN), a wireless local area network (WLAN), a wireless personal area network (WPAN), and so on. The term “network” and “system” are often used interchangeably. A WWAN may be a Code Division Multiple Access (CDMA) network, a Frequency Division Multiple Access (FDMA) network, a Time Division Multiple Access (TDMA) network, an OFDMA network, a 3GPP LTE network, a WiMAX (IEEE 802.16) network, and so on. A CDMA network may implement one or more radio access technologies (RATs) such as CDMA2000, Wideband-CDMA (W-CDMA), and so on. CDMA2000 includes IS-95, IS-2000, and IS-856 standards. W-CDMA is described in documents from a consortium named “3rd Generation Partnership Project” (3GPP). CDMA2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth network, an IEEE 802.15x, or some other type of network. The techniques may also be implemented in conjunction with any combination of WWAN, WLAN, and/or WPAN.

Further embodiments may include methods of determining a location of a wireless device, which may include determining, via a processor of the wireless device, an approximate location of the wireless device, forming a communication group with other devices in proximity to the wireless device, the other devices an internet of things (iOT) device, receiving on the wireless device location information from the devices in the communication group, and determining a more precise location of the wireless device based on the location information received from the devices in the communication group.

In some embodiments, the iOT device may be coupled to an iOT hub, and receiving on the wireless device location information from the devices in the communication group may include receiving information identifying a location of the iOT device relative to a location of the iOT hub. In some embodiments, the iOT device may be a location aware iOT device. In some embodiments, the iOT device may be a location unaware iOT device. In some embodiments, receiving the location information may include receiving a latitude coordinate, a longitude coordinate, and an altitude coordinate from the iOT device. In some embodiments, the method may include sending sensor information collected from at least one of an accelerometer, a gyroscope, a magnetometer, and a pressure sensor to a server (e.g., a network server, a sever deployed in an iOT cloud network, etc.).

In some embodiments, receiving on the wireless device location information from the devices in the communication group may include receiving location information from a first iOT device via an iOT hub, receiving location information from a second iOT device via an eNodeB deployed within a telecommunication network, and/or receiving location information from a third iOT device via a wireless access point. In some embodiments, the method may include detecting movement of the wireless device, and re-computing the approximate location of the wireless device in response to detecting the movement. In some embodiments, the method may include receiving on the wireless device updated location information in response to the iOT device detecting a movement of the iOT device.

Some embodiments may include methods, and devices (e.g., mobile device, iOT device, fixed wireless device, etc.) configured to implement the methods, of determining a location of a wired or wireless device (e.g., mobile device, iOT device, fixed wireless device, etc.), which may include determining an approximate location of the wireless device, grouping the device with another device (or wireless transceiver) in proximity to the device to form a communication group, sending the determined approximate location of the device to the wireless transceiver, receiving on the device location information from the wireless transceiver, and determining a more precise location of the device based on the location information received from the wireless transceiver.

Some embodiments may include methods, and devices (e.g., mobile device, iOT device, fixed wireless device, etc.) configured to implement the methods, of providing an enhanced location based service in a device, which may include collecting in processor of a device location information from a plurality of devices in a communication group, computing more precise location information for the device based on the location information collected from the plurality of devices, and using the generated location and position information to provide the location based service. Computing the more precise location information may include using horizontal data to determine a position relative to the Earth's surface, using vertical data to determine a height of the position relative to sea level, and generating three-dimensional location and position information based on the determined position and height.

Some embodiments may include methods, and devices configured to implement the methods, of providing an enhanced location based service in a device, which may include determining via processor of a device whether the device is able to acquire satellite signals and navigation data from a geospatial system, collecting location information from a plurality of devices in a communication group in response to determining that the device is not able to acquire satellite signals and navigation data from the geospatial system, computing more precise location information (e.g., three-dimensional location and position information) for the device based on the location information collected from the plurality of devices, and using the generated location and position information to provide the location based service. Collecting the location information may include receiving a latitude coordinate, a longitude coordinate, and an altitude coordinate.

Some embodiments may include methods, and devices configured to implement the methods, of providing an enhanced location based service in a device, which may include determining via a processor of a device whether information obtained via a geospatial system of the device is accurate, collecting location information from a plurality of devices in a communication group in response to determining that the information obtained via the geospatial system of the device is not accurate, computing more precise location information for the device based on the location information collected from the plurality of devices (the more precise location information including three-dimensional location and position information), and using the computed more precise location information generated to provide the location based service.

Some embodiments may include methods, and devices configured to implement the methods, of providing an enhanced location based service in a device, which may include establishing a first connection (e.g., a connection that is not a cellular data uplink transmission path) to a data network, obtaining location information for a current location of the device via the first connection, determining via a processor of the device a variance between the received location information and a device determined location, determining whether the variance exceeds a threshold value, collecting location information from a plurality of transceivers in a communication group in response to determining that the variance exceeds the threshold value, computing more precise location information for the device based on the location information collected from the plurality of transceivers, and using the more precise location information to provide the location based service.

Some embodiments may include methods, and devices configured to implement the methods, providing an enhanced location based service in a device, which may include determining via a processor of a device whether information obtained via a geospatial system of the device is accurate, collecting location information from a plurality of devices in response to determining that the information obtained via the geospatial system of the device is not accurate, computing more precise location information for the device based on the collected location information, and using the computed more precise location information to provide the location based service.

Some embodiments may include methods, and devices configured to implement the methods, of providing an enhanced location based service via a device, which may include determining via a processor of the device an initial position, generating, by the processor, at least one set of local position information based on locally determined location information, receiving by an antenna of the device location information from one or more external location tracking systems, generating by the processor at least one set of external position information based on the location information received from the one or more external location tracking systems, receiving by the antenna distance information from multiple devices in a communication group, generating by the processor at least one set of proximity position information based on the distance information received from the multiple devices in the communication group, generating by the processor a final location estimation set (which may include a position, a velocity, and an acceleration value) based on the local position information, external position information, proximity position information and the initial position information, and using by the processor the final location estimation set to provide an enhanced location based service.

Some embodiments may include methods, and devices configured to implement the methods, providing an enhanced location based service via a device, which may include determining by a processor of the device whether the device is currently connected to a communications network, establishing connections via an antenna of the device to a plurality of devices to form a communication group in response to determining that the device is not currently connected to the communications network, receiving distance information from the plurality of devices in the communication group, generating a location estimation set based on the received distance information, and transmitting the generated location estimate set to one or more of the plurality of devices in the communication group for relay to a network resource. In some embodiments, generating the location estimation set may include calculating a current coordinate position of the device based on a distance of the device from each of the plurality of devices in the communication group.

Some embodiments may include methods, and devices configured to implement the methods, providing an enhanced location based service via a device, which may include determining by a processor of the device an initial position of the device, generating local position information, generating external position information based on location information received from an external location tracking system, generating proximity position information based on distance information received from a second device, generating final location information based on the determined initial position, the generated local position information, the generated external position information and the generated proximity position information, and using the generated final location information to provide an enhanced location based service.

Some embodiments may include methods, and devices configured to implement the methods, of providing an enhanced location based service via a device, which may include determining via a processor of the device an initial location value that identifies the current location of the device, computing an initial location accuracy value for the determined initial location value, and establishing a communications group with a plurality of transceivers in response to determining that the computed initial location accuracy value exceeds a threshold value. The methods may further include, receiving location information from each of the plurality of transceivers in the communications group, determining a trilateration position value based on the location information received from each of the plurality of transceivers in the communications group, computing a trilateration variance value based on the determined trilateration position value, determining a final location value based on the determined initial location value, the computed initial location accuracy value, the determined trilateration position value, and the computed trilateration variance value, and using the final location value to provide the enhanced location based service.

Some embodiments may include methods, and devices configured to implement the methods, of providing an enhanced location based service via a device, which may include receiving in a processor of the device coupled an antenna of the device a first and second set of externally determined location information from one or more external location tracking systems. The methods may further include generating by the processor a best stride length estimate based on the first set of externally determined location information, the second set of externally determined location information and output of an accelerometer of the device. The methods may further include generating by the processor a best altitude estimate based on output of a barometer of the device and at least one of the first and second sets of externally determined location information. The methods may further include generating by the processor a best compass heading estimate based on output of a magnetometer of the device, output of the accelerometer of the device, and at least one of the first set of externally determined location information and the second set of externally determined location information. The methods may further include generating by the processor dead reckoning location information based on the best stride length estimate, the best altitude estimate, and the best compass heading estimate. The methods may further include calculating by the processor a best location estimate based on the dead reckoning location information and a set of externally determined location information, and using the best location estimate to provide an enhanced location based service in the device.

Some embodiments may include methods, and devices configured to implement the methods, of providing an enhanced location based service via a device, which may include receiving in a processor of a device externally determined location information, generating by the processor a best stride length estimate based on the externally determined location information and accelerometer information, generating by the processor a best altitude estimate based on the externally determined location information and barometer information, generating by the processor a best compass heading estimate based on the externally determined location information and magnetometer information, and generating by the processor dead reckoning location information based on the best stride length estimate, the best altitude estimate, and the best compass heading estimate.

Some embodiments may include methods, and devices configured to implement the methods, of providing an enhanced location based service via a device, which may include receiving, via a processor of the device, location information from one or more of a sensor of the device and an external system, generating via the processor a first waypoint based on the received location information, receiving via the processor network provided location information, generating via the processor a second waypoint based on the received network provided location information, retrieving via the processor dead reckoning location information, generating via the processor a third waypoint based on the received network provided location information, applying via the processor the first, second and third waypoints to a kalman filter to generate precise location information, and using the precise location information to provide the enhanced location based service.

Some embodiments may include methods, and devices configured to implement the methods, of determining a location of a device, which may include receiving by a processor of the device, first location information from a plurality of other devices, using the received first location information to determine an approximate location of the device to a first level of accuracy, grouping the device with one or more wireless transceivers in proximity to the device to form a communication group, sending the determined approximate location to the one or more wireless transceivers in the communication group, receiving second location information from the one or more wireless transceivers in the communication group in response to sending the determined approximate location, and using the received second location information to determine a more precise location of the device to a second level of accuracy (in which the second level of accuracy is greater than the first level of accuracy).

Some embodiments may include methods, and devices configured to implement the methods, of determining a location of a device via enhanced location based trilateration, which may include receiving location information from one or more external devices (the received location information including a waypoint from each of the one or more external devices, each waypoint including a coordinate value, an altitude value and a range value, the range value identifying a distance from an external device to the device), determining the validity of each of the received waypoints, performing normalization operations to normalize the received valid waypoints, assigning an overall ranking to each of the normalized waypoints, assigning an device-specific ranking to each of the normalized waypoints, storing the normalized waypoints in memory, selecting four waypoints from memory based on a combination of the overall ranking and the device-specific ranking associated with each waypoint, applying the four selected waypoints to a kalman filter to generate a final location waypoint, and using the generated final location waypoint to provide an enhanced location based service.

Some embodiments may include methods, and devices configured to implement the methods, of providing an enhanced location based service on a device, which may include determining whether a first fixed device is able to establish a location fix based on information obtained via a geospatial system, collecting location information from a communication group in response to determining the first fixed device is unable to establish a location fix, computing a new three-dimensional location fix for the first fixed device based on the location information collected from the communication group, and providing location based service based on the new three-dimensional location fix.

Some embodiments may include methods, and devices configured to implement the methods, of providing an enhanced location based service on a device, which may include determining whether a first fixed device is able to establish a location fix based on information obtained via a geospatial system, collecting location information from a plurality of mobile devices in a communication group in response to determining the first fixed device is unable to establish a location fix, computing more precise location information including a new three-dimensional location fix for the first fixed device based on the location information collected from the plurality of mobile devices in the communication group, generating three-dimensional information based on the determined position and the determined height, and using the generated three-dimensional information to provide the enhanced location based service.

Some embodiments may include methods, and devices configured to implement the methods, of providing an enhanced location based service on a device, which may include performing trilateration for a fixed infrastructure node (FIN) by receiving via a processor of a FIN device a plurality of inputs from a plurality of devices (the received plurality of inputs including GPS data input, a network provided LBS data input, a mobile device LBS data input, a dead reckoning data input collected during an initial positioning of the FIN, and/or an external device data input), using the received plurality of inputs to generate an initial positional fix, setting a current waypoint of the FIN based the initial positional fix, using the received plurality of inputs to generate updated location information for the FIN, and updating the current waypoint based on the generated updated location information. In some embodiments, the method may include using the received plurality of inputs to generate an initial positional fix, setting a current waypoint of the FIN based the initial positional fix, using the received plurality of inputs to generate updated location information for the FIN, and updating the current waypoint based on the generated updated location information. In some embodiments, the method may include sending GPS timing information to another fixed device, receiving three-dimensional location information from a mobile device, relaying three-dimensional location information to another fixed device, receiving three-dimensional location information from fixed and/or mobile devices, receiving location information from a network based location server, and/or receiving location information from other fixed and mobile devices fixed infrastructure devices (e.gs a small cell device, a femto cell device, a beacon device that has GPS capabilities, eNodeB, micro cell, pico cell, small cell, beacon, access point, etc.).

In various embodiments, the methods may include determining the approximate location of the wireless based on information received from a sensor hub (the sensor hub including information collected from an accelerometer, a two-axis gyroscope, a three-axis compasses, altimeters, barometers, etc.). In some embodiments, device may include a distributed antenna, which may include one or more sensor hubs.

In some embodiments, the methods may include determining whether new location information is available, such as whether new dead reckoning location information is available, whether new GPS location information is available, whether new network-provided location information is available, whether new trilateration location information is available, etc. The method may further include computing a variance estimate value that considers an accuracy of the more precise location in response to determining that new location information is available, and extrapolating the more precise location and increasing a variance value that considers the age of the location in response to determining new location information is not available.

In various embodiments, the methods may include determining the validity of each of received waypoints, performing normalization operations to normalize the received valid waypoints, assigning an overall ranking to each of the normalized waypoints, assigning a device-specific ranking to each of the normalized waypoints, storing the normalized waypoints in memory, and selecting between two and four waypoints from memory based on a combination of the overall ranking and the device-specific ranking associated with each waypoint, applying the four selected waypoints to a kalman filter to generate a final location waypoint, and determining the more precise location of the device based on the final location waypoint.

Some embodiments may include or use a fixed device, which may include a geospatial system, a memory, and a processor coupled to the memory. The processor may be configured with processor-executable instructions to perform operations that include determining whether information obtained via the geospatial system is accurate, collecting location information from a plurality of devices in a communication, computing more precise location information (e.g., three-dimensional location information) for the fixed device based on the collected location information, and using the generated location information to provide an enhanced location based service or to participate in the iOT ecosystem. The processor may also determine the more precise location of the fixed device based on the approximate location and the location information received from another device.

Further embodiments may include methods of providing an enhanced location based service on a first fixed device. A processor of a first fixed device may be configured to determine whether information that was obtained from (an internal or external) geospatial system is available in the first fixed device. The processor may also determine whether the first fixed device is able to establish a location fix (e.g., calculate its geospatial location) based on information obtained via a geospatial system. The processor may collect location information from a communication group in response to determining that the first fixed device is not able to establish a location fix (e.g., due to its inability to acquire satellite signals or navigation data, the unavailability of information that was obtained via a geospatial system, inaccuracy of the available information, etc.). The processor may use the collected information (e.g., the information collected from devices in the communication group) to compute a new location fix when it is unable to establish an adequate location fix based on information that is obtained via a geospatial system. The new location fix may be a three-dimensional location fix that includes three-dimensional location and position information, and the first fixed device may provide all or portions of an enhanced location based service based on the new three-dimensional location fix.

In some embodiments, the mobile or device may be configured to generate or receive the location information in the form of one or more waypoints.

A waypoint may be an information structure that includes one or more information fields, component vectors, location information, position information, coordinate information, etc. Each waypoint may include coordinate values (e.g., x and y coordinates, latitude and longitude values, etc.), an altitude value, a time value, a timestamp, ranking values, confidence values, precision values, a range value, and an information type identifier (e.g., GPS, Loran C, sensor, combined, etc.). The coordinate and altitude value may identify the three-dimensional location of the corresponding external device. The timestamp may identify the time that the location was determined/captured. The range value may identify a distance between the external device and the mobile/device. In various embodiments, a waypoint may be, or may include, a location estimate value, a position estimate, a location set, or any other similar value or location information that suitable for adequately conveying or communicating location information.

Some of the embodiments discussed above may allow a processor in a computing device (e.g., mobile wireless device, etc.) to generate a position estimate (a value or information structure that includes one or more information fields). Wireless fixed infrastructure devices (FIDs) such as small cells, femto cells, WiFi access nodes, Bluetooth™ beacons, fixed appliances, etc. could also benefit from such position estimates, particularly if they include longitude, latitude, and elevation information that is within a specific or high degree of accuracy (e.g., within one (1) meter or better). Generating and using such accurate geodetic coordinate values is also of growing importance for various entities (e.g., wireless service providers, mobile advertisers, public safety operators, etc.) that could also benefit from the position estimate generated via the various embodiments discussed in this application.

Further embodiments may include methods, and devices configured to implement the methods, of determining a location of a device. The methods may include determining an approximate location of the device, grouping the device with a wireless transceiver in proximity to the device to form a communication group, sending the determined approximate location of the device to the wireless transceiver, receiving on the device location information from the wireless transceiver, and determining a more precise location of the device based on the location information received from the wireless transceiver. As part of the operation for determining the approximate location, the device may estimate its position and/or generate a position estimate. The position estimates may include latitude, longitude and elevation information that are accurate to within one (1) meter.

Further embodiments may include methods, and devices and systems configured to implement the methods, for accomplishing Internet of Things (iOT) eLBS Trilateration. For example, a device may include a processor that is configured with processor executable instructions to perform iOT eLBS Trilateration operations to ascertain location information and/or provide an enhanced location based service. In the various embodiments, the iOT eLBS Trilateration operations may include any or all of the method operations discussed above.

Trilaterion for the iOT using eLBS positions with devices may include receiving and using multiple inputs from various other devices to assist in initial fix and subsequent improvements for both mobile and fixed devices, with the location determination involving latitude, longitude and altitude. The iOT eLBS Trilateration operations may allow the devices to utilize information from a multitude of other devices and/or an iOT ecosystem to determine their locations (e.g., generate the more precise location information) with a high degree of accuracy. The various embodiments allow for automatic provisioning of the iOT devices so that they readily and automatically determine their locations within the system with a high degree of accuracy. Various embodiments may use the automatic provisioning capabilities to tightly couple the devices to each other so to create a coordinated ecosystem of sensors and services, which may be used to improve the location information generated by other devices, including mobile devices. The various embodiments also allow for enhanced infrastructure monitoring. The various embodiments provide or make available new and enhanced services by allowing tight coupling and connectivity to a iOT cloud service network.

The various embodiments may improve the accuracy, precision and confidence of the actual three-dimensional coordinates of the various wireless devices (including fixed devices, moving devices, and movable devices) that implement or use eLBS technologies or for which determining precise locations are important. For example, the performance of the iOT eLBS Trilateration operations may improve the performance and functioning of other devices that implement or use eLBS technologies in accordance with the various embodiments.

Devices that are designed for (or used in) an iOT environment or ecosystem are often lacking a full complement of location awareness sensors and/or receivers. As a result, it may be difficult to ascertain their precise locations in all three dimensions using conventional techniques. The various embodiments allow such devices to ascertain their precise locations in all three dimensions. The devices may determine confidence and precision values for three-dimensional coordinates (latitude, longitude and altitude). These values may be used to refine location or position estimates, generate a precise two or three-dimensional location fixes, or to generate more precise location information that identifies the precise location of the device (e.g., to within one meter, etc.) with a high degree of confidence. The wireless device may determine whether a computed location value has a “high degree of confidence” based on whether an associated confidence value exceeds or is greater than a threshold value.

Some embodiments may include or use the existing mobile device ecosystem in conjunction with the iOT devices, systems or solutions to improve the position location (location values) of the wireless devices (both mobile and fixed). The existing mobile device ecosystem may also be used in conjunction with the iOT devices, systems or solutions to improve the location awareness, position awareness, or positional awareness of the iOT devices. Location awareness may refer to the functionality, ability, or capability of a device to passively or actively determine its location.

Various embodiments may allow a wired or wireless device (e.g., mobile device, iOT device, etc.) to work in conjunction a variety of different devices to achieve a three-dimensional positional fix (e.g., by generating latitude, longitude and altitude values) with a high confidence of its correctness and/or a high degree of confidence that a iOT device (which may be moveable or fixed infrastructure node using eLBS Trilateration) is within a determined location.

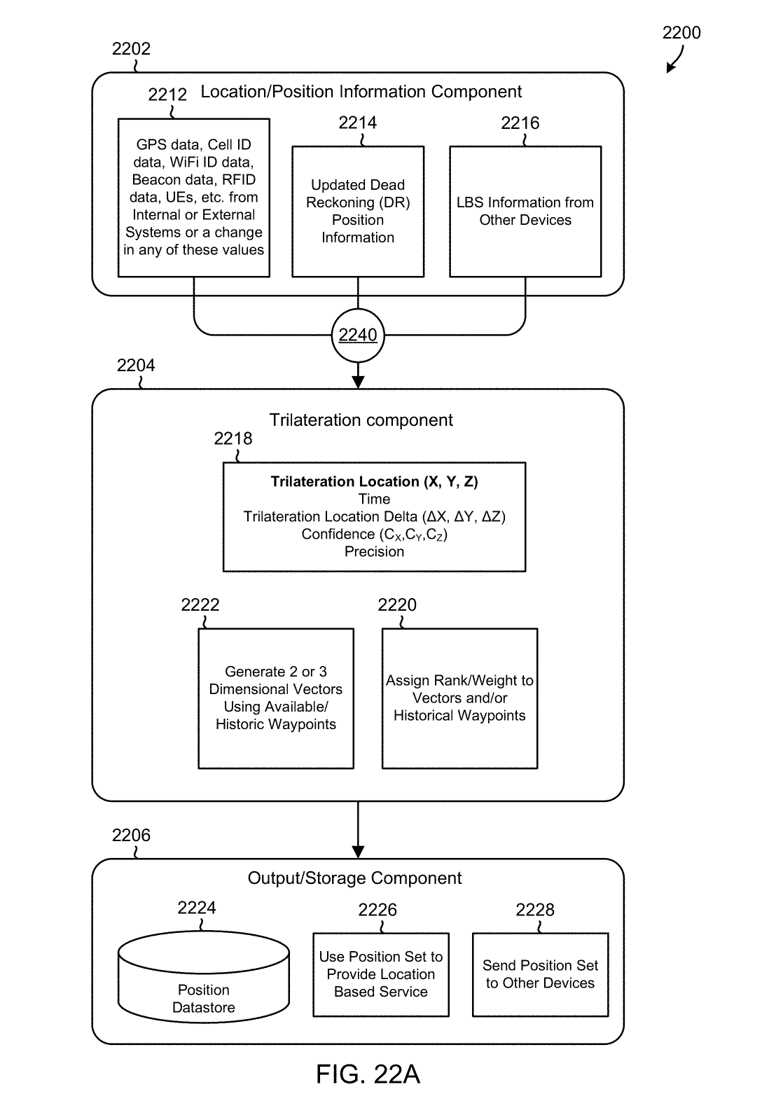

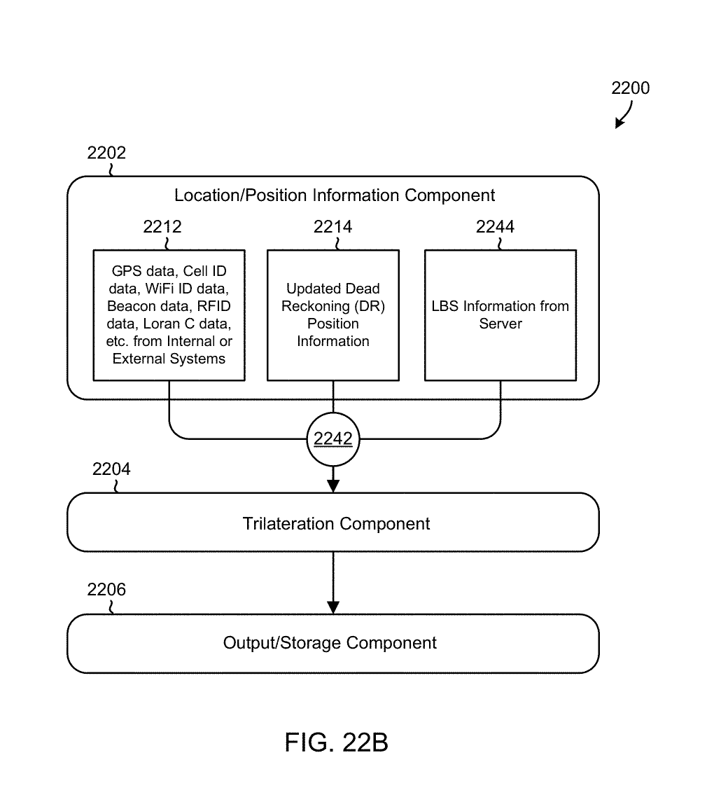

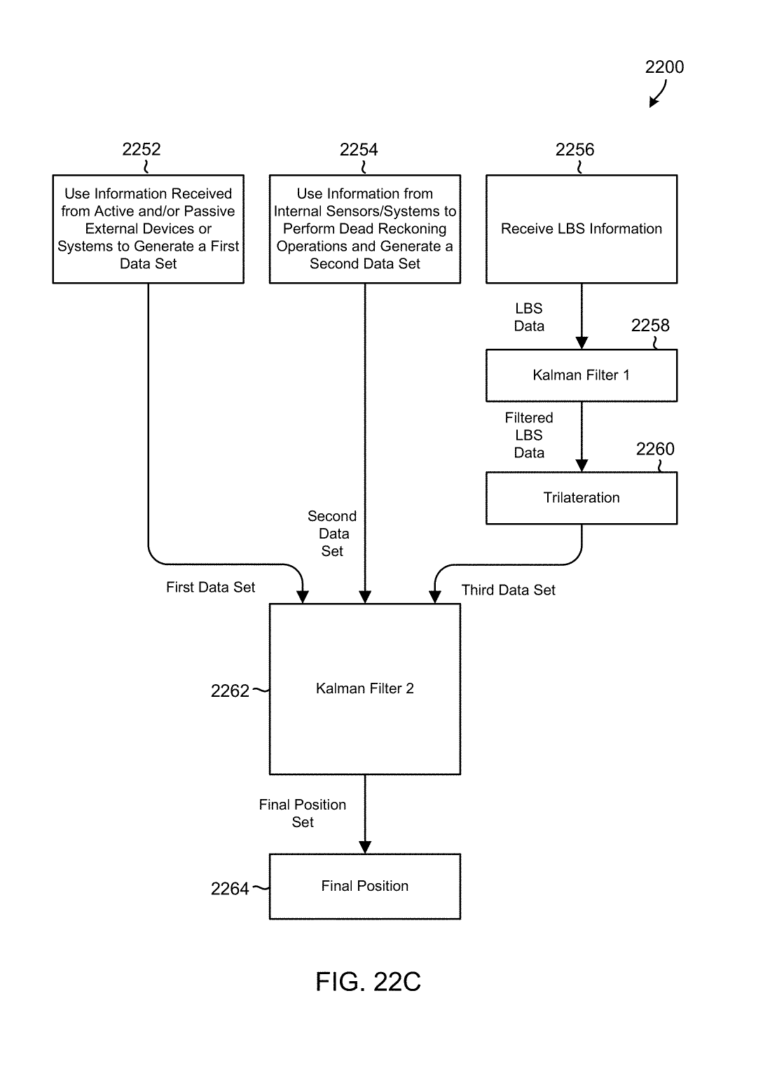

FIG. 22A illustrates various components, information flows, and operations in an example system 2200 that is configured to perform trilateration operations in accordance with an embodiment. FIG. 22B illustrates that, in another embodiment, the iOT device 2200 may be configured to perform single device eLBS trilateration operations that do not require receiving information from other devices in the communication group. In the examples illustrated in FIGS. 22A and 22B, the system 2200 includes a location information component 2202, a trilateration component 2204, and an output/storage component 2206.

In block 2212, a processor of the iOT device may receive information that is suitable for use as, may be used to generate, or which includes, location information, such as GPS data, a Cell ID, a WiFi ID, Beacon data, a RFID, Loran C data, OS Library Function, etc. or changes in any of these values. In some embodiments, the iOT device may receive location information from active or passive external devices/systems. For example, the iOT device may communicate with an active external device, such as location based server from a fleet management company, to receive location information. As part of these operations, the iOT device may perform various operations (e.g., interrogation, etc.) to establish communication links and receive information from the active external devices. Alternatively or in addition, the iOT device may receive location information from a passive external device, such an RFID chip that scans for the presence of device and/or which broadcasts location information periodically. In addition, the iOT device may generate location information locally (in the device) based on information received from an external system in block 2212. For example, the iOT device may generate GPS data (e.g., GPS coordinates or GPS determined position information) in a local GPS receiver based on GPS information received from an external GPS system. As another example, the iOT device may use received WiFi ID information to determine or compute its proximity to known networks, and generate location information based on the determined proximity to these known networks.

In block 2214, the iOT device may generate and/or receive updated dead reckoning (DR) position information (or dead reckoning position estimate value). As mentioned above, the iOT device may be equipped with sensors (e.g., accelerometer, gyros, magnetic compass, altimeters, odometers, etc.) that allow it to estimate the distance it has traveled or moved over a period of time in any dimension (e.g., x, y or z; latitude, longitude or altitude; etc.). The iOT device may use information collected from these sensors in block 2214 to perform any or all of the dead reckoning operations discussed in this application and generate dead reckoning (DR) position information. For example, the iOT device may use information from the sensors (e.g., accelerometer, gyros, magnetic compass, altimeters, odometers, etc.) to determine the distance it has traveled (or been moved) since the last time it was able to ascertain its location with a sufficiently high degree of confidence (e.g., Cx, Cy and Cz are all greater than 0.95, etc.), determine its current location based on the determined distance (e.g., distance it has traveled, etc.), and generate updated DR position information that identifies its current location. In some embodiments, the iOT device may also compute confidence values and/or a precision value for the generated DR position information in block 2214.

In block 2216, the iOT device may receive and process location based service information (LBS information) from other devices, such as from transceiver or other iOT devices in the communication group. Since the LBS information may be received from devices that are being moved and/or which are not stationary, the LBS information may include, or may be used to generate or establish, multiple waypoints at discrete times and/or for discrete durations or periods of time. In some embodiments, the LBS information may include estimated distances between multiple (e.g., three or more) devices/transceivers and the iOT device. Each waypoint may be an information structure that includes one or more information fields, component vectors, location information, position information, coordinate information, etc.

Thus, the location information component 2202 of the iOT device may be configured to receive, process and/or generate standard location information (or a first data set, estimate value, etc.) in block 2212, updated DR position information (or a second data set, estimate value, etc.) in block 2214, and LBS information (a third data set, estimate value, etc.) in block 2216. In operation 2240, the location information component 2202 may send any or all such information (e.g., first, second, and third values/sets) to the trilateration component 2204 as input data.

In blocks 2218-2222, the iOT device/trilateration component 2204 may use the received input data to perform trilateration operations (e.g., trilateration API location operations, etc.), determine the geographical coordinates (e.g., latitude, longitude, and altitude coordinates) of the iOT device, generate a trilateration position estimate value, generate a final position set (e.g., a final location estimate value), generate an updated final position set (e.g., x, y and z coordinates, an updated position estimate value, more precise information, etc.), and send the updated final position set to the output/storage component 2206. The trilateration operations may include operations for implementing any or all of the techniques discussed in this application, including time of arrival, angle of arrival, mobile-to-mobile trilateration, lateration, multilateration, triangulation, etc.

In the example illustrated in FIG. 22A, in block 2218, the iOT device generates/computes/receives trilateration location values (X, Y, Z), a time value, trilateration location delta values (ΔX, ΔY, ΔZ), confidence values (C_{X},C_{Y},C_{Z}), and one or more precision values, the combination of which may be stored or used as a waypoint (or a data set or estimate value). In block 2220, the iOT device may rank or assign weights to the current or historical waypoints (i.e., previously computed waypoints). In block 2222, the iOT device may generate two or three-dimensional vectors using the waypoints (current and/or historic). In an embodiment, the iOT device may generate the vectors based on their rank/weights (e.g., by including/using only waypoints having a rank that exceeds a threshold value).

As mentioned above, the trilateration component 2204 may send the computed updated final position set to the output/storage component 2206. The output/storage component 2206 may store the updated final position set in a location buffer or the illustrated updated final position datastore 2224. In block 2226, the output/storage component 2206 may use the updated final position set (more precise location information) to provide an enhanced location based service. In block 2228, the output/storage component 2206 may send the updated final position set to other devices, such as to a network server or the other iOT devices in the communication group.

In order to accurately compute/determine the updated final position set (more precise location information), the iOT device 2200 may be required to communicate with other devices in a communication group (e.g., in block 2216). However, iOT devices may not always have access to a communication group (yet alone a sufficiently large communication group) and/or to the robust data that could be required to accurately determine the location of the device. As such, in the example illustrated in FIG. 22B, in block 2244, the iOT device may receive LBS information from a server computing device (e.g., a network provided location service). In operation 2242, the iOT device may send the standard location information (or first data set, estimate value, etc.), updated DR position information (or second data set, estimate value, etc.), and the LBS information received from the server (or third data set, estimate value, etc.) to the trilateration component 2204 as input data. The trilateration component 2204 may receive and use the input data to compute/generate a final position set and/or an updated final position set, and send the generated position set to the output/storage component 2206 for storage and/or use.

FIG. 22C illustrates various additional components, information flows, and operations in an example iOT device 2200 configured to perform enhanced location based service (eLBS) trilateration operations in accordance with the various embodiments. In block 2252, the iOT device may use information received from active and/or passive external devices or systems to generate a first data set (e.g., x, y and z coordinates, first estimate value, etc.). In block 2254, the iOT device may use information collected from internal sensors and systems to perform dead reckoning operations and generate a second data set (e.g., x, y and z coordinates, second estimate value, etc.). In block 2256, the iOT device may receive location based service (LBS) information from a server (e.g., x, y and z coordinates, LBS estimate value, etc.). In block 2256, the iOT device may pass the received LBS information through a first kalman filter (Kalman Filter 1) to generate filtered LBS data (e.g., a filtered LBS estimate value, etc.). The kalman filter may be a procedure, algorithm, method, technique, or sequence of operations for accomplishing the function of a kalman filter.

In block 2260, the iOT device may perform trilateration operations (e.g., trilateration API location operations, etc.), determine the geographical coordinates of the iOT device, and generate a third data set (e.g., x, y and z coordinates, third estimate value, etc.) based on the determined geographical coordinates. In block 2262, the iOT device may pass the first, second, and third data sets (or estimate values, etc.) through a second kalman filter (Kalman Filter 2) to generate a position set (e.g., final position set, final location estimate value, updated final location estimate value, etc.). In block 2264, the iOT device may use the position set to determine/compute the current location of the device. As part of these operations, the iOT device may generate a waypoint information structure (or estimate value) that includes trilateration location values (X, Y, Z), a time value, trilateration location delta values (ΔX, ΔY, ΔZ), confidence values (C_{X},C_{Y},C_{Z}), and one or more precision values, and use the generated way point to set the current location of the device. In an embodiment, the iOT device may be configured to store the waypoint in a list (or other information structure) in conjunction with a timestamp.

FIG. 22C illustrates three types of position calculations that are fused creating one position that is reported for the device. In addition, not only is a kalman filter approach used for the trilateration process involving external devices which the anchor iOT device (AD) determines its position from, but the external trilateration position is fed into another kalman filter process which also uses as inputs the internal position tracking via dead reckoning, and the available external stationary devices and systems, and external iOT device and systems, collectively abbreviated to as external devices (ED), which are reporting what the current devices location is.

Several decisions may be made regarding the measurements received, as well as the need to obtain or retrieve previous waypoints, based on the number of devices reporting to the anchor iOT device. As mentioned above, a waypoint may include location information that has been determined to be valid location information, confidence value, an overall rank value, a device specific rank value. In some embodiments, the location information may be generated based on dead reckoning location information, external trilateration location information, and/or location information received from external devices. In some embodiments, the waypoint may include dead reckoning location information, external trilateration location information, and/or location information received from external devices.

The output generated via the performance of the iOT trilateration may include location information defining three (3) points that could be used to make a reliable positional determination (e.g., to generate more precise location information).

The eLBS iOT Trilaterion operations discussed above with reference to FIGS. 22A through 22C may utilize inputs from GPS, Cell ID, Wi-Fi ID, Beacons, RFIDs, Mobile Devices (Ue's) or other external devices that provide a location position of the device (e.g., as part of the operations in block 2240). The external devices can be both active and passive devices.

The eLBS iOT Trilaterion operations discussed above with reference to FIGS. 22A through 22C may also include using dead reckoning when placing or installing the node/device, and equipping the iOT device with suitable sensors and capabilities (if needed). Examples of such sensors and capabilities may include a two or three-dimensional gyroscopes, compasses, and barometers and other advanced sensors enabling the device to estimate how far it has transverses over a particular period of time in any three dimensions in space from a predetermined fixed reference point. In some embodiments, the device may also include a GPS receiver and/or RAN circuitry.

In some embodiments, the eLBS iOT Trilaterion operations may allow a device to utilize other devices (e.g., other iOT devices, mobile devices, etc.) to obtain its position relative to those devices. The devices used for positioning may be non-stationary, enabling multiple waypoints to be established at discrete periods of time. Additionally, the iOT devices do not need to be permeant for their location, enabling the potential for enabling multiple waypoints to be established at discrete periods of time.

The eLBS iOT Trilaterion operations may include the other devices (e.g., mobile devices) in the ecosystem using an eNodeB to obtain their positions or location information. By utilizing an iterative process with eLBS iOT trilateration, the actual position of the all the devices, eNodeBs, individual cells and antenna, mobile devices as well as the various iOT devices may be obtained using a collective ecosystem for improvement.

The eLBS iOT Trilaterion operations may include using a kalman filter, which may involve various external devices from which the iOT device determines its position. The external trilateration position information (e.g., data generated in blocks 2258 and 2260) may feed into another kalman filter (e.g., in block 2262). The second Kalman filter may use this information, along with information received from other external devices and systems, to determine the current device's location (latitude, longitude and altitude).

In some embodiments, the eLBS iOT Trilaterion operations may include generating an output in the form of a position location (latitude, longitude and altitude), which may be used by an iOT device to determine and report its current position (latitude, longitude and altitude).

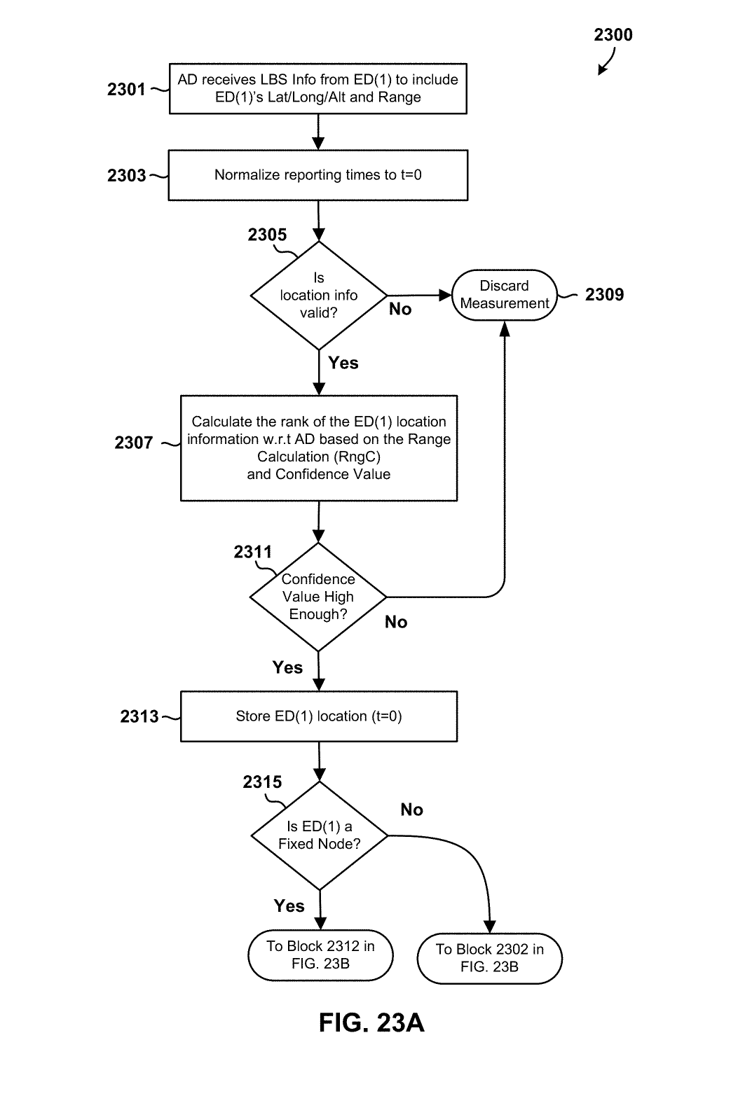

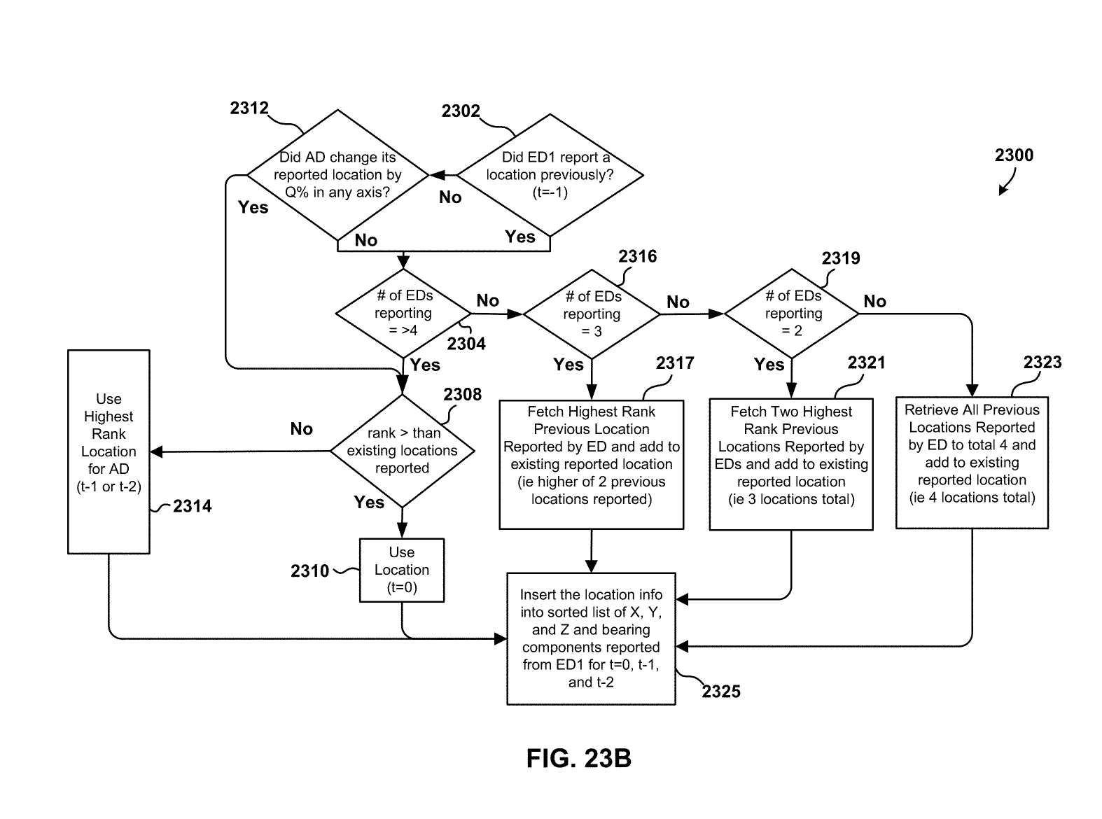

FIGS. 23A and 23B illustrate methods for receiving and using (e.g., in an anchor iOT device (AD)) an external device's (ED's) position information to provide an enhanced location based service. The ED may be a iOT device, fixed infrastructure node (FIN) or a mobile device (Ue). The AD may be configured to determine the ED's relative position (e.g., relative to itself) and compare the determined relative position to a range value provided by the ED. The range value may be value that is calculated in the ED, and which identifies a distance between the ED and the AD. For ease of legibility, the method illustrated in FIG. 23A represents an example for receiving data from a single device. It should be understood that, in other embodiments, the same or similar operations may be performed based on information received from multiple devices.

At block 2301, an AD may receive location information (e.g., LBS information, etc.) from ED(1), which may be a fixed or mobile device. The location information may include a latitude value, a longitude value, an altitude value, range information, and a time value. In an embodiment, the location information may be a waypoint. In block 2303, the AD may normalize the location information timing to a time (e.g., t=0). Said another way, the AD may normalize its measured location and/or received location information to a common time (e.g., based on the processors cycle) so that the ad-hoc positions reported by all the EDs and other sensors are normalized (or synchronized) to a unified time. In some embodiments, in block 2303, the AD may perform a pseudo synchronization method. In some embodiments, after normalizing/synchronizing the location information timing, the AD may determine and assign a confidence value to each unit of location information (e.g., each waypoint, etc.) provided by each ED. In block 2304, the AD may calculate a rank for the received information (e.g., with respect to the current device, etc.) based on the range calculation (RngC) and confidence value.

In determination block 2305, the AD may determine whether the received location information is valid. Validity may be determined on a variance between expected and actual relative positions. For example, the AD may be configured to compute or determine an expected position (or expected relative position) based on previous trilateration results, previous dead reckoning results, or data received from other external sensors or devices. In some embodiments, the location may be calculated based on the location information provided to the AD by the ED.

In response to determining that location information is not valid, (i.e., determination block 2305=“No”), the AD may discard the measurement in block 2309. If a location value is determined to not be valid and/or has a confidence that is too low (i.e., does not exceed a threshold value), it can be temporarily stored and marked to be discarded. If the AD receives location information from several EDs having low confidence values associated with the location information which were initially determined not to be valid, but the EDs reported location information have high precision, the AD may take those low confidence measurements as being valid. In this case the measurements have the marker for discarding removed and are stored for use in block 2307. In response to determining that a location information is valid, (i.e., determination block 2305=“Yes”) the AD may use the information in block 2307.

In particular, in block 2307, the AD may calculate a rank for location information provided by ED(1) with respect to AD based on the range calculation and confidence value of the location information provided by ED(1). In determination block 2311, the AD may determine whether the location information provided by ED(1) has a sufficiently high confidence value. In response to determining that the location information provided by ED(1) does not have a sufficiently high confidence value (i.e., determination block 2311=“No”), the AD may mark the location information provided by ED(1) to be discarded in block 2309. This is similar to the AD making a determination that the information is not valid, but the location information has a confidence value, and range value/calculation associated with it. In response to determining that a location information has a sufficiently high confidence value, the AD, in block 2313, may stores the location information as a waypoint (e.g., as a current location waypoint) for ED(1) in its location database.

With reference to FIG. 23B, in determination block 2302, the AD may determine whether the ED previously reported a location (or sent a valid waypoint, etc.). In response to determining the ED did not previously report a location, (i.e., determination block 2302=“No”), in determination block 2312, the AD may determine whether the AD moved (or changed its reported location) by more than a distance or a percentage value in any axis or direction.

In response to determining that the AD changed its position by a set percentage in any axis (i.e., determination block 2312=“Yes”), the AD may determine whether a rank value associated with reported location information (or reported waypoint) exceeds (e.g., is greater than, etc.) the ranks of the other stored or received location information (or received waypoints) in determination block 2308. In response to determining that the rank value associated with reported location information does not exceed the ranks of the other stored or received location information, in block 2314, the AD may select and use the highest ranked waypoint, which may be a previously computed and stored waypoint for AD (e.g., for t=t−1 or t=t−2 etc.) with its range corrected to the t=0 for the current position of AD. In block 2325, the AD may insert the waypoint into a sorted list of coordinates X, Y, and Z and bearing components reported from ED1 for t=0, t=t−1, or possibly t=t−2 accordingly.

In response to determining that the AD did not move (or change its reported location) by more than the distance or percentage value in any axis or direction (i.e., determination block 2312=“No”), that the AD is stationary, or that the ED did report a location (i.e., determination block 2302=“Yes”), the AD may determine whether four or more EDs are currently reporting location information (or whether waypoints where received from four or more devices) in determination block 2304. In response to determining that four or more EDs are reporting location information (i.e., determination block 2304=“Yes”), the AD may determine whether a rank value associated with reported location information (or reported waypoint) exceeds (e.g., is greater than, etc.) the ranks of the other stored or received location information (or received waypoints) in determination block 2308.

In response to determining that the rank of the reported waypoint exceeds the ranks of the other stored or received waypoints (i.e., determination block 2308=“Yes”), in block 2310 the AD may store the location information (or received waypoint) in memory and/or mark the information as being suitable for use as the current location waypoint or location information for t=0. On the other hand, in response to determining that the rank of the reported waypoint does not exceed the ranks of the other stored or received waypoints (i.e., determination block 2308=“No”), the AD may select and use the highest-ranking waypoint/location information in block 2314.

In response to determining that four or more EDs are not reporting location information (i.e., determination block 2304=“No”), in determination block 2316 the AD may determine whether three EDs are currently reporting location information. In response to determining that three EDs are reporting location information (i.e., determination block 2316=“Yes”), in block 2317 the AD may retrieve the highest-ranking location information or the highest ranked stored waypoint from memory. The highest ranked stored waypoint may be a previously reported waypoint (received from any of the reporting EDs) that has the highest rank. The retrieved waypoint may be added to the existing three reported waypoints (i.e., the waypoints received from each of the three reporting EDs) to obtain a total of four waypoints. The waypoints may time normalized to t=0 and range corrected for t=0, and in block 2325, the AD may insert the waypoints into a sorted list of coordinates X, Y, and Z and bearing components reported from ED1 for t=0, t=t−1, or possibly t=t−2 accordingly.

In response to determining that three EDs are not reporting location information (i.e., determination block 2316=“No”), in determination block 2319 the AD may determine whether two EDs are currently reporting location information. In response to determining that two EDs are reporting location information (i.e., determination block 2319=“Yes”), in block 2321 the AD may retrieve two previously reported highest ranked waypoints (received from any of the reporting EDs). The AD may add the retrieved waypoints to the existing two reported waypoints to obtain a total of four way points. The previously reported waypoints may be time normalized to t=0 and range corrected for t=0. In block 2325, the AD may insert the waypoints into a sorted list of coordinates X, Y, and Z and bearing components reported from ED1 for t=0, t=t−1, or possibly t=t−2 accordingly.

In response to determining that two EDs are not reporting location information (i.e., determination block 2319=“No”), in block 2323 the AD may retrieve three of the highest ranked previously reported waypoints stored in memory to obtain a total of four waypoints. The previously reported waypoints may be time normalized to t=0 and range corrected for t=0. In block 2325, the AD may insert the waypoints into a sorted list of coordinates X, Y, and Z and bearing components reported from ED1 for t=0, t=t−1, or possibly t=t−2 accordingly.

Block 2325 uses the waypoints in the sorted list as input for the various method for trilateration disclosed in this application, including the methods for determining the position location accuracy (using the trilateration) for multiple devices reporting locations. The output of the AD's trilateration for each EDs, the reported positions, may be ranked with respect to each other based on accuracy and confidence. Using these values, possibly discarding or ignoring those values which are considered inferior or invalid, provides for achieving highest position location accuracy to be achieved. The output of the eLBS trilateration operations may be a position/location (or waypoint) that is used by a device to report its current position (or for other functions, such as to provide an enhanced location based service).

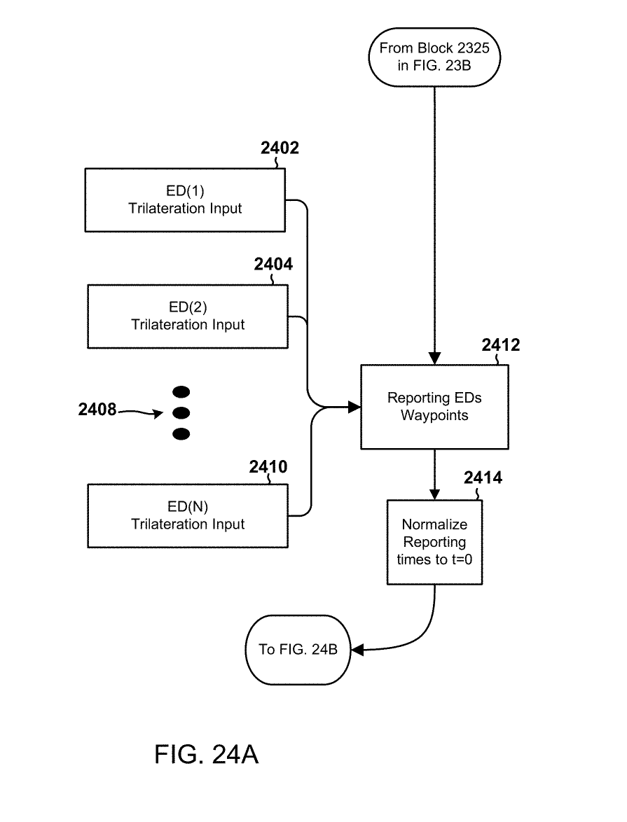

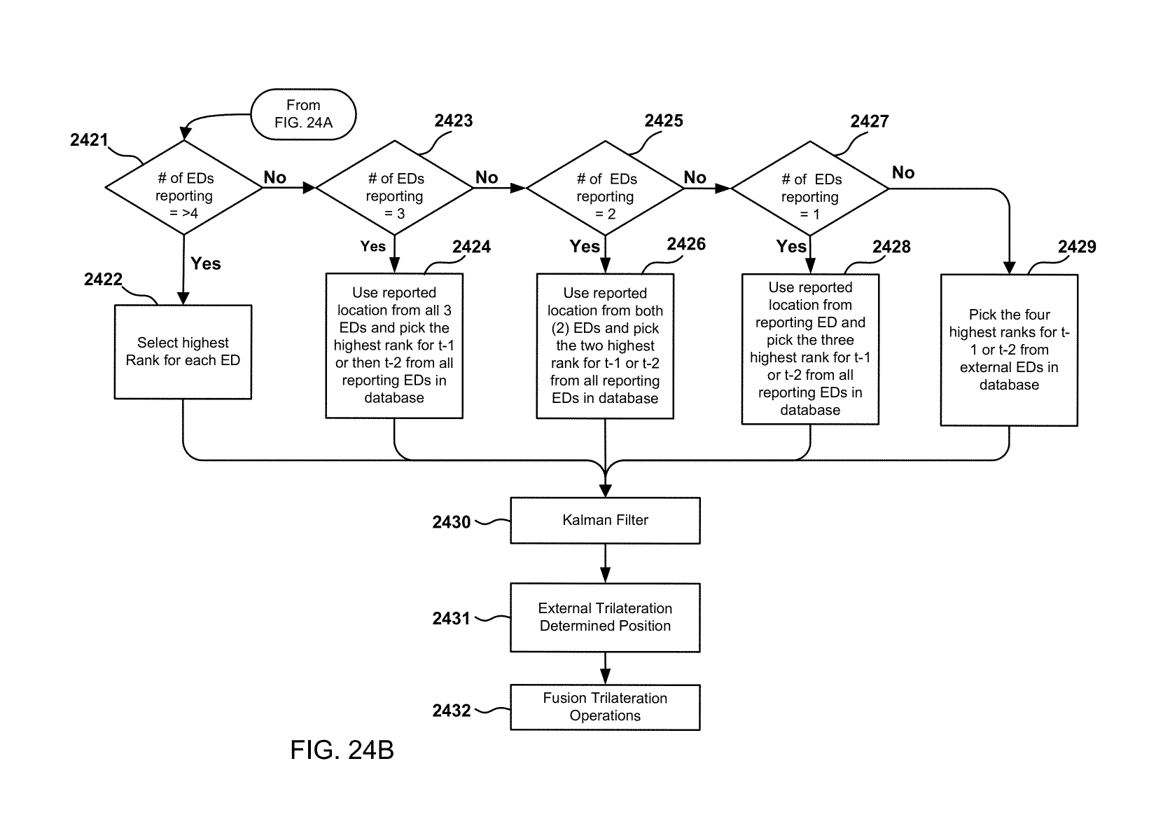

FIGS. 24A and 24B illustrate processes for determining the position location accuracy using the trilateration methods for multiple devices reporting locations. In particular, FIG. 24A illustrates the output of block 2325 (illustrated in FIG. 23B) may be used (for each reporting ED, which may be a fixed infrastructure device (FID) or fixed infrastructure node (FID)) as trilateration input. Block 2402 illustrates the trilateration input for a first ED, ED(1), which is process 2300 for ED(1). Block 2404 illustrates the trilateration input for a second ED, ED(2) which is process 2300 for ED(2). Block 2408 illustrates one or more EDs providing trilateration input. Block 2410 illustrates the trilateration input for an Nth ED, ED(N) which is process 2300 for ED(N). All of the trilateration input may be combined in block 2412 as reporting EDs waypoints. All of the separate ED's waypoints may be normalized to a time, t=0, in block 2414.

With reference to FIG. 24B, in determination block 2421, the AD may determine whether four or more EDs are reporting location information. In response to determining four or more EDs are reporting location information (i.e., determination block 2421=“Yes”), in block 2422, the AD may select the highest ranked waypoint reported for each ED. The AD may provide the selected waypoints as inputs to a kalman filter in block 2430.

In response to determining fewer than four EDs are reporting location information (i.e., determination block 2421=“No”), in determination block 2423, the AD may determine whether three EDs are reporting location information. In response to determining three EDs are reporting location information (i.e., determination block 2423=“Yes”), in block 2424, the AD may use the reported waypoints from all three EDs and selects the highest ranked previously reported waypoint for t=t−1 and/or t=t−2 for any ED in the database (and in so doing obtains a total of four waypoints). The AD may then provide the four waypoints to a kalman filter in block 2430.

In response to determining that fewer than three EDs are reporting location information (i.e., determination block 2423=“No”), in determination block 2425 the AD may determine whether two EDs are reporting location information. In response to determining two EDs are reporting location information (i.e., determination block 2425=“Yes”), in block 2426 the AD may use the reported waypoints for both EDs and select the two highest ranked previously reported waypoints for t=t−1 and/or t=t−2 (for any reporting ED in the database) to obtain a total of four waypoints. The AD may provide these four waypoints to the kalman filter in block 2430.

In response to determining that fewer than two EDs are reporting location information (i.e., determination block 2425=“No”), in determination block 2427 the AD may determine whether one ED is reporting location information. In response to determining that one ED is reporting location information (i.e., determination block 2427=“Yes”), in block 2428 the AD may use the reported waypoint and the three highest ranked previously reported waypoints for t=t−1 and/or t=t−2 for the any EDs in the database to obtain a total of four waypoints. The AD may provide these four waypoints to the kalman filter in block 2430.

In response to determining no EDs are reporting location information, (i.e., determination block 2425=“No”), in block 2429 the AD may retrieve the four highest ranked waypoints, and provides these four waypoints to a Kalman filter in block 2430.

The kalman filter in block 2430 may be used to generate an external trilateration determined position 2431 for time period 0 (t=0). This value may be fed as input to the fusion trilaterion process 2432 to generate filtered LBS data (e.g., a filtered LBS estimate value, etc.). The kalman filter 2430 may be a procedure, algorithm, method, technique, or sequence of operations for accomplishing the function of a kalman filter.

All the reporting EDs may be compared to each other, ranked prior to being sent to a kalman filter with the appropriate matrix and weighting factors.

The trilateration operations discussed above may be performed/conducted for various sources. Such operations may enable the iOT device to generate more robust position/location information having high confidence values (e.g., for accuracy, precision, etc.).

Thus, an anchor iOT device receives the location (latitude, longitude and altitude) from external sources like other iOT devices, FIN or UEs and determines if the location reported is indeed valid. Validity may be based on relative position to itself and the confidence value indicating whether the reporting device position is correct. If any of the other reporting device does not have confidence in its location (latitude, longitude and altitude) and several of the external devices also report similar positions which may be initially discarded the iOT may take those degraded measurements as possibly being within validity. The iOT device after determining quickly the validity of the reported device location (latitude, longitude and altitude) stores the value in its database. The iOT also normalizes the measurement to a common time based on the processors cycle so the ad-hoc positions reported by all the devices and other sensors are normalized or rather synchronized to a unified time. Several decisions may be made regarding the measurement received as well as the need to obtain previous positions or rather waypoints (WP) based on the number of devices reporting to the anchor iOT device.

The output of the iOT trilateration process for each device may be feed into another process that utilizes the best reported positions (latitude, longitude and altitude) from all the reporting and non-reporting devices so the best position estimate (latitude, longitude and altitude) may be obtained.

In some embodiments, the iOT device may be fixed relative to the anchor iOT device (AD) and not moving. In some embodiments, the iOT device may be treated as a mobile device in the trilateration process (e.g., in response to determining that the iOT device is movable or currently in motion relative to the anchor iOT).

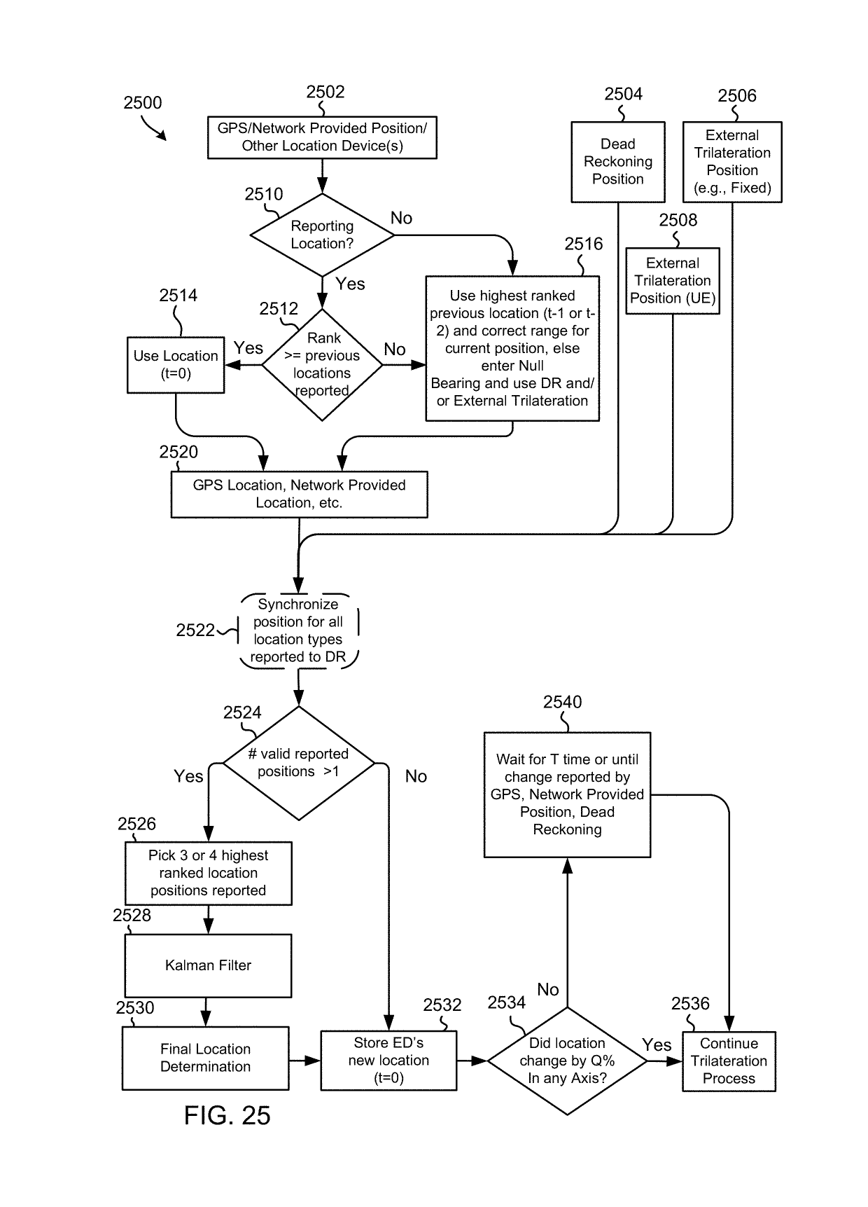

FIG. 25 illustrates a method 2500 of performing fusion trilateration operations using information or inputs from various sources. In block 2502, a processor in an anchor iOT device (AD) may receive information from external sources, including include GPS data, Network provided position information, Cell ID, WiFiID, Beacon/RFID and other data. In the illustrated example, the AD processor receives GPS and network provided position in block 2502, dead reckoning 2504, external trilateration position from fixed devices 2506 and external trilateration position from other iOT devices, wireless devices or UEs 2508.

In block 2510, the AD processor may determine whether a waypoint or location information has been reported (e.g., by a specific device having a source type, etc.). In response to determining that a waypoint or location information has not been reported (i.e., determination block 2510=“No”), in block 2516 the AD processor may retrieve and use previous reported locations from memory. In response to determining that at least one waypoint or location information has been reported (i.e., determination block 2510=“Yes”), in blocks 2512, 2514 and 2518 the AD processor may select and use the received waypoint or information (for t=0). If more than the required number of waypoints have been reported (and stored in memory), the AD processor may select and use the waypoints/location information with the highest ranks in blocks 2512, 2514, and 2518 as the location information. Alternatively, the if no valid previous locations have been reported, the AD processor could elect to not use data from that device, but rather use dead reckoning position information 2504, external trilateration positioning information 2506, and/or UE external trilateration positioning information to select location information in block 3606.

If the external device is reporting valid location information to AD processor, it is ranked according to previously received location information for that device. If no previous location information has been received, the most current valid location information being received is used. If the current reported location information is ranked highest, it is used as the location information and stored in the location information database. If previous location information has been received and the ranking of the current received location information is lower than the previous information, the highest ranked previously reported location information is used.

In some embodiments, having received the location reporting devices from external devices, if any external trilateration position information is received, all location information may be synchronized for time values in optional block 2522 (e.g., via any of the methods discussed in the application) with the dead reckoning data from the AD processor. If in block 2524, only one valid position is available (i.e., determination block 2524=“No”), that location information may be stored by the AD processor as the location for the AD processor in block 2532. If more than one valid position is reported (i.e., determination block 2524=“Yes”), the valid positions are ranked from best to worse based on confidence values, and the three or four highest positions are selected in block 2526. The selected positions are used as input into a kalman filter in block 2528. The output from the kalman filter is stored as the AD processor's location (or Final Location Determination value) in block 2530. If more than one, but less than four locations are reported, for determining the remaining positions to obtain a total of four positions, inputting these into the kalman filter, and storing the best location (output of the kalman filter) in block 2532. The stored location, best location, or output of the kalman filter may also be identified as the location of the device in block 2532.

In determination block 2534, the AD processor may determine whether the new location of AD processor changed (relative to its previously computed location) more than a given distance or percentage value in any axis, or greater than a location information value. In response to determining that the new location of AD processor changed (relative to its previously computed location) more than a given distance or percentage value in any axis (i.e., determination block 2534=“Yes”), the trilateration process may be continued or repeated in block 2536 to obtain a more precise location information. If there is no change or the change is less than a certain percentage (i.e., determination block 2534=“No”), the AD processor may wait for a set amount of time (T) to obtain any changes in location in block 2540. The procedure can also mark the AD processor as stationary and wait until a change is reported by any reporting device, external trilateration information, or internal sensors or components that can be used for dead reckoning. Also, as part of the process involving external device trilateration, the use of previous positions can be used to achieve the necessary set of points from which a three-dimension position may be calculated.

Thus, method 2500 includes using the various inputs (trilateration input values) to generate or provide positional information (latitude, longitude and altitude) in accordance with an embodiment. The inputs may include information from external and internal sources. The external sources may include GPS, network provided position, fixed infrastructure nodes, iOT devices and mobile devices and other external position sources.

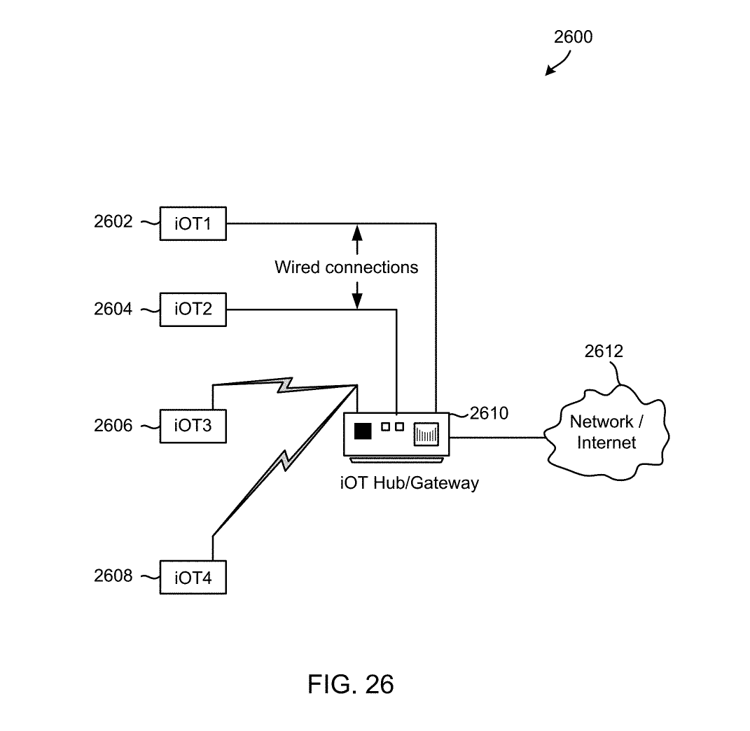

FIG. 26 illustrates an embodiment system 2600 that includes iOT devices 2602, 2604, 2606, 2608 connected to an iOT Hub 2610 (or iOT Gateway) via wired and/or wireless communication links. The iOT Hub 2610 includes communication links that allow it to send and receive information to and from a private or commercial network 2612, which may include communication links to a local network, Internet-connected network, an iOT cloud server, iOT service provider network, etc. The iOT Hub 2610 and/or each of the iOT devices 2602, 2604, 2606, 2608 may include a memory and processor that is configured with processor executable instructions to perform the operations discussed in this application for determining the locations of the iOT Hub 2610 and iOT devices 2602, 2604, 2606, 2608. In some embodiments, the processor(s) may be configured to determine the locations of the iOT devices 2602, 2604, 2606, 2608 relative to the location of the iOT Hub 2610.

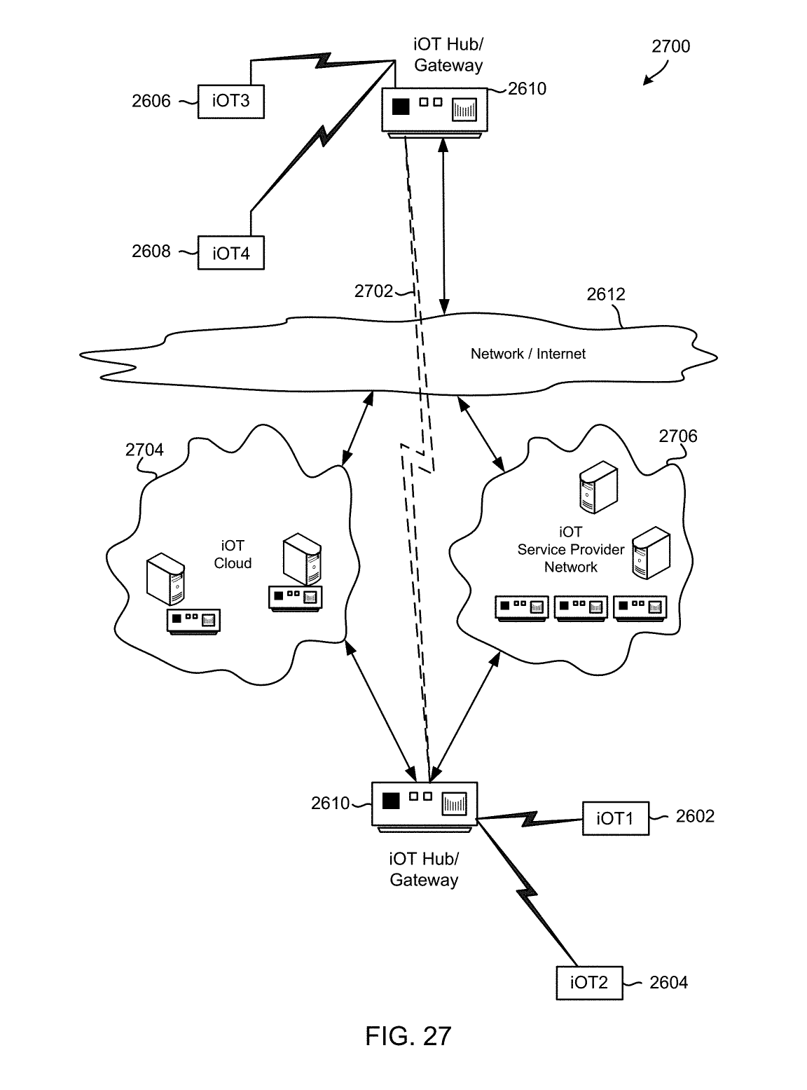

FIG. 27 illustrates an embodiment system 2700 in which the iOT devices 2602, 2604, 2606, 2608 are distributed across a large geographic area. The iOT hubs 2610 may or may not have direct connectivity or communication links 2702 that allows them to communicate directly. In response to determining that direct connectivity or communication links 2702 are not available, the iOT Hubs 2610 may generate and send communication messages to an iOT cloud server/network 2704 and/or iOT cloud service provider server/network 2706 that may facilitate communications between the iOT hubs 2610. The iOT Hubs 2610 may also send and/or receive telemetry information to iOT cloud server/network 2704 and/or iOT cloud service provider server/network 2706. The iOT cloud server/network 2704 and/or iOT cloud service provider server/network 2706 may include server computing devices that are configured to receive telemetry and data from the iOT Hubs 2610, analyze and/or crowdsource the received information, and send the received information and/or the analysis results to other iOT Hubs 2610.

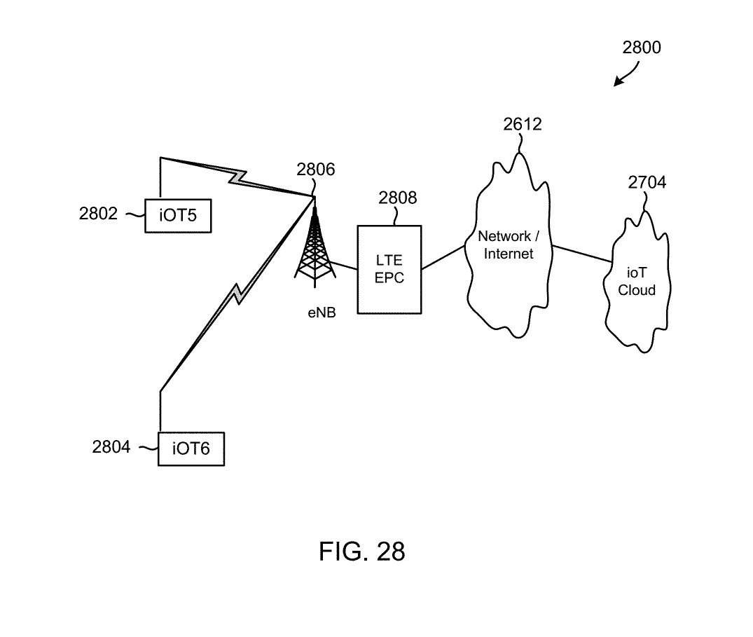

FIG. 28 illustrates an embodiment system 2800 that includes iOT devices 2802, 2804, an eNodeB 2806, and an LTE EPC core network 2808, which is coupled to a network 2612 and iOT cloud server/network 2704. The iOT devices 2802, 2804 may obtain connectivity with an iOT service provider or iOT cloud server/network 2704 through an LTE system (or other wireless network). In some embodiments, the system 2800 may include an LTE network RAN configured to support wideband and/or narrow band LTE, which may be selected depending on the telemetry required to communicate with or service one or more of the iOT devices 2802, 2804.

Thus, iOT devices 2802, 2804 are capable of operating using LTE RAN protocol. Each of the iOT devices 2802, 2804 may function as a wideband iOT device enabling large telemetry or streaming information. Each of the iOT devices 2802, 2804 may also function as a narrowband LTE device through provisioning of the device either via over the air or with command sent from the iOT service provider or similar method, enabling the device to operate in as a narrow band LTE iOT device or a wideband LTE iOT device.

While a single eNodeB 2806 is illustrated in FIG. 28, it should be understood that the system 2800 may be expanded to include additional eNodeBs 2806, including eNodeBs 2806 utilizing unlicensed bands.

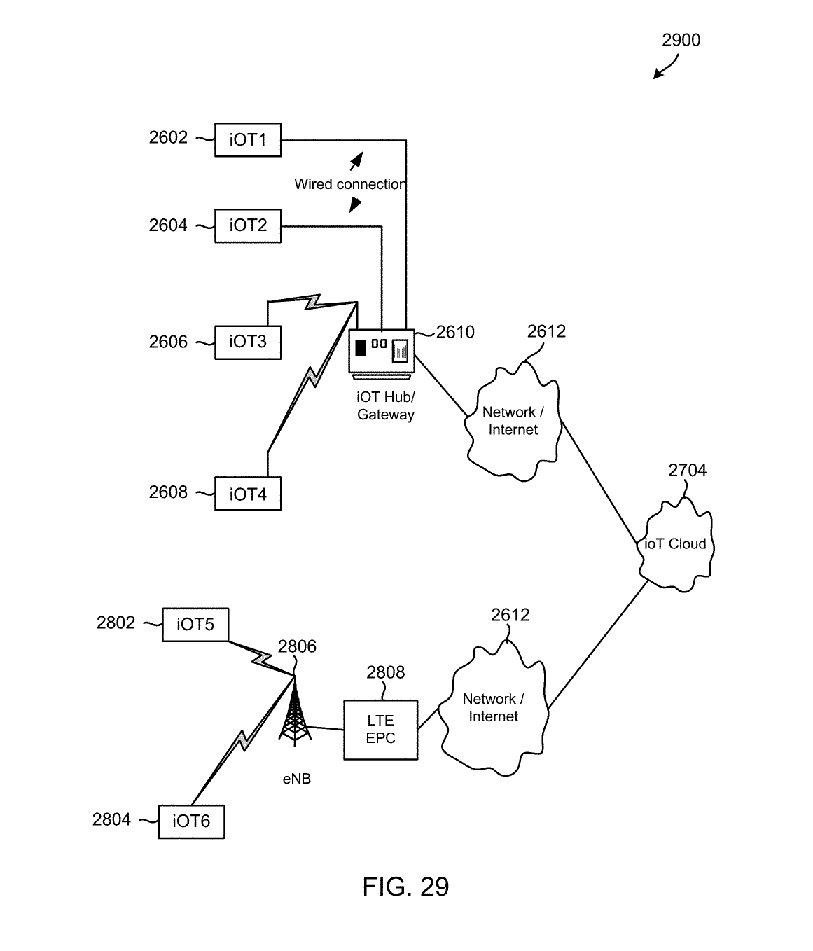

FIG. 29 illustrates an embodiment system 2900 that includes iOT devices connected to the iOT cloud server/network 2704 via different networking and communication technologies. In particular, iOT devices 2602, 2604, 2606, 2608 are connected to a iOT Hub 2610, which includes communication links that allow it to send and receive information to and from a private or commercial network 2612 and, ultimately, the iOT cloud server/network 2704. The iOT devices 2802 and 2804 include communication links to an eNodeB 2806 coupled to an LTE EPC core network 2808 that allows these devices to communicate with the network 2612 and iOT cloud server/network 2704.

In some embodiments, one or more of the iOT devices 2602, 2604, 2606, 2608, 2802, 2804 may include communication circuitry that allows them to establish direct connecting to the Internet, network 2612, or iOT cloud server/network 2704.

The system 2900 and connectivity illustrated in FIG. 29 may enable a host of service offerings from narrowband telemetry to wideband telemetry of various mediums. In this example shown in FIG. 29, the different iOT devices 2602, 2604, 2606, 2608, 2802, 2804 are in close proximity to each other. However, none of these devices are connected directly to the iOT cloud. In some embodiments, one or more of the iOT devices 2602, 2604, 2606, 2608, 2802, 2804 may include a “location awareness” component and/or implement location awareness functionality.

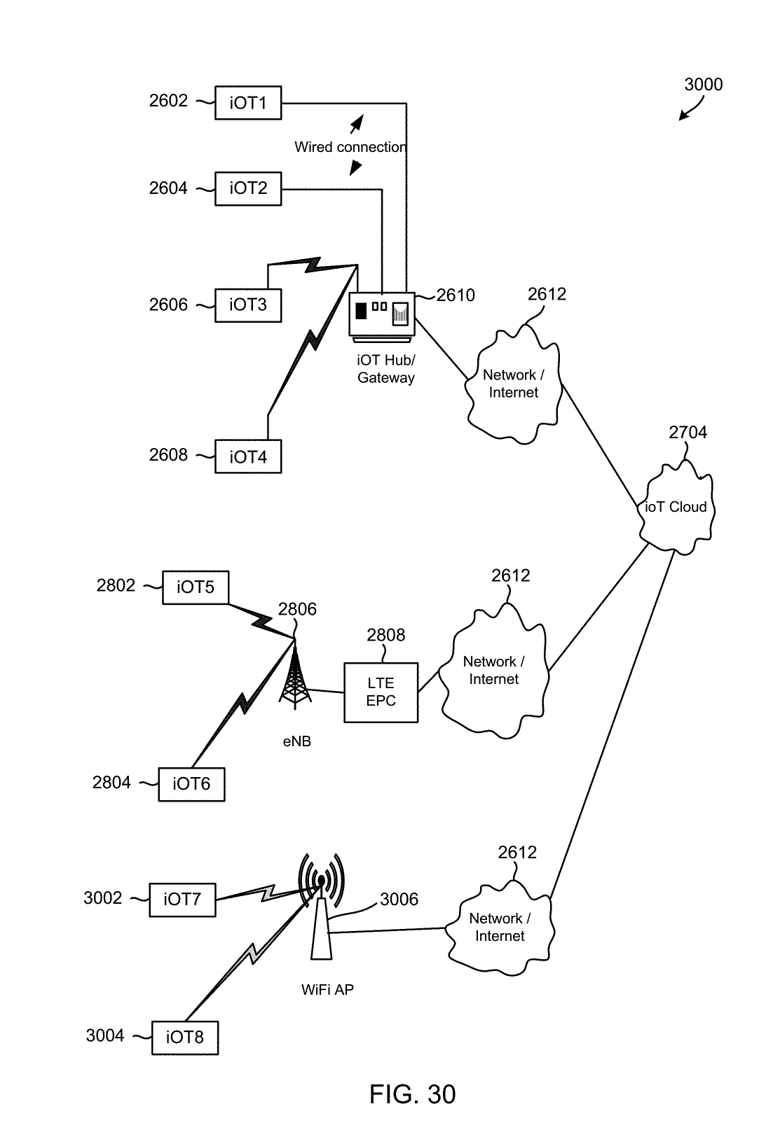

FIG. 30 illustrates another embodiment system 3000 that includes iOT devices connected to a iOT cloud server/network 2704 via a variety of different networking and communication technologies. In addition to the components illustrated in FIG. 29 and discussed above, the system 3000 illustrated in FIG. 30 includes iOT devices 3002 and 3004 coupled to a WiFi Access Point 3006 via wireless communication links. The WiFi Access Point 3006 allows the iOT devices 3002 and 3004 to communicate with the network 2612 and iOT cloud server/network 2704. It should be understood that additional communication, networking and network access technologies may be included and used by the 3000 so as to allow iOT devices to communicate with each other, the network 2612 and/or iOT cloud server/network 2704. The amount or number of perturbations may be continued for the inclusion of ZigBee, Sioux, SubG and other iOT radio access schemes.

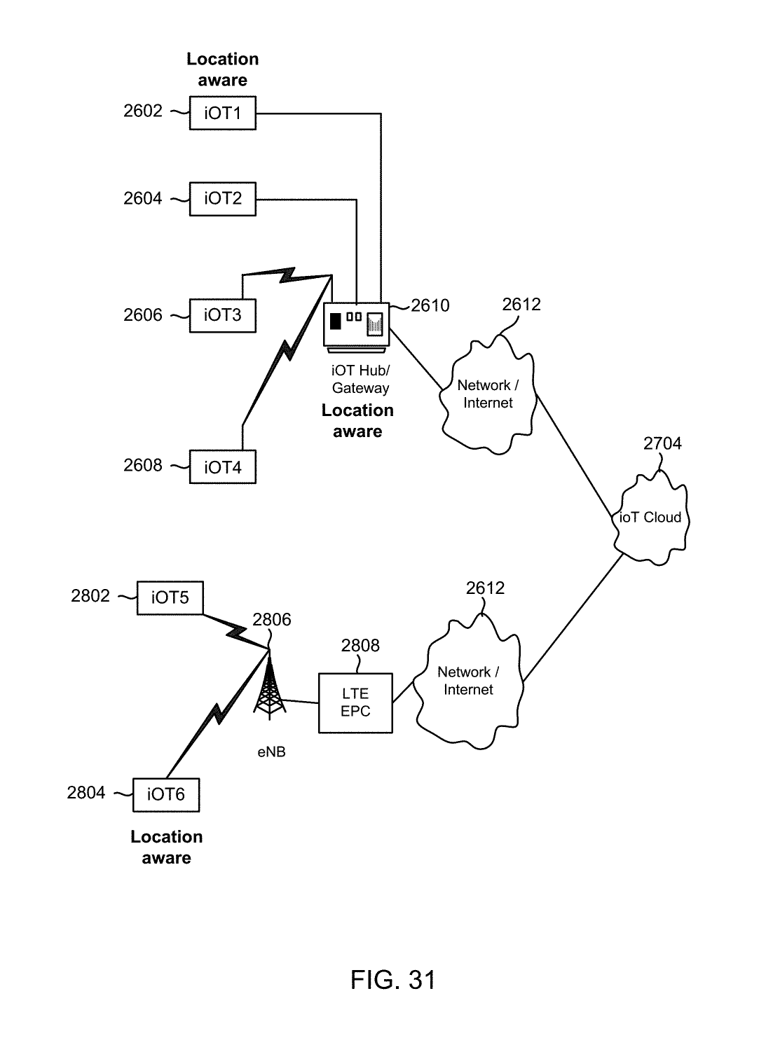

FIG. 31 illustrates an embodiment system 3100 that includes Location Aware (LA) iOT devices and components. In particular, in the example illustrated in FIG. 31, the iOT Hub 2610 and iOT devices 2602 and 2804 are location aware devices. The degree of location awareness may be variable and/or determined and set based on a variety of different factors. As examples, the degree of location awareness may be associated with a IP address, physical street or apartment location related to the billing information or pertaining to the range from a cell site where the iOT device may be able to obtain GPS/A-GPS or ranging information for its approximate location. In various embodiment, the iOT Hub 2610 may be configured to implement or use any of a variety of communication, networking, network access, iOT radio access schemes and technologies, which may include ZigBee, WiFi, SubG, sigfox, narrowband iOT, etc.

In some embodiments, the iOT Hub 2610 may be configured to determine its location (e.g., as part of its location awareness functionality) and/or have its location defined based on its corresponding billing address information. The first Location Aware (LA) iOT device 2602 may determine its location based on information collected from sensors (e.g., GPS sensors, etc.) and/or based on the billing address, hand entry of location when it was placed in service, etc. The second Location Aware (LA) iOT device 2804 may determine its location based on LTE location capability, which may be fixed or mobile (e.g., depending on the iOT services provided by the device).

Accurate and efficient location awareness capabilities may important for many iOT devices, and they allow or facilitate a host of other capabilities and enhancements. Further, location aware iOT devices may be better or more easily associated with a particular consumer or location. The various embodiments allow iOT to determine their precise location, including locations within an apartment or home with multiple floor or levels that above or below grade. The various embodiments also allow for the automatic provisioning of the iOT devices without having to have the consumer provision the devices. The automatic provisioning (or introduction of a plug and play environment) may allow the various embodiment to tightly couple devices to each other for a coordinated ecosystem of sensors and services that facilitate a host of additional features and capabilities. By creating a coordinated ecosystem of sensors and services, various embodiments may improve the capabilities, performance and functioning of the individual consumer devices, thereby enhancing the consumer experience.

The various embodiments may be used to provide enhance infrastructure monitoring for bridges, tunnels, and roadways; used to provide enhanced services through connectivity via a iOT cloud service; used to monitor, control or report information that could be used by vehicles (e.g., road conditions, traffic or other road hazards may be detected and routed to iOT devices, which may send this information to vehicles for use in making better or more informed decisions regarding routes, speeds, etc.); for enhanced asset tracking including container transport, etc.

With plug and play or rather a self-organizing network of iOT devices the addition or removal of iOT device is also possible without requiring the need for human intervention. Examples of inclusion of a iOT device can be where a device is brought into the ecosystem either as an enhancement to the iOT ecosystem or a device temporary entering the ecosystem. This method can also be used for removing a iOT device from service either because of performance issues, moving out the ecosystem area or because a service subscription has ended.

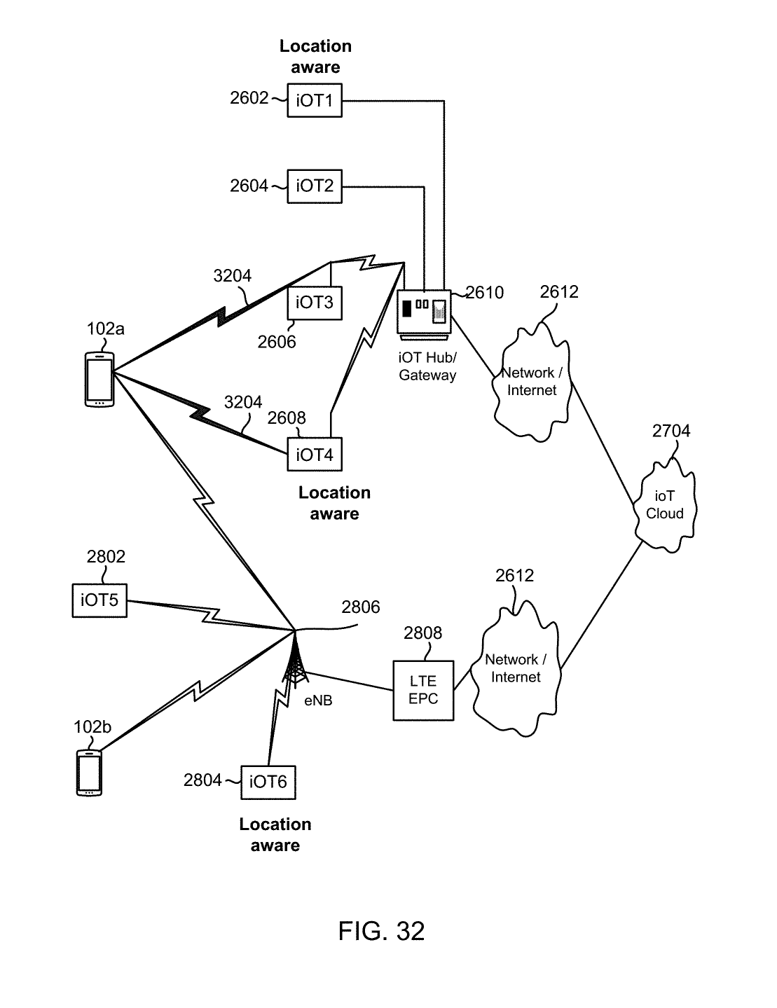

FIG. 32 illustrates an embodiment system 3200 that includes a plurality of iOT devices and mobile devices. The inclusion of mobile devices could be used to help improve the location awareness of the iOT devices. For example, mobile device 102a may be configured to communicate with a iOT device 2606 and/or the iOT hub 2610, enabling any or all of the iOT devices in the system 3200 to obtain a three-dimensional position fix from the mobile device 102a via eLBS. Each of the iOT device 2606 may also implement or use any or all of the eLBS techniques or technologies described in this application.

In the example illustrated in FIG. 32, iOT devices 2802 and 2804 are connected to the eNodeB 2806, and may obtain a location position from mobile device 102b directly or via the eNodeB 2806. The iOT devices 2606 and 2608 may communicate with mobile device 102a via direct communication links 3204. The iOT devices 2606 and 2608 may communicate with mobile device 102b via indirect communication links that are facilitated via any or all of the iOT Hub 2610, LTE network 2808 and/or iOT cloud server/network 2704. The iOT devices may use such communication to determine their locations, update their current location information, and/or to allow the mobile devices 102 to obtain a better position fix.

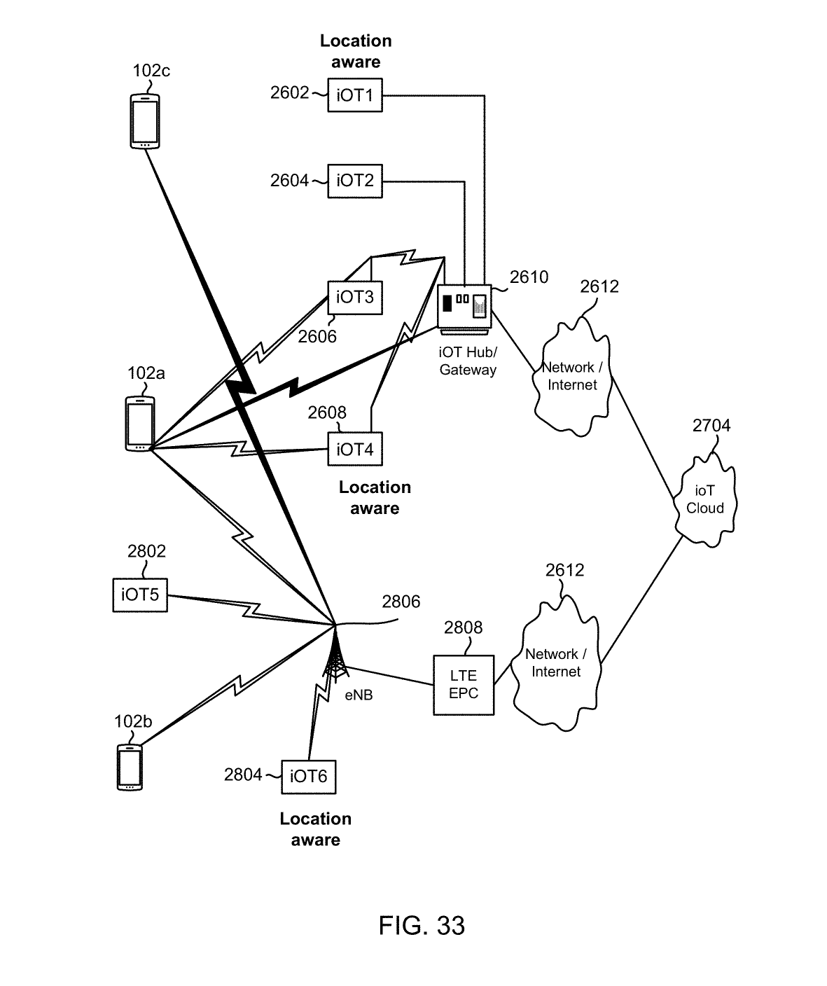

FIG. 33 illustrates that mobile device 102c may communicate with iOT device 2802, which may use a wired connection to reach other iOT service or aggregation points. The iOT device 2802 may also request and receive position updates or enhancements from the mobile device 102c via eLBS. FIG. 33 also illustrates that mobile device 102a may communicate with iOT device 2804 via the iOT hub 2610.

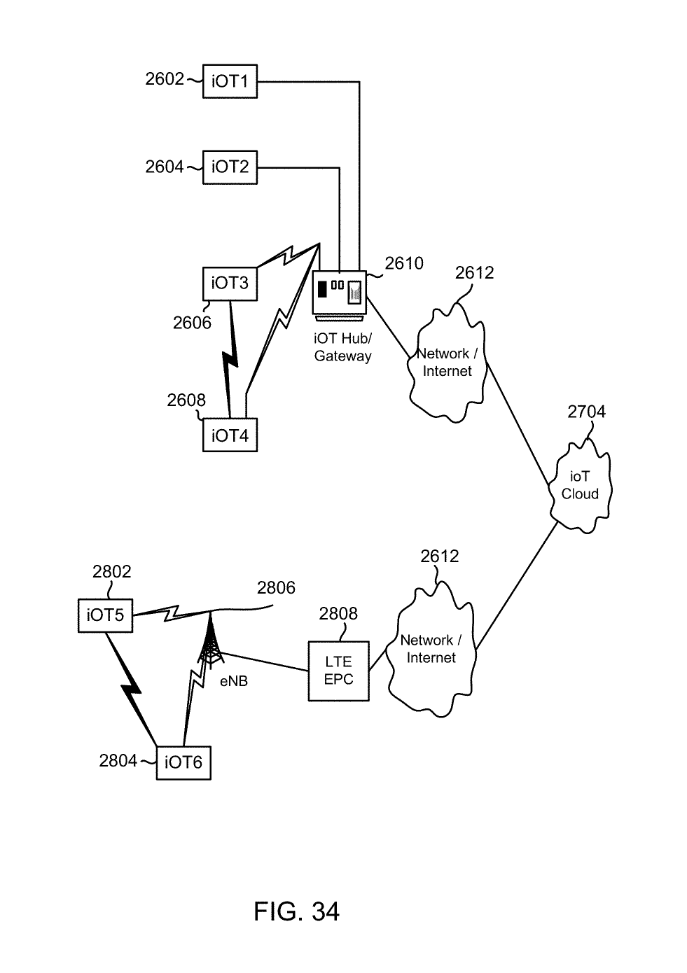

FIG. 34 illustrates iOT devices having established or in the process or refining their position location in either 2 or 3 dimensions establish communication with LTE mobile devices and relay their position to the to the mobile devices.

Specifically, in the example illustrated in FIG. 34, iOT device 2606 relays its position location to iOT device 2608. Additionally, iOT device 2606 sends its location information with iOT device 2608 using the eLBS trilateration algorithm. The iOT devices 2606 and 2608 do not have to be directly connected with each other, since with eLBS trilateration, the iOT devices can relay their location awareness and ranging information from one iOT device to another. For instance, in FIG. 34 iOT 2804 may relay its positional information to iOT device 2608 via iOT device 2802 (either directly or via the eNodeB 2806, the LTE EPC core network 2808, network 2612 and/or iOT cloud server/network 2704).

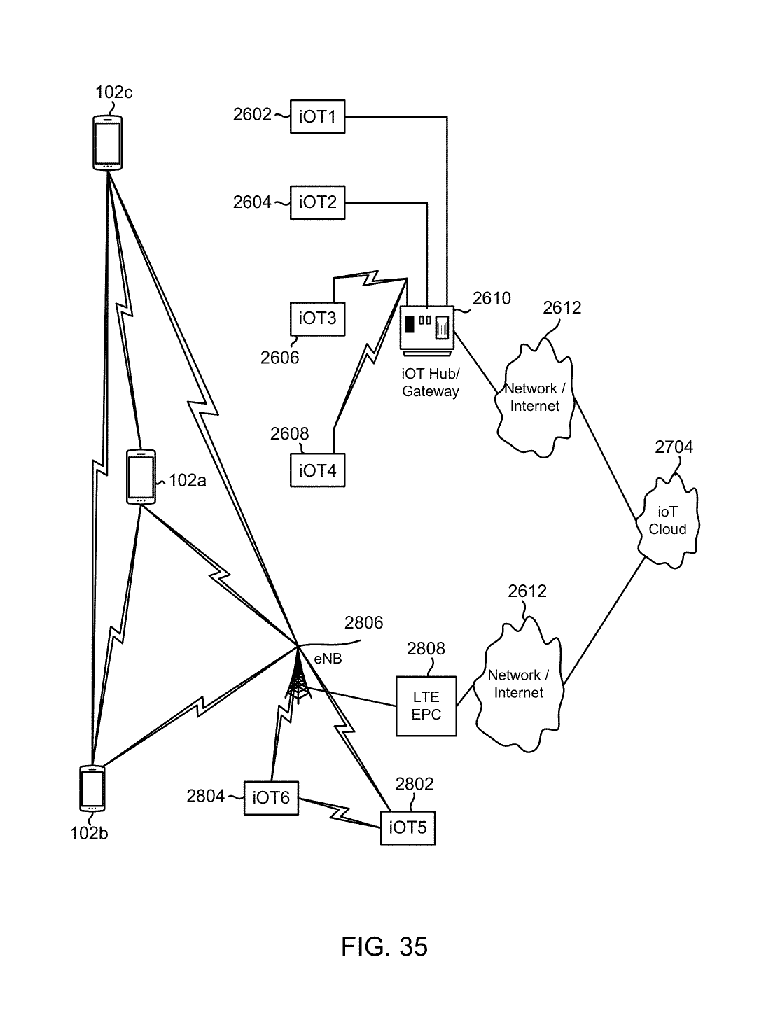

In FIG. 35 illustrates that the mobile device 102a, 102b and 102c may utilize trilateration to share and update their positional location information between themselves.

For example, mobile device 102b may use eLBS, treating one or more of the iOT devices (e.g., iOT device 2804) as another device in the mobility environment using the trilateration algorithm or eLBS. The iOT device 2804 may be a broadcast device that broadcasts its coordinates and other telemetry information. The iOT device 2804 may also employ bidirectional communication technologies in which the iOT device 2804 is able to receive positional information from the mobile device 102b, and using eLBS to improve its positional estimate.

The mobile devices 102a, 102b, 102c and iOT devices 2602, 2604, 2606, 2608, 2802, 2804 may actively work together to improve their position location. In some cases, the iOT devices 2602, 2604, 2606, 2608, 2802, 2804 may have a better initial position than the mobile devices 102a, 102b, 102c. At other times, the mobile devices 102a, 102b, 102c may have a better positional location than the iOT devices 2602, 2604, 2606, 2608, 2802, 2804. The combination of using the eNodeB 2806 location, information collected or computed in iOT devices, information collected or computed in mobile devices, and information made available via the iOT cloud server/network 2704 in concert with each other in the general location improvement ecosystem will improve the positional accuracy of all the members of the collective ecosystem.

The embodiments described above (e.g., with reference to FIGS. 26-35) provide a location ecosystem for improving the positional location of the iOT devices and mobile devices. In further embodiments, the eNodeB 2806 may include a processor that is configured to implement and use eLBS Fixed Infrastructure node techniques (e.g., with the iOT devices and mobile devices) to generate location information that more accurately identifies the location of the eNodeB and other fixed nodes in the communication system. This information may used to further improve the location information generated in, by or for the mobile devices 102a, 102b, 102c and the iOT devices 2602, 2604, 2606, 2608, 2802, 2804.

As an example, iOT devices 2606 and 2608 may relay their position location information to mobile device 102a. The mobile device 102a may use any or all of the received information to perform eLBS operations (e.g., eLBS triangulation operations), treating one or more of the iOT devices 2606, 2608 as a device in the mobility environment to generate more precise location information. As a further example, the iOT device 2606 may employ bidirectional communication technologies that allows the device to receive updated position information from the mobile device 102a. The iOT device 2606 may receive the more precise location information from the mobile device 102a, and use the received information to improve its positional estimate.

If the iOT hub 2610 is LTE enabled, then the location of the device can be better positioned to the LTE network using standard LTE location awareness methods.

In the situation where the iOT device does not have location awareness capability it is possible to obtain a relative positive in relation to another device. The other device can be fixed either as a cell site, eNodeB, femto cell, beacon, or stationary iOT device which could also be a iOT hub. The other device can also be a device that is on the move specifically a mobile device or iOT device that is being transported or a iOT hub, eNodeB or other device that is non stationary.

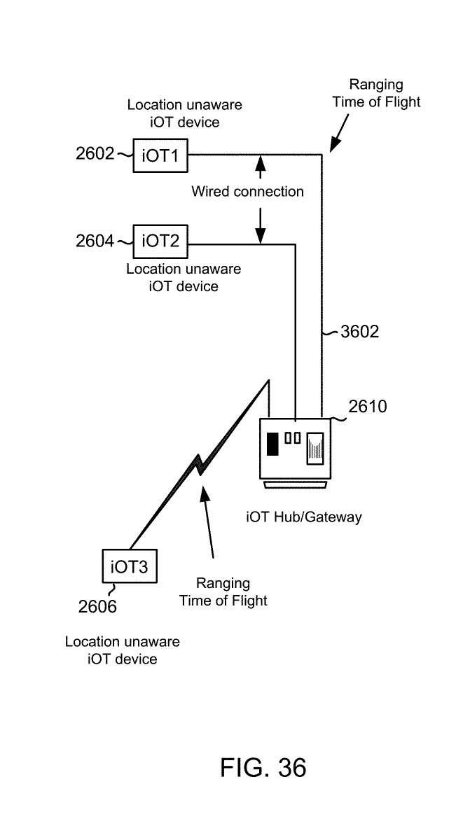

FIG. 36 illustrates an example in which iOT devices 2602, 2604 and 2606 that are location unware (e.g., are not equipped with location awareness capability) are able to determine (or have determined) their locations, ranges relative to other devices, and/or time of flight information. The range or time of flight information from sounding or ranging between the devices may be accomplished or establish if the iOT devices 2602, 2604 and 2606 are in a collective group of devices. The time of flight may be determined an over the air sounding method. The time of flight may also be determined from sounding over a wired connection 3602 using the same method that is done for over the air, except the medium for transport is now a wire.

The grouping of the iOT devices may be done at the iOT hub level or using another platform at the edge of the network. Alternatively, the grouping of the iOT device with other devices may be performed in the network or in the iOT cloud service where ranging and grouping functions are performed.

Multiple iOT devices without location awareness capability when communicating either between each other or with the iOT hub or upstream server can be grouped together based purely on the ability to communicate with a single iOT hub or node.

If the iOT device that is not location aware communicates with several iOT hubs then the one with the shorted time of flight or best communication link is the one that the iOT device is defined to communicate with and this link is used for the time of flight calculation.

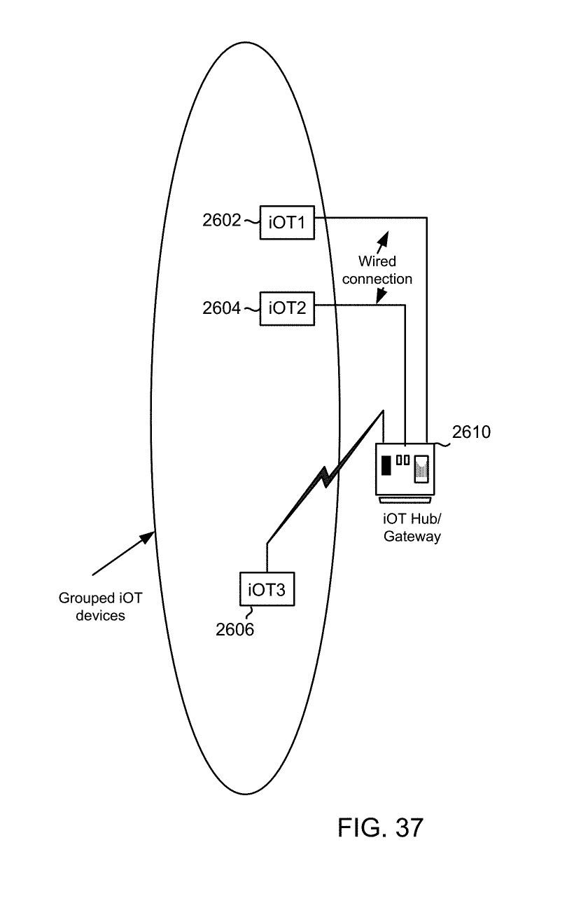

FIG. 37 illustrates that the location unware iOT devices 2602, 2604 and 2606 may form a communication group and/or that iOT devices that are associated with the same iOT hub 2610 may be grouped together.

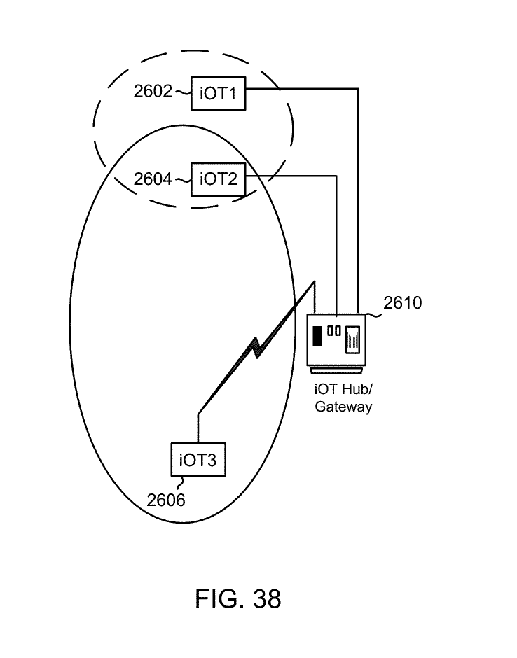

FIG. 38 illustrates that iOT devices 2602, 2604 and 2606 associated with the same iOT hub 2610 may grouped into several groups based on a policy, which may be controlled from the iOT hub 2610, network, iOT cloud.

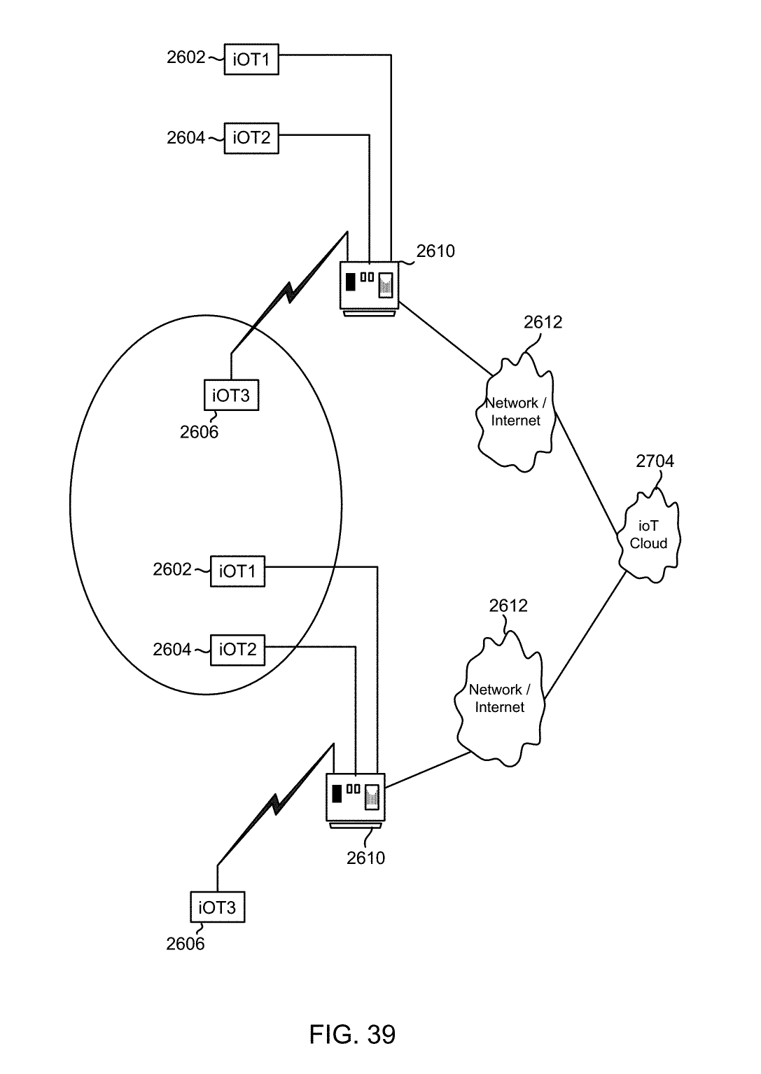

FIG. 39 shows a potential scenario where several iOT devices are grouped together for a collective service offering however the iOT devices are connected to the network or cloud service either from different iOT Hubs, beacons, eNodeB or even wireless networks allowing for a hetnet of iOT devices to exist.

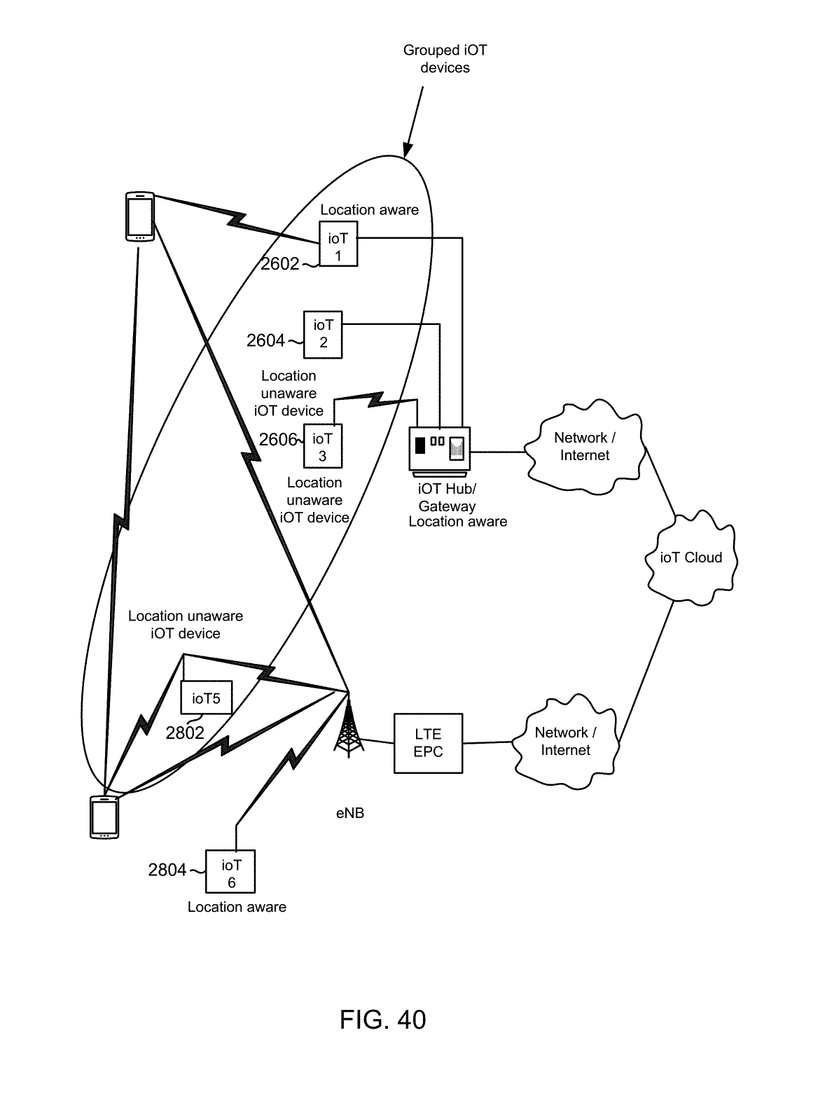

FIG. 40 depicts that situation where a hetnet for iOT devices exists and iOT devices are grouped for a common service using different iOT protocols or networks. This can be augmented by using possibly the iOT cloud service for ranging other reporting devices can also be used to help position the iOT device by using pure ranging, time of flight. In this case different the eLBS algorithm of iOT devices is run in the iOT cloud service for that device that is not location aware However one the iOT device which is not location aware in hardware can be informed through telemetry what its relative location is a confidence interval can be also associated with the positional fix and the iOT device can now also provide location information to other devices seeking positional information.

The various embodiments include methods for trilaterion for internet of things (iOT) devices using eLBS techniques. In an embodiment, the method may include using multiple inputs received from various devices (e.g., both mobile devices and iOT devices, etc.) to assist in initial fix and subsequent improvements for both mobile and fixed devices location determination involving latitude, longitude and altitude. In a further embodiment, the method may include determining location of a wireless device based information (e.g., sensor information, location information, etc.) received from devices in a iOT network. In a further embodiment, the method may include using information received from iOT devices (fixed, moving or movable) to improve location services the accuracy and confidence of three-dimensional coordinates of a device. In a further embodiment, the method may include determining confidence and/or precision values of the three-dimensional coordinates (latitude, longitude and altitude) for devices that do not have a full complement of location awareness sensors or receivers (i.e., devices in the iOT environment).

In a further embodiment, the method may include determining an approximate location of a mobile device, forming a communication group, sending the determined approximate location of the mobile device to an iOT device, other mobile devices or fixed wireless devices in the communication group, receiving on the mobile device location information (e.g., a latitude coordinate, a longitude coordinate, and an altitude coordinate) from the iOT device and/or other mobile devices, determining a more precise location of the mobile device based on the received location information, and sending (e.g., in-band, out of band, etc.) information relating to the determined more precise location (e.g., coordinates, information collected from an accelerometer, gyroscope, magnetometer, pressure sensor, etc.) and the received location information to an iOT cloud server computing device. In a further embodiment, the method may include receiving updated location information from the server, and re-computing the more precise location based on the updated location information received from the server.

In a further embodiment, the method may include determining an approximate location of an iOT device, grouping the iOT device other devices to form a communication group, sending the determined approximate location to another iOT device, mobile device or fixed wireless device, receiving location information from the iOT device, mobile device or fixed wireless device, determining a more precise location of the iOT device based on the received location information, and sending information relating to the determined more precise location and the received location information to an iOT cloud server computing device. In a further embodiment, the method may include receiving updated location information from the server, and re-computing the more precise location based on the updated location information received from the server.

In a further embodiment, the method may include grouping the mobile device or iOT device with a plurality of wireless transceivers, iOT devices, mobile devices and/or fixed wireless devices that are in close proximity to form the communication group, and receiving location information from two or more of the devices in the communication group.

In a further embodiment, the method may include detecting movement of the device, and re-computing the approximate location of the device in response to detecting the movement.

In some embodiments, the devices the communication group may be coupled to different networks, which may include to utilize different network access technologies. In a further embodiment, the method may include establishing a near field communication link to a wireless transceiver and sending the determined approximate location to the wireless transceiver over the established near field communication link.

The foregoing method descriptions and the process flow diagrams are provided merely as illustrative examples and are not intended to require or imply that the blocks of the various embodiments must be performed in the order presented. As will be appreciated by one of skill in the art the order of blocks in the foregoing embodiments may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm blocks described in connection with the embodiments disclosed herein may be implemented as electronic hardware, computer software, or combinations of both. To clearly illustrate this interchangeability of hardware and software, various illustrative components, blocks, modules, circuits, and blocks have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What I claim is:

1. A method of determining a location of a wireless device, comprising:
determining, via a processor of the wireless device, an approximate location of the wireless device;
forming a communication group with other devices in proximity to the wireless device, the other devices an internet of things (iOT) device;
receiving on the wireless device location information from the devices in the communication group; and
determining a more precise location of the wireless device based on the location information received from the devices in the communication group.

2. The method of claim 1, wherein the iOT device is coupled to an iOT hub, and wherein receiving on the wireless device location information from the devices in the communication group comprises receiving information identifying a location of the iOT device relative to a location of the iOT hub.

3. The method of claim 1, wherein the iOT device is a location aware iOT device.

4. The method of claim 1, wherein the iOT device is a location unaware iOT device.

5. The method of claim 1, wherein receiving the location information comprises receiving a latitude coordinate, a longitude coordinate, and an altitude coordinate from the iOT device.

6. The method of claim 1, further comprising sending sensor information collected from at least one of an accelerometer, a gyroscope, a magnetometer, and a pressure sensor to a server.

7. The method of claim 1, wherein receiving on the wireless device location information from the devices in the communication group comprises:
receiving location information from a first iOT device via an iOT hub;
receiving location information from a second iOT device via an eNodeB deployed within a telecommunication network; and
receiving location information from a third iOT device via a wireless access point.

8. The method of claim 1, further comprising:
detecting movement of the wireless device; and
re-computing the approximate location of the wireless device in response to detecting the movement.

9. The method of claim 1, further comprising receiving on the wireless device updated location information in response to the iOT device detecting a movement of the iOT device.

10. A wireless device, comprising:
a memory; and
a processor coupled to the memory, wherein the processor is configured with processor-executable instructions to perform operations comprising:
determining an approximate location of the wireless device;
forming a communication group with other devices in proximity to the wireless device, the other devices an internet of things (iOT) device;
receiving location information from the devices in the communication group; and
determining a more precise location of the wireless device based on the location information received from the devices in the communication group.

11. The wireless device of claim 10, wherein the processor is configured with processor-executable instructions to perform operations such that receiving on the wireless device location information from the devices in the communication group comprises receiving information identifying a location of the iOT device relative to a location of a iOT hub

12. The wireless device of claim 10, wherein the iOT device is a location aware iOT device.

13. The wireless device of claim 10, wherein the iOT device is a location unaware iOT device.

14. The wireless device of claim 10, wherein the processor is configured with processor-executable instructions to perform operations such that receiving the location information comprises receiving a latitude coordinate, a longitude coordinate, and an altitude coordinate from the iOT device.

15. The wireless device of claim 10, wherein the processor is configured with processor-executable instructions to perform operations further comprising sending sensor information collected from at least one of an accelerometer, a gyroscope, a magnetometer, and a pressure sensor to a server.

16. The wireless device of claim 10, wherein the processor is configured with processor-executable instructions to perform operations such that receiving on the wireless device location information from the devices in the communication group comprises:
receiving location information from a first iOT device via an iOT hub;
receiving location information from a second iOT device via an eNodeB deployed within a telecommunication network; and
receiving location information from a third iOT device via a wireless access point.

17. The wireless device of claim 10, wherein the processor is configured with processor-executable instructions to perform operations further comprising:
detecting movement of the wireless device; and
re-computing the approximate location of the wireless device in response to detecting the movement.

18. The wireless device of claim 10, wherein the processor is configured with processor-executable instructions to perform operations further comprising receiving on the wireless device updated location information in response to the iOT device detecting a movement of the iOT device.

19. A non-transitory computer readable storage medium having stored thereon processor-executable software instructions configured to cause a processor of a wireless device to perform operations comprising:
determining an approximate location of the wireless device;
forming a communication group with other devices in proximity to the wireless device, the other devices an internet of things (iOT) device;
receiving on the wireless device location information from the devices in the communication group; and
determining a more precise location of the wireless device based on the location information received from the devices in the communication group.

20. The non-transitory computer readable storage medium of claim 19, wherein the stored processor-executable software instructions are configured to cause a processor of a mobile device to perform operations such that receiving on the wireless device location information from the devices in the communication group comprises receiving information identifying a location of the iOT device relative to a location of a iOT hub.
